(19) United States
(12) Patent Application Publication
(10) Pub. No.: US 2019/0197916 A1
(43) Pub. Date: Jun. 27, 2019

(54) SENTENCE BUILD-UP ENGLISH LEARNING SYSTEM, ENGLISH LEARNING METHOD USING SAME, AND TEACHING METHOD THEREFOR

(71) Applicant: Jeong-Seon PARK, Seoul (KR)

(72) Inventor: Jeong-Seon PARK, Seoul (KR)

(21) Appl. No.: 15/762,273

(22) PCT Filed: Dec. 21, 2016
(86) PCT No.: PCT/KR2016/014977

§ 371 Date: Mar. 22, 2018

(30) Foreign Application Priority Data
Apr. 29, 2016 (KR) 10-2016-0053000

(51) Int. Cl. G09B 19/00; H04L 29/08

(52) U.S. Cl. CPC G09B 19/00; G09B 7/06; H04L 67/22

(57) ABSTRACT

The present invention provides a sentence build-up English learning system, an English learning method using the same, and a teaching method therefor, in which a list of learning contents and a learning content, stored in a learning content DB, are configured to have contents associated with first to final stages, or a higher stage is configured to include all contents of lower stages, and learning progresses by stages toward a higher layer according to a determined order, so as to stably provide an English learning environment by stages through a systematized building structure, thereby guaranteeing the same contents-to-learn regardless of a teacher.

### TECHNICAL FIELD

The present invention relates to a sentence build-up English learning system, an English learning method using the same, and a teaching method therefor, and more particularly, to a sentence build-up English learning system, an English learning method using the same, and a teaching method therefor, which stably provide an English learning environment by stages through a building structure with systematized learning contents, thereby guaranteeing the same learning outcomes regardless of teachers.

In other words, the present invention relates to a sentence build-up English learning system, in which learning contents are adjusted by stages through a systematized building structure with 33 layers or equivalent so that a learner can learn the learning contents by stages, thereby providing standardization in teaching and learning to provide the same learning outcomes regardless of teachers, and guaranteeing correct results by enhancing perfection in English skills.

### BACKGROUND ART

Some languages are similar in the arrangement of words and some languages are different in the arrangement of words from one another. For instance, in case of Korean and Japanese, they are similar in many aspects of the arrangement of words with each other, but Korean and English are considerably different in the arrangement of words from each other. Such linguistic features make it difficult to understand the English sentence structure when people learn English, so may act as obstacles of learning.

In the meantime, if a learner is well-educated at the sentence structure of English, the learner can change all expressions that he or she can express in his or her native language into English expressions, and also change all English expressions into native language expressions. English education environment in Korea is an English environment not as a native language or a second language but as a foreign language. As described above, in the case that English is not a native language or a second language but a foreign language, in order to enhance the learner's proficiency in English, a systematic understanding of the English sentence structure is essential.

However, conventional English learning methods simply provide a lot of tables of contents of English grammar and discrete contents by each table so that a learner learns the contents individually. So, if the learner uses the conventional English learning methods, there is a great difference in learning effects according to teachers' teaching levels and it takes long time to systematically learn the sentence structure of English.

### PATENT LITERATURE

### Patent Documents

Patent Document 1: Korean Patent Publication No. 10-2013-0043852

### DISCLOSURE

### Technical Problem

Accordingly, the present invention has been made in an effort to solve the above-mentioned problems occurring in the prior arts, and it is an object of the present invention to provide a sentence build-up English learning system, an English learning method using the same, and a teaching method therefor, which stably provide an English learning environment by stages through a building structure with systematized learning contents, thereby guaranteeing the same learning outcomes regardless of teachers.

It is another object of the present invention to provide a sentence build-up English learning system and an English learning method using the same, in which learning contents stored in a learning content DB are configured to have contents associated with one another from the first stage to the final stage or configured in such a way that a higher stage includes all contents of lower stages and learning progresses by stages toward a higher layer in a determined order, so that a learner can learn the sentence structure of English systematically, thereby guaranteeing the same learning contents regardless of teachers and greatly improving the learner's learning effects and English skills.

It is a further object of the present invention to provide an English learning method, which enables a learner to change all expressions that he or she can express in his or her native language into English expressions because the learner is provided with 1,600 iterative learnings of various expressions based on the systematic order and accuracy.

It is a still further object of the present invention to provide a sentence build-up English learning system and a teaching method therefor, in which learning contents are adjusted by stages through a systematized building structure with 33 layers or equivalent so that a learner can learn the learning contents by stages, thereby providing standardization in teaching and learning to provide the same learning outcomes regardless of teachers, and guaranteeing correct results by enhancing perfection in English skills.

### Technical Solution

To achieve the above objects, the present invention provides a sentence build-up English learning system including: a learning operating server which stores learning programs and a user database; a user terminal connected with the learning operating server through a communication network to store a learning program or an application downloaded from the learning operating server or install executive program, the user terminal having a display part and an input part; a control part, which logs on to the user database of the learning operating server according to the request of the program or application executed in the user terminal, requests English learning services, and operates and controls learning program; a learning contents database located inside the learning operating server, the learning contents database storing learning stages and a table of contents and learning contents by stages according to a predetermined learning order; a learning stage selection module located inside the learning operating server, the learning stage selection module allowing the control part to automatically select the learning stage of the lowest level, which a learner did not complete, out of the learning stages stored in the learning contents database or enabling the learner to directly select one of the learning stages of the learning contents database by the input part, so as to display the table of learning contents and summarized contents of the selected learning stage on a first screen of the display part; a learning contents display module located inside the learning operating server, the learning contents display module displaying detailed learning contents of the selected learning stage on a second screen of the display part after the learning stage selection module; and a utilization history providing module located in the user terminal to provide the learning operating server with the learning contents by each stage and the learning progress learned by the learner and to update and store provided information in the user database.

In an embodiment of the present invention, the sentence build-up English learning system further includes a learning stage progress display module having a learning stage progress display part of a multi-layer structure displayed on the first or second screen of the display part in order to show a progress status of the learning stage.

In an embodiment of the present invention, the learning stage progress display module classifies the learning stages into finished stages, learning stages in progress, and stages before learning and displays them in their own colors.

In an embodiment of the present invention, the learning contents display module includes: a learning goal display part for displaying a table of contents of the selected stage and a learning goal on the second screen of the display part; a sub-table of contents display part, which divides the learning contents into a plurality of sub-tables of contents; and an example sentence display part providing a plurality of the example sentences having the contents related with the sub-table of contents provided by the sub-table of contents display part.

In an embodiment of the present invention, the contents displayed by the example sentence display part are classified into corresponding parts according to parts of speech or various learning purposes of the corresponding learning contents, and are displayed in their own colors.

In an embodiment of the present invention, the table of learning contents stored in the learning contents database is configured to have contents associated from the first stage to the final stage.

In an embodiment of the present invention, wherein a building structure of the table of learning contents stored in the learning contents database is classified into a basic level, an intermediate level, and an advanced level, wherein the basic building structure includes: a 1^{st} layer providing 1,600 iterative learnings of easily understandable expressions of verb ‘be’, subject and personal pronouns, and providing verb ‘be’ in the present tense and personal pronouns in the singular form, which are foundational to learning of contents from the 2nd layer to the 33^{rd} layer that the learner will learn later; a 2^{nd} layer providing 1,600 iterative learnings of easily understandable expressions of verb ‘be’, subject, personal pronouns, questions, negative sentences, positive answers, and negative answers, and providing verb ‘be’ in the present tense, personal pronouns in the plural form, negative sentences, and questions and answers, which are foundational to learning of contents from the 3^{rd} layer to the 33^{rd} layer that the learner will learn later; a 3^{rd} layer providing 1,600 iterative learnings of various expressions of subject pronouns, object pronouns, possessive adjectives, and possessive pronouns based on various sentences with verb ‘be’ learned in the first and second layers, and providing personal pronouns and declension, which are foundational to learning of contents from the 4^{th} layer to the 33^{rd} layer that the learner will learn later; a 4^{th} layer providing 1,600 iterative learnings of various expressions of subject pronouns, object pronouns, possessive adjectives, and possessive pronouns based on various sentences with verb ‘be’ learned in the first and second layers, and providing declension of personal pronouns, which are foundational to learning of contents from the 5^{th} layer to the 33^{rd} layer that the learner will learn later; a 5^{th} layer providing 1,600 iterative learnings of various expressions of present tense regular verbs based on various sentences with verb ‘be’ and personal pronouns learned in the 1^{st} to 4^{th} layers, and providing present tense verbs, which are foundational to learning of contents from the sixth layer to the 33^{rd} layer that the learner will learn later; a 6^{th} layer providing 1,600 iterative learnings of various expressions of declarative sentences, questions, negative sentences, positive answers and negative answers based on various sentences with verb ‘be’ and other verbs learned in the 1^{st} to 5^{th} layers, and providing present tense verbs, which are foundational to learning of contents from the seventh layer to the 33^{rd} layer that the learner will learn later; a 7^{th} layer providing 1,600 iterative learnings of various expressions of declarative sentences, questions, negative sentences, positive answers and negative answers in the past tense based on various sentences with verb ‘be’ and other verbs learned in the first to sixth layers, and providing past tense verbs, which are foundational to learning of contents from the 8^{th} layer to the 33^{rd} layer that the learner will learn later; a 8^{th} layer providing 1,600 iterative learnings of various expressions of declarative sentences, questions, negative sentences, positive answers and negative answers in the past tense based on various sentences with verb ‘be’ and other verbs learned in the first to seventh layers, and providing past tense verbs, which are foundational to learning of contents from the 9^{th} layer to the 33^{rd} layer that the learner will learn later; a 9^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 10^{th} layer to the 33^{rd} layer that the learner will learn later; a 10^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 11^{th} layer to the 33^{rd} layer that the learner will learn later; a 11^{th} layer providing 1,600 iterative learnings of various expressions of exclamatory, suggesting, and imperative sentences based on various present simple, past simple, present continuous, past continuous, and future tense sentences with verb ‘be’ and other verbs learned in the first to tenth layers, and providing exclamatory, suggesting, and imperative sentences, which are foundational to learning of contents from the 12^{th} layer to the 33^{rd} layer that the learner will learn later; and a 12^{th} layer providing 1,600 iterative learnings of various expressions of tag questions based on various present simple, past simple, present continuous, past continuous, and future tense, exclamatory, suggesting, and imperative sentences with verb ‘be’ and other verbs learned in the first to 11^{th} layers, and providing tag questions, which are foundational to learning of contents from the 13^{th} layer to the 33^{rd} layer that the learner will learn later, wherein the intermediate building structure includes: a 13^{th} layer providing 1,600 iterative learnings of various expressions of reflexive pronouns and impersonal subject ‘it’ based on the sentence building structure of various tenses (present simple, past simple, present continuous, past continuous, and future) in questions, declarative, negative, exclamatory, suggesting, and imperative sentences learned in the first to 12^{th} layers, and providing reflexive pronouns and impersonal subject ‘it’, which are foundational to learning of contents from the 14^{th} layer to the 33^{rd} layer that the learner will learn later; a 14^{th} layer providing 1,600 iterative learnings of various expressions of indefinite pronouns and uncountable nouns based on the sentence building structure of various tenses (present simple, past simple, present continuous, past continuous, and future) in questions, declarative, negative, exclamatory, suggesting, and imperative sentences learned in the first to 13^{th} layers, and providing indefinite pronouns and uncountable nouns, which are foundational to learning of contents from the 15^{th} layer to the 33^{rd} layer that the learner will learn later; a 15^{th} layer providing 1,600 iterative learnings of various expressions of question words ‘Wh-’ based on the sentence building structure of various tenses (present simple, past simple, present continuous, past continuous, and future) in questions, declarative, negative, exclamatory, suggesting, and imperative sentences learned in the first to 14^{th} layers, and providing question words ‘Wh-’, which are foundational to learning of contents from the 16^{th} layer to the 33^{rd} layer that the learner will learn later; a 16^{th} layer providing 1,600 iterative learnings of various expressions of the question word ‘How’ based on the sentence building structure of various tenses (present simple, past simple, present continuous, past continuous, and future) in questions, declarative, negative, exclamatory, suggesting, and imperative sentences learned in the first to 15^{th} layers, and providing the question word ‘How’, which are foundational to learning of contents from the 17^{th} layer to the 33^{rd} layer that the learner will learn later; a 17^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 16^{th} layers, and providing modal verbs, which are foundational to learning of contents from the 18^{th} layer to the 33^{rd} layer that the learner will learn later; a 18^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 17^{th} layers, and providing modal verbs, which are foundational to learning of contents from the 19^{th} layer to the 33^{rd} layer that the learner will learn later; a 19^{th} layer providing 1,600 iterative learnings of various expressions of the comparatives and the superlatives based on the sentence building structure of various tenses (present simple, past simple, present continuous, past continuous, and future) in questions, declarative, negative, exclamatory, suggesting, and imperative sentences learned in the first to 18^{th} layers, and providing the comparatives and the superlatives, which are foundational to learning of contents from the 20^{th} layer to the 33^{rd} layer that the learner will learn later; a 20^{th} layer providing 1,600 iterative learnings of various expressions of number expressions and adverbs of frequency based on the sentence building structure of various tenses (present simple, past simple, present continuous, past continuous, and future) in questions, declarative, negative, exclamatory, suggesting, and imperative sentences learned in the first to 19^{th} layers, and providing number expressions and adverbs of frequency, which are foundational to learning of contents from the 21^{th} layer to the 33^{rd} layer that the learner will learn later; a 21^{th} layer providing 1,600 iterative learnings of various expressions of adjectives, adverbs, the indefinite article, and the definite article based on the sentence building structure of various tenses (present simple, past simple, present continuous, past continuous, and future) in questions, declarative, negative, exclamatory, suggesting, and imperative sentences learned in the first to 20^{th} layers, and providing adjectives, adverbs, the indefinite article, and the definite article, which are foundational to learning of contents from the 22^{nd} layer to the 33^{rd} layer that the learner will learn later; a 22^{nd} layer providing 1,600 iterative learnings of various expressions of prepositions and prepositional phrases based on the sentence building structure of various tenses (present simple, past simple, present continuous, past continuous, and future) in questions, declarative, negative, exclamatory, suggesting, and imperative sentences learned in the first to 21^{st} layers, and providing prepositions and prepositional phrases, which are foundational to learning of contents from the 23^{rd} layer to the 33^{rd} layer that the learner will learn later; a23^{rd} layer providing 1,600 iterative learnings of various expressions of conjunctions based on the sentence building structure of various tenses (present simple, past simple, present continuous, past continuous, and future) in questions, declarative, negative, exclamatory, suggesting, and imperative sentences learned in the first to 22^{nd} layers, and providing conjunctions, which are foundational to learning of contents from the 24^{th} layer to the 33^{rd} layer that the learner will learn later; and a 24^{th} layer providing 1,600 iterative learnings of various expressions of possessive pronouns, selection of verbs, agreement on number, inversion, and emphasis based on the sentence building structure of various tenses (present simple, past simple, present continuous, past continuous, and future) in questions, declarative, negative, exclamatory, suggesting, and imperative sentences learned in the first to 23^{rd} layers, and providing possessive pronouns, selection of verbs, agreement on number, inversion, and emphasis, which are foundational to learning of contents from the 25^{th} layer to the 33^{rd} layer that the learner will learn later, and

wherein the advanced building structure includes: a 25^{th} layer providing iterative learnings so that the learner can perfectly understand usages of to-infinitive through various expressions including various tenses based on the sentence building structure completed from the first to 24^{th} layers, and providing infinitives, which are associated with various English expressions from the 26^{th} layer to the 33^{rd} layer that the learner will learn later; a 26^{th} layer providing iterative learnings so that the learner can understand usages of gerunds and present participles in connection with to-infinitive through various expressions including various tenses based on the sentence building structure completed from the first to 25^{th} layers, and providing gerunds, which are associated with various English expressions from the 27^{th} layer to the 33^{rd} layer that the learner will learn later; a 27^{th} layer providing iterative learnings so that the learner can understand constituent parts of sentences, kinds of sentences, sentence structures, and discrimination of parts of speech through various expressions including various tenses based on the sentence building structure completed from the first to 26^{th} layers, and providing kinds of verbs and sentence structures, which are associated with various English expressions from the 28^{th} layer to the 33^{rd} layer that the learner will learn later; a 28^{th} layer providing iterative learnings so that the learner can understand kinds and roles of participles, participle forms of emotions, understanding of present participle and gerund, and forms of participle constructions through various expressions including various tenses based on the sentence building structure completed from the first to 27^{th} layers, and providing participles, which are associated with various English expressions from the 29^{th} layer to the 33^{rd} layer that the learner will learn later; a 29^{th} layer providing iterative learnings and advanced learning processes of present, past, future, present perfect, past perfect, future perfect, present continuous, past continuous, future continuous, and present perfect continuous tenses through various expressions including various tenses based on the sentence building structure completed from the first to 28^{th} layers and provide iterative learnings so that the learner can complete the sentence building structure of all tenses including the perfect tense, and providing tenses of verbs, which are associated with various English expressions from the 30^{th} layer to the 33^{rd} layer that the learner will learn later; a 30^{th} layer providing iterative learnings so that the learner can understand kinds of the subjunctives, various forms of the subjunctives, and changes of speech through various expressions including various tenses based on the sentence building structure completed from the first to 29^{th} layers, and providing the subjunctive and speech, which are associated with various English expressions from the 31^{st} layer to the 33^{rd} layer that the learner will learn later; a 31^{st} layer providing iterative learnings so that the learner can understand modal verbs, do, have, can, may, must, should/ought to, will, would, and used to through various expressions including various tenses based on the sentence building structure completed from the first to 30^{th} layers, and providing the modal verbs, which are associated with various English expressions from the 32^{st} layer to the 33^{rd} layer that the learner will learn later; a 32^{st} layer providing iterative learnings so that the learner can understand the meaning, forms and tenses of the passive voice, modal verbs in the passive voice, the passive voice from which ‘by’ is omitted, prepositions in the passive voice, sentence kinds in the passive voice, sentence structures in the passive voice through various expressions including various tenses based on the sentence building structure completed from the first to 31^{st} layers, and providing the passive voice, which is associated with various English expressions of the 33^{rd} layer that the learner will learn later; and a 33^{rd} layer providing iterative learnings so that the learner can perfectly understand relative pronouns who, which, that, and what, usage and ellipsis of the relative pronouns, relative adverbs where, when, why, and how, and usage and ellipsis of the relative adverbs through various expressions including various tenses based on the sentence building structure completed from the first to 32^{nd} layers.

In another aspect of the present invention, the present invention provides a sentence build-up English learning method including the steps of: storing a table of contents and learning contents by stages in a learning contents database of a learning operating server in determined order; logging on to a user database of the learning operating server through a communication network by a learner; allowing a control part to automatically select the learning stage of the lowest level, which the learner did not complete, out of the learning stages stored in the learning contents database of the learning operating server or enabling the learner to directly select one of the learning stages in the table of contents using an input part, and displaying the table of contents and summarized learning contents of the selected learning stage on a first screen; after the step of selecting the learning stage, displaying detailed learning contents associated with the selected learning stage on a second screen of the display part, so that the learner can learn the learning contents while getting them with eyes; and updating and storing the utilization history of the learning stage in the user database of the learning operating server.

In an embodiment of the present invention, in the step of logging in, a layer structure the learning stages are classified into finished stages, learning stages in progress, and stages before learning and are displayed in their own colors on the display part of the user terminal.

In an embodiment of the present invention, in the step of displaying detailed learning contents, the contents to be learned are divided into a plurality of sub-table of contents and are displayed on the second screen of the display part, and a plurality of example sentences containing contents related with the sub-table of contents are further displayed on the second screen of the display part.

In an embodiment of the present invention, the table of contents stored in the learning contents database is configured to have contents associated from the first stage to the final stage, so that the learner progresses learning in order from a lower stage to higher stages.

In a further aspect of the present invention, the present invention provides a sentence build-up English teaching method including the steps of: storing a table of contents and learning contents by stages in a learning contents database of a learning operating server in determined order; logging on to a user database of the learning operating server through a communication network by a learner; allowing a control part to automatically select the learning stage of the lowest level, which the learner did not complete, out of the learning stages stored in the learning contents database of the learning operating server or enabling the learner to directly select one of the learning stages in the table of contents using an input part, and displaying the table of contents and summarized learning contents of the selected learning stage on a first screen; after the step of selecting the learning stage, displaying detailed learning contents associated with the selected learning stage on a second screen of the display part, so that the learner can learn the learning contents while getting them with eyes; reading the contents corresponding to the corresponding layer from an electronically standardized learning manual stored in the learning operating server and displaying the read contents on a part of the screen of the display part or a separate window; and updating and storing the utilization history of the learning stage in the user database of the learning operating server.

In an embodiment of the present invention, the standardized learning manual displays the unit and learning contents of the layer, which the learner is currently learning, at the left side of the screen, displays activities for learning the corresponding unit from the top in learning order in the middle of the screen, and displays repetition number by activities to be repeatedly learned and cumulative number of learning at the right side of the screen.

### Advantageous Effects

According to embodiments of the present invention, It is another object of the present invention to provide a sentence build-up English learning system and an English learning method using the same, in which a list of contents and learning contents stored in a learning content DB are configured to have contents associated with one another from the first stage to the final stage or configured in such a way that a higher stage includes all contents of lower stages so that a learner cannot obtain desired effects at the next high stage if the learner did not learn the contents of a lower stage sufficiently and the learner's learning progresses by stages toward a higher layer in a determined order, thereby guaranteeing the same learning contents regardless of teachers by stably providing an English learning environment by stages through a systematized building structure of English.

Through the above process, the sentence build-up English learning system, the English learning method using the same, and the teaching method therefor according to the embodiments of the present invention can remarkably improve the learner's understanding level of the English sentence structure so that the learner can freely change all expressions that he or she can express in his or her native language into English expressions and all English expressions into native language expressions so as to read, write, listen and speak all languages into English.

Therefore, the sentence build-up English learning system, the English learning method using the same, and the teaching method therefor according to the embodiments of the present invention enable the learner to changes all expressions that he or she can express in his or her native language into English expressions because the learner is provided with 1,600 iterative learnings of various expressions based on the systematic order and accuracy. Additionally, the sentence build-up English learning system, the English learning method using the same, and the teaching method therefor according to the embodiments of the present invention provide standardization in teaching and learning to provide the same learning outcomes regardless of teachers and guarantee correct results by enhancing perfection in English skills because learning contents are adjusted by stages through the systematized building structure with 33 layers or equivalent so that the learner can learn about the learning contents by stages.

### DESCRIPTION OF DRAWINGS

FIG. 1 is a schematic structure view showing components of a sentence build-up English learning system according to a preferred embodiment of the present invention.

FIGS. 2A to 2D are views showing an example of a list of learning contents stored in a learning contents database in FIG. 1.

FIGS. 3A and 3B are structure views showing a state where contents corresponding to the first layer in a table of FIG. 2 is displayed on a monitor.

FIGS. 4A and 4B are structure views showing a state where contents corresponding to the second layer in the table of FIG. 2 is displayed on a monitor.

FIGS. 5A and 5B are structure views showing a state where contents corresponding to the 32^{nd} layer in the table of FIG. 2 is displayed on a monitor.

FIGS. 6 to 33 are structure views showing a state where a standardized manual of the present invention is displayed on the monitor in consecutive order.

### MODE FOR INVENTION

Hereinafter, reference will be now made in detail to exemplary embodiments of the present invention with reference to the attached drawings. However, the embodiments of the present invention may be modified into various other forms, and the scope of the present invention is not limited to following embodiments.

The embodiments are provided to allow the present disclosure to be more faithful and full and to perfectly transfer the inventive concept to those skilled in the art. Accordingly, the shape, the size, etc., of elements in the figures may be exaggerated for explicit comprehension. Regarding the reference numerals assigned to the elements in the drawings, it should be noted that the same elements will be designated by the same reference numerals and parts having similar functions and activities have the same reference numerals in the drawings.

In addition, unless explicitly stated to the contrary, the word “include” “comprise” or “have” used throughout the specification will not be understood as the exclusion of the other elements but to imply the inclusion of the other elements.

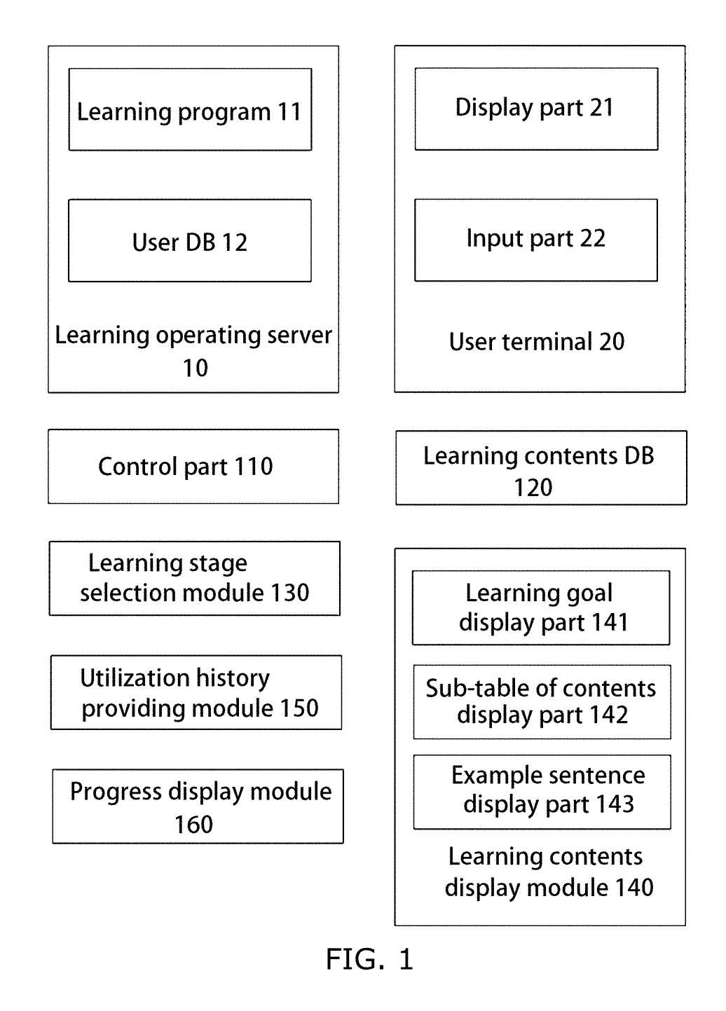

Referring to FIG. 1, a sentence build-up English learning system 100 includes a learning operating server 10, a user terminal 20, a control part 110, a learning contents database 120, a learning stage selection module 130, a learning contents display module 140, and a utilization history providing module 150.

The learning operating server 10 includes a learning program 11 prebuilt for executing English learning contents, and a learner database 12 for storing user information previously registered in the system and utilization history.

The user terminal 20 may be one of electronic devices, such as a personal computer, a smart phone, and a tablet computer. Such a user terminal 20 is connected with the learning operating server 10 through a wired or wireless communication network, and stores or installs a learning program or application downloaded from the learning operating server 10 to progress English learning. In this instance, the communication network may be technology based on wired internet, mobile communication network, or Wi-fi, but the present invention is not limited to the above.

Moreover, in case of two-way communication with the learning operating server 10, a user interface (UI) unit may be formed on the user terminal 20 for input and output of the corresponding information, and such an UI unit includes a display part 21 and an input part 22. Here, the display part 21 may be a monitor or a liquid crystal display (LCD) of, for instance, a personal computer, a smart phone or a tablet PC, and the input part 22 may be, for instance, a keyboard, a mouse, a virtual keyboard, or a control pad. The display part 21 and the input part 22 of the present invention are not limited to the above, but for the sake of convenient description, in this embodiment, a computer monitor is adopted for the display part 21, and a keyboard and a mouse are adopted for the input part 22.

The control part 110 logs on to the user database 12 of the learning operating server 10 and according to the request of the program or application executed in the user terminal 20 and requests approval for the corresponding learner's use of English learning services. When approval is gained from the learning operating server 10, the control part 110 executes, controls and operates the learning program stored in the learning operating server 10 through the program or application of the user terminal 20.

The learning contents database 120 is located inside the learning operating server 10, and serves to divide and store learning stages and a table of contents previously made according to a predetermined learning order and learning contents by stages corresponding to the table of contents.

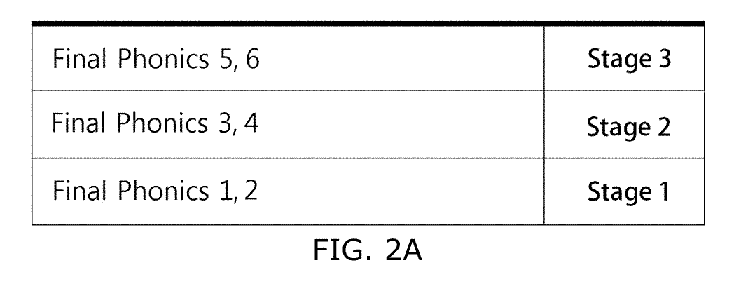

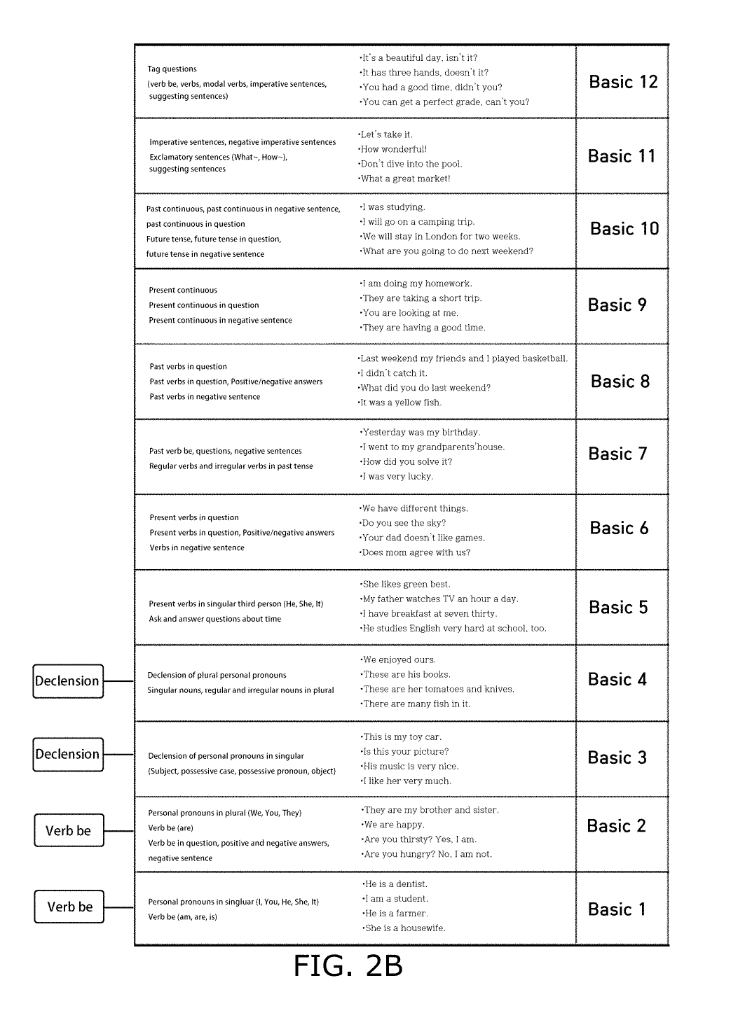

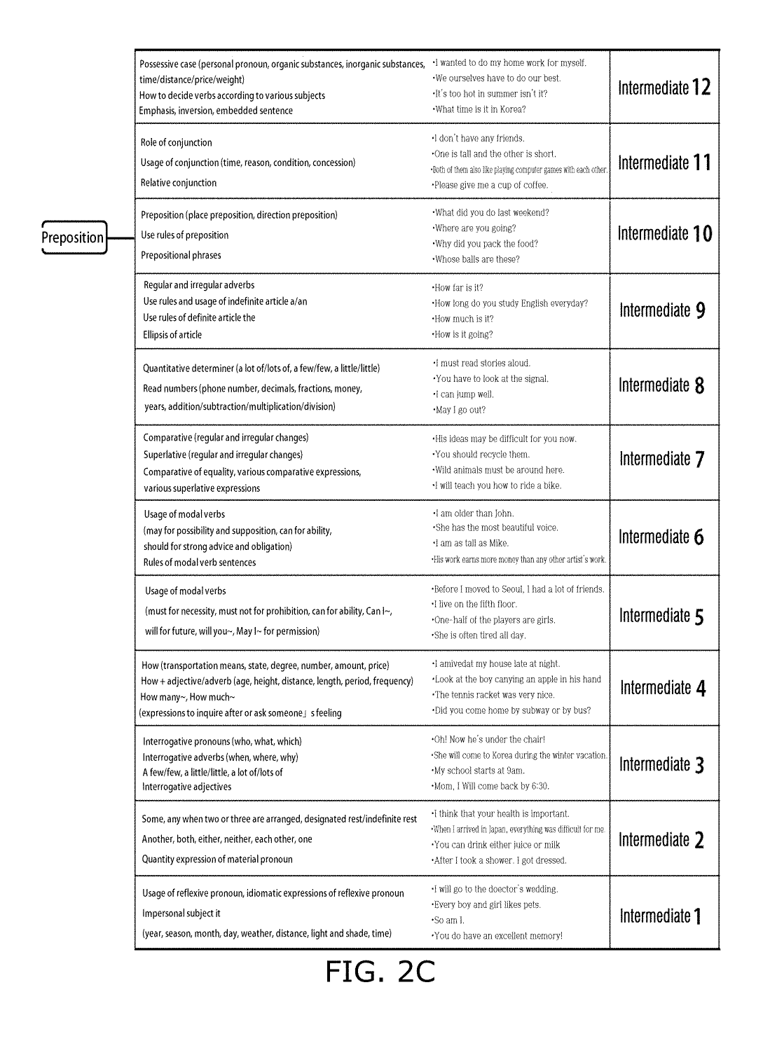

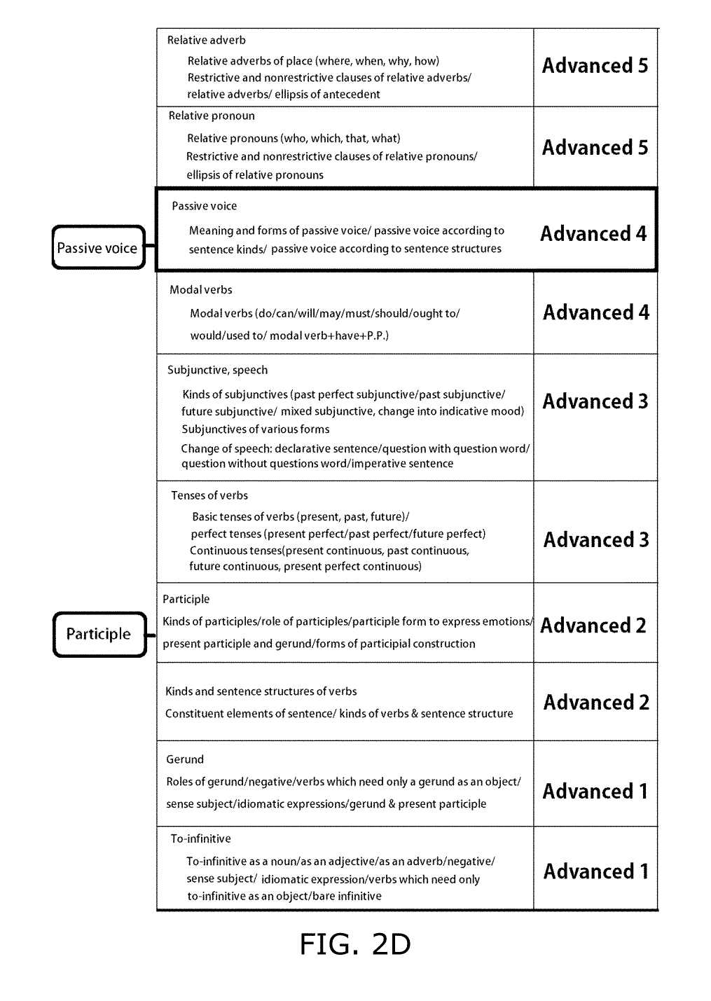

As shown in FIG. 2, the table of contents stored in the learning contents database 120 may have a multilayered building structure in which learning stages are systematically stacked from the first stage to the 33^{rd} stage at right angles in consideration of the learner's age and learning ability, contents to be learned, and so on. In this instance, the table of learning contents is configured to have contents connected from the first layer to the 33^{rd} layer in sequential order or contents that a higher stage includes all contents of lower stages, so that the learner can enhance his or her English skills in a short time while mastering the learning contents from a lower stage to higher stages layer by layer. That is, a higher stage includes the contents of lower stages so that the learner can progress his or her learning when mastering the contents of the lower stages, and of course, includes contents harder than the contents of the lower layers.

Furthermore, according to learners' learning levels, the building structure with the first to the 33^{rd} layers may be divided into a basic building structure configured such that a learner can learn about the whole of basic English, an intermediate building structure configured such that a learner can learn English to the level that the learner can read, write, listen and speak all expressions, which are expressible in his or her native language, in English by learning various and complicated sentence structures, and an advanced building structure including contents for learners, who finished the intermediate course and being configured such that the learner can prepare for various English certification tests for adults, such as TOEFL, TEPS, or others and freely read original books in English when finishing this course.

In this instance, the learner can learn a phonics course before learning the basic building structure, and the phonics course includes a learning structure of three stages contained in two CDs.

The learning building structure stored in the learning contents database 120 includes the basic building structure with twelve layers, the intermediate building structure with twelve layers, and the advanced building structure with nine layers. According to the present invention, because the learner can reach accurate achievement levels by stages, the present invention guarantees JET level 5 when the learner learned English to the eighth layer of the basic course, guarantees JET level 3 when the learner learned English to the twelfth layer of the basic course, guarantees JET level 1 when the learner learned English to the 18^{th} layer of the intermediate course, guarantees above 150 points on TOEIC Bridge when the learner learned English to the 24^{th} layer of the intermediate course, and guarantees above 500 points on TOEIC when the learner completed learning of all layers to the 33^{rd} layer.

In the basic building structure, the first layer is a stage to learn about verb ‘be’ present tense/personal pronouns in the singular form, and is configured to provide 1,600 iterative learnings of easily understandable expressions of verb ‘be’, subject and personal pronouns, so that the learner can learn about verb ‘be’ present tense/personal pronouns in the singular form, which is foundational to learning of contents from the second layer to the 33^{rd} layer that the learner will learn later. Examples of the contents of the first layer to be learned are as follows.

Unit 1 She is/He is/Father=He/Jane=She

(You can understand that ‘He’ refers to a man and ‘She’ refers to a woman through a gender classification of nouns)

He=[grandfather/father/uncle/husband/brother/brother-in-law/son/nephew/Justin/Mike/Tom . . . .]

She=[grandmother/mother/aunt/wife/sister/sister-in-law/daughter/niece/Sally/Judy/Jenny/Molly . . . .]

a man=He is=He's/a girl=She is=She's

My father is a dentist. He is a dentist.=He's a dentist. . . . .

My father (am/are/is) a doctor. (He/She) (am/are/is) in the hospital. . . . .

She is in the bed.=She's in the bed. . . . .

Unit 2 I am/It is

He=[a grandfather/a man/a boy . . . .], She=[a grandmother/a woman/a girl . . . .], It=[a pencil/a book/a class . . . .]

(I am+Noun) I am [a student]. [a teacher/a nurse/a zookeeper/a cook/a singer/a dancer/a scientist/a police . . . .]

(I am+Adjective) I am [big]. [tall/happy/quiet/loud/rich/old/young/smart/sad/small/cute/pretty . . . .]

(It is+Noun) It is [a desk]. [a book/a pencil/a chair/a dictionary/a computer/a snake/a bus/a candy . . . .]

(It is+Adjective) It is [heavy]. [thin/fat/short/soft/slow/easy/hot/cold/high/low/hard/long . . . .]

I (am/are/is) a young student./It (am/are/is) a black pen. . . . .

Unit 3 grandpa=He is=He's/mom=She is=She's/a table=Itis=It's

(You can understand that ‘He’ refers to a man, ‘She’ refers to a woman, and ‘It’ refers to a thing or an animal through a gender classification of nouns)

He=(a girl/a ball/a man. . . . ), She=(a son/a wife/a pencil . . . . ), It=(a ruler/a father/a sister . . . . )

(Use the given personal pronouns in the singular form and nouns to make sentences utilizing verb ‘be’)

(I, a doctor) I am a doctor./(He, a farmer) He is a farmer./(She, a painter) She is a painter./(It, a cellphone) It is a cellphone. . . . .

(Use various personal pronouns in the singular form and adjectives to make sentences utilizing verb ‘be’)

(I, lazy) I am lazy./(She, loud) She is loud./(He, excellent) He is excellent./(It, fantastic) It is fantastic. . . . .

(Change the given sentences, in each of which a personal pronoun in the singular form is a subject, into a contraction with verb ‘be’)

It is a big kite.=It's a big kite./I am sad.=I'm sad./She is a fast runner.=She's a fast runner./He is a strong swimmer.=He's a strong swimmer. . . . .

(Change the contraction with verb ‘be’ in the given sentences, in each of which a personal pronoun in the singular form is a subject, into uncontracted sentences)

It's a beautiful dress.=It is a beautiful dress./I'm a lazy boy.=I am a lazy boy./She's a funny girl.=She is a funny girl./He's heavy.=He is heavy. . . . .

Unit 4 my sister=She is=She's/puppy=It is=It's

(Select subjects, verb ‘be’, and nouns in parentheses and make sentences)

(He/I/It)+(am/is)+(a son/a scarf/a student) He is a son. I am a student. It is a scarf. . . . .

(Select subjects in parentheses according to the verb ‘be’ in the given sentences)

(I/He) is from England./(I/Tom) am nine years old./(She/It) is a new car./(I/My sister) is sick. . . . .

(Decide verb ‘be’ and change the subjects into subject pronouns as subjects of the verb ‘be’)

Daniel (is) a farmer.=He's a farmer./My sister (is) very loud.=She's very loud./A lion (is) in the zoo.=It's in the zoo. . . . .

(Make sentences with verb ‘be’ utilizing the given words)

(He, great) He is great./(I, worried) I am worried. (It, a dirty room) It is a dirty room./(She, a cute sister) she is a cute sister. . . . .

(Use the subject pronouns in parentheses to make sentences)

He is a handsome boyfriend. (I) I am a handsome boyfriend./She is very brave. (I) I am very brave./

I am a happy teacher. (She) She is a happy teacher./I am powerful. (He) He is powerful. . . . .

The second layer is a stage to learn about verb ‘be’ present tense, personal pronouns in the plural form, negative sentences, and questions and answers, and is configured to provide 1,600 iterative learnings of easily understandable expressions of verb ‘be’, subject, personal pronouns, questions, negative sentences, positive answers, and negative answers, so that the learner can learn about verb ‘be’ present tense, personal pronouns in the plural form, negative sentences, and questions and answers, which are foundational to learning of contents from the third layer to the 33^{rd} layer that the learner will learn later. Examples of the contents of the second layer to be learned are as follows.

Unit 1 They are=They're/Sister and brother=They

(Noun and Noun=They)

a son and a daughter=They/a son and daughters=They/a desk and a chair=They/desks and chairs=They . . . .

(He/She/It/They)

(an uncle=He, an aunt=She) an uncle and an aunt=They/(a brother=He, girls=They) a brother and girls=They/

(a shark=It, a wife=She) a shark and a wife=They/(sisters=They, umbrellas=They) sisters and umbrellas=They

A brother and a sister are=They are=They're/A dolphin and rabbits are=They are=They're

Dogs are smart.=They are smart.=They're smart./Sally and Judy are sisters.=They are sisters.=They're sisters. . .

They (am/are/is) in the swimming pool./They (am/are/is) classmates./They (am/are/is) yellow flowers. . . . .

(It/They/He) are umbrellas./(He/She/They) are students./(I/It/They) are my uncle and my aunt. . . . .

Unit 2 We are=We're/She and I=We

(Noun and I=We)—My mother and I=We/My friend and I=We/She and I=We/They and I=We/My classmates and I=We

(Review of personal pronouns and verb ‘be’)—Singular form: I+am/You+are/He+is/She+is/It+is

Plural form: We+are/You+are/They+are

My brother and I are=We are=We're/She and I are=We are=We're/Dancers and I=We are=We're . . . .

Tom and I are very close.=We are very close.=We're very close./My husband and I are from China.=We are from China.=We're from China. . . . .

We (am/are/is) friends./They (am/are/is) in the living room./I (am/are/is) very tired./

She (am/are/is) a beautiful singer./You (am/are/is) really beautiful./It (am/are/is) a blue balloon. . . . .

They are hungry. (We) We are hungry./I am in the swimming pool. (We) We are in the swimming pool./

He is in the kitchen. (We) We are in the kitchen./She is so thin. (We) We are so thin.

Unit 3 You are smart. Are you smart?/You are not smart. (questions and negative sentences with verb ‘be’)

I am fast. Am I fast?/You are fast. Are you fast?/He is fast. Is he fast?/She is fast. Is she fast?/

It is fast. Is it fast?/We are fast. Are we fast?/You (plural form) are fast. Are you fast?/They are fast. Are they fast?. . . .

(Am/Are/Is) I tall?/(Am/Are/Is) he tired?/(Am/Are/Is) you sad?/(Am/Are/Is) it fun?/

(Am/Are/Is) we in the library?/(Am/Are/Is) they married?. . . .

He is a musician. Is he a musician?/It is under the table. Is it under the table?/You are full. Are you full?/

We are rich. Are we rich?/She is late. Is she late?/They are absent. Are they absent?/I am small. Am I small?. . . .

(Negative sentences with verb ‘be’) I am not strong.=I'not strong./You are not strong.=You're not strong./

She is not strong.=She's not strong./He is not strong.=He's not strong./It is not strong.=It's not strong./

We are not strong.=We're not strong./They are not strong.=They're not strong. . . . .

(Contraction of negative sentences) He is not a student.=He's not a student.=He isn't a student./You are not ugly.=You're not ugly.=You aren't ugly. . . . .

(Declarative sentence) They are hungry. (Negative sentence) They are not hungry. (Question) Are they hungry?. . . .

Unit 4 Are you smart?/Yes, I am./No, I am not. (Questions, positive answers, and negative answers)

Am I strong? Yes, you are./Are you strong? Yes, I am./Are you (plural form) strong? Yes, we are./

Are we smart? Yes, we are. , Yes, you are./Are they smart? Yes, they are. . . . .

He is a famous singer. (Question) Is he a famous singer? (Positive answer) Yes, he is./

You are a smart student. (Question) Are you a smart student? (Positive answer) Yes, I am. . . . .

(Negative answer & contraction) I am not.=I'not./You are not.=You're not.=You aren't./He is not.=He's not.=He isn't./

She is not.=She's not.=She isn't./It is not.=It's not.=It isn't./We are not.=We're not.=We aren't./

They are not.=They're not.=They aren't. . . . .

Are they in the class room? (Negative answer) No, they are not.=No, they're not.=No, they aren't. . . . .

(Declarative sentence) It is a fast car. (Question) Is it a fast car? (Negative answer) No, it is not.=No, it's not.=No, it isn't. . . . .

The third layer is a stage to learn about declension of personal pronouns, and is configured to provide 1,600 iterative learnings of various expressions of subject pronouns, object pronouns, possessive adjectives, and possessive pronouns based on various sentences with verb ‘be’ learned in the first and second layers, so that the learner can learn about declension of personal pronouns, which are foundational to learning of contents from the fourth layer to the 33^{rd} layer that the learner will learn later. Examples of the contents of the third layer to be learned are as follows.

Unit 1 I/my/me/mine

(Declension of personal pronouns: subject pronoun-possessive adjective-object pronoun-possessive pronoun)

I my me mine/You your you yours/He his him his/She her her hers/

It its it X/We our us ours/You (plural form) your you yours/They their them theirs

(Use of declension)I am a student./My name is Justin./This bag is mine./He likes me.

This is (I/my/me/mine) dog./(I/my/me/mine) am a ballerina./They help (I/my/me/mine) all the time./

This pencil is (I/my/me/mine). . . . .

I jump on the sofa./My grandparents call me on Sundays./My name is Sally./The red crayon is mine. . . . .

Unit 2 you/your/you/your

(Declension of personal pronouns: subject pronoun-possessive adjective-object pronoun-possessive pronoun)

I my me mine/You your you yours/He his him his/She her her hers/

It its it X/We our us ours/You (plural form) your you yours/They their them theirs

(Use of declension) You are very kind./Your name is Judy./This apple is yours./I love you. . . . .

This is (you/your) ticket./I can help (you/your)./(You/Yours) is in the box./(You/Your) have a large garden. . . . .

You are beautiful./Your car is very fast./This pencil is yours./I always need you. . . . .

Unit 3 he/his/him/his

(Declension of personal pronouns: subject pronoun-possessive adjective-object pronoun-possessive pronoun)

I my me mine/You your you yours/He his him his/She her her hers/

It its it X/We our us ours/You (plural form) your you yours/They their them theirs

(Use of declension) He is a scientist./His name is Kevin./I love him./This red car is his. . . . .

(He/His) is eleven years old./(He/His) jacket is expensive./I call (his/him) every day./This umbrella is (him/his). . . . .

He runs every morning./His room is very dirty./I meet him every Monday./This candy is his. . . . .

Unit 4 she/her/her/hers, It/Its/It/-

(Declension of personal pronouns: subject pronoun-possessive adjective-object pronoun-possessive pronoun)

I my me mine/You your you yours/He his him his/She her her hers/

It its it X/We our us ours/You (plural) your you yours/They their them theirs

(Use of declension) She is a dentist./Her name is Sally./This coin is hers./ Everybody loves her. . . . .

(She/hers) is my teacher./This is (her/hers) umbrella./This puppy is (her/hers)./ They need (her/hers). . . . .

She is a hairdresser./The black shoes are hers./Her shoes are beautiful./Everybody likes her. . . . .

It is a pencil./Its color is black./I need it. ...

(It/Its) is my red crayon./Many students like (it/its) color./I play with (it/its). . . . .

It is a science book./I like its size./I wear it. . . . .

The fourth layer is a stage to learn about declension of personal pronouns, and is configured to provide 1,600 iterative learnings of various expressions of subject pronouns, object pronouns, possessive adjectives, and possessive pronouns based on various sentences with verb ‘be’ learned in the first and second layers, so that the learner can learn about declension of personal pronouns, which are foundational to learning of contents from the fifth layer to the 33^{rd} layer that the learner will learn later. Examples of the contents of the third layer to be learned are as follows.

Unit 1 we/our/us/ours, they/their/them/theirs

(Use of declension) We are very happy./Our classroom is large./The apples are ours./She visits us. . . . .

(Use of declension) They are in the library./Their teacher is very strict./I visit them every Sunday./Our classroom is bigger than theirs. . . . .

(We/Our/Us/Ours) are very happy all the time./Doctors help (we/our/us/ours)./

(We/Our/Us/Ours) bags are very heavy./The tickets are (we/our/us/ours). . . . .

(They/Their/Them/Theirs) go to the same school./(They/Their/Them/Theirs) daughters are tall./

I give (they/their/them/theirs) homework every day./This is not (they/their/them/theirs). . . . .

We are in the third grade./This classroom is ours./The teacher calls us names./Our school is great. . . . .

They make a beautiful song./Their song is popular./We really love them./Ours is faster than theirs. . . . .

Unit 2 an+vowel/a+consonant, book+s/bus+es (expressions of singular and plural nouns)

(Singular nouns: a+consonant) [a bear/a coat/a dog/a frog/a goat . . . .]

(Singular nouns: an+vowel) [an ambulance/an escalator/an injection/an orange/an umbrella . . . .]

(Kinds of nouns) person [girl/boy/teacher/uncle . . . .], place [school/library/classroom/store . . . .], thing [pencil/book/orange/computer . . . .], and animal [cat/dog/cow/elephant . . . .]

(Singular nouns) [an eraser/an animal/a cake/a banana/a friend/an ostrich/an aunt/a hat/a baby/an astronaut . . . .]

(Plural nouns: noun+s) [a cat cats/a ruler rulers/a cup cups/an onion onions/an answer answers/a tail tails . . . .]

(Plural nouns: noun+es) [a bus buses/a dish dishes/a watch watches/a fox foxes/a potato potatoes . . . .]

(Singular and plural nouns) [three books/a cat/three buildings/ten fingers/an oven/ a soldier/an ant/two sandwiches . . . .]

Unit 3 a leaf/leaves (Expressions of singular and plural nouns)

(Regular plurals of nouns: noun+yes) [a leaf leaves/a wolf wolves/a knife knives/a wife wives/a shelf—shelves . . . .]

(Plural form of nouns) [ten fingers/ten toes/many brooms/six elves/many witches/ twelve months/eight buttons . . . .] There are many (things/thinges) on the table./We use our (noses/nosees) to smell./I usually wash the (dishs/dishes)./We need three (loafes/loaves) of bread./I help my (classmatees/classmates) all the time. . . . .

(Singular form) A calf is a young cow./There is an armchair in the living room./An ostrich cannot fly./I have an idea. . . . .

(Plural form) Amy has two cats./People live in houses./There are many bones in my body./Knives are very sharp. . . . .

(Discrimination of singular form and plural form) We need three boxes./She is an adult./We play many games together./My daughter looks like an angle. . . . .

(Discrimination of singular form and plural form) Students take many tests./He is a pharmacist./I have an earache./Green tea leaves are good for health. . . . .

Unit 4 a baby/babies (Expressions of singular and plural nouns)

(Regular plurals of nouns: noun+ies) [a city cities/a baby babies/a story stories/a fly flies/a hobby hobbies . . . .]

(Expressions of plural nouns) [three cities/two boys/many babies/many stories/four days/two ways/ten candies/three ladies . . . .]

(Irregular plurals of nouns) [a fish fish/a sheep sheep/a deer deer/a man men/a woman women/a foot feet/a tooth teeth/a goose geese/a child children/a mouse mice]

(Irregular expressions of plural nouns) (Sheeps/Sheep) are farm animals./We use our (tooths/teeth) to chew./He has two (childs/children)/Snakes eat (mouses/mice)./Hunters kill many (deer/deers)./I catch many (fish/fishes). . . . .

(Expressions of singular and plural nouns) Babies sleep many hours./An author is a writer./I brush my teeth every day./I have six watches. . . . .

(Expressions of singular and plural nouns) There are many libraries in his neighborhood./Many men love sports./I need an envelope./He is an engineer./People hate cockroaches./This store sells many toys./The leaves are falling off the tree. . . . .

The fifth layer is a stage to learn about the present tense verbs, and is configured to provide 1,600 iterative learnings of various expressions of present tense regular verbs based on various sentences with verb ‘be’ and personal pronouns learned in the first to fourth layers, so that the learner can learn about the present tense verbs, which are foundational to learning of contents from the sixth layer to the 33^{rd} layer that the learner will learn later. Examples of the contents of the fifth layer to be learned are as follows.

Unit 1 I love apples./He, She loves apples. (verb+s)

(Find verbs in sentences) I like my family./We call her “Baby”./I listen to music every night./They swim in the pool./

The weather is so cold./My parents feel happy./Many people are angry./I go to bed at 11 o'clock./I promise you. . . . .

(Verb rule 1) [verb+s] Normally, in the present tense, we add ‘s’ to the end of the verb in the 3^{rd} person singular (He, She, It).

[opens/thinks/likes/learns/jumps/listens/reads/dreams/looks/feels/sleeps/ speaks/barks/hates/smells . . . .]

(Verb rule according to subjects) I (clean/cleans) my room./We (work/works) very hard./She (take/takes) a shower in the morning./

He (sleep/sleeps) late./Sarah and I (take/takes) a piano lesson./It (taste/tastes) good./He (live/lives) in Seoul. . . . .

(Find the subject according to the verbs) (He/They) play basketball after school./(She/I) drives her car./(It/They) begins at 3 o'clock. . . . .

Sally cleans her desk every morning./I want a cheese cake./Tom speaks English and French./My mom likes Chinese food./

He looks tired./My class begins at 9 o'clock./Students wear school uniforms./He gives many presents to me. . . . .

Unit 2 I watch TV./She watches TV. (verb+es)

(Find verbs in sentences) I get up at 6 o'clock./She is nine years old./They go to the same school./We play tennis together. . . . .

(Verb rule 2) [verb+es] Normally, in the present tense, ‘es’ is added to the end of the verb in the 3^{rd} person singular (He, She, It) if the verb ends in -s, -sh, -ch, -o, and -x. [misses/brushes/watches/goes/mixes/kisses/washes/catches/does/fixes/teaches/touches/pushes/finishes . . . .]

(Verb rule according to subjects) Susan watches movies on Saturdays./My mother knows my friend./My grandmother always kisses me on my cheek./He goes to school with his friends./We brush our teeth after meals./She washes her hands before meals. . . . .

(Comparison of changes in verbs) I (watch/watches) movies every weekend. She (watch/watches) movies every weekend./

We (do/does) our homework every night. He (do/does) his homework every night. . . . .

Sarah brushes her teeth after meals./I watch TV every night./He goes to church every Sunday./We swim in the pool./

Kevin and I eat hamburgers for lunch./My sister reads a comic book every night./My father works at the post office. . . . .

Unit 3 I, You, They, We get up/He, She gets up (the third person singular & verbs), and time expressions

(Find verbs in sentences) He smiles at me./It is far away./He washes the dishes./Lions eat meat./Many people like cupcakes./Amy goes to school by bus./They are my best friends./You and your sister study very hard./He wakes up in the morning.

(Time expressions for o'clock) 1:00=It's one o'clock./2:00=It's two o'clock. ˜12:00=It's twelve o'clock. . . . .

(Time expressions for thirty minutes) 1:30=It's one thirty.=It's half past one. ˜12:30=It's twelve thirty.=It's half past twelve. . . . .

(Time expressions for fifteen minutes) 1:15=It's one fifteen.=It's a quarter past one. =It's a quarter after one. ˜12:15=It's twelve fifteen.=It's a quarter past twelve.=It's a quarter after twelve. . . . .

(Time expressions for forty five minutes) 1:45=It's one forty five.=It's a quarter to two. ˜12:45=It's twelve forty five.=It's a quarter to one. . . . .

(Time expressions & present tense verbs) He wakes up at 7 o'clock./He eats breakfast at 7:30./He washes his face at 8 o'clock./He brushes his teeth at 8 o'clock./He goes to school at 8:45./His class starts at 9 o'clock./He learns English at 10:30. . . . .

(How to make sentences using time expressions & verbs) I get up at seven./He gets up at eight./I eat breakfast at eight./He eats breakfast at eight thirty. . . . .

Unit 4 I study English./He, She studies English. (verb+ies)

(Verb rule 3) For verbs that end in a consonant+y, we remove the y and add —ies in the 3^{rd} person singular (He, She, It). [studies/plays/pays/flies/tries/worries/prays/copies/buys/stays/carries/dries/sprays/spies/applies . . . .]

A baby cries aloud./She has two brothers./He studies very hard./Jack flies a kite./ My mother always worries about me. . . . .]

I go out on Sundays./She has a wonderful garden./Jennifer flies a kite./Sam draws a picture very well./A baby cries a lot./Jack sends an e-mail every day./We enjoy coffee after meals./I make many mistakes./We need air. . . . .

You study English every day. (He) He studies English every day./We watch a talk show. (She) She watches a talk show./I stay home all day long. (He) He stays home all day long./They pick flowers in the garden. (He) He picks flowers in the garden. . . . .

(Write with verbs in the 3^{rd} personal singular) My little sister cries always./He loves me./Sally teaches English./Tom plays soccer with his friends. . . . .

The sixth layer is a stage to learn about present tense verbs, and is configured to provide 1,600 iterative learnings of various expressions of declarative sentences, questions, negative sentences, positive answers and negative answers based on various sentences with verb ‘be’ and other verbs learned in the first to fifth layers, so that the learner can learn about present tense verbs, which are foundational to learning of contents from the seventh layer to the 33^{rd} layer that the learner will learn later. Examples of the contents of the sixth layer to be learned are as follows.

Unit 1 I, You, They, We have many books/He, She has many books (verb ‘have’) (Find subjects according to verbs) (I/She) has a desk./(You/He) have one daughter./(She/They) has a mobile phone./(It/I) has bones./(My father/You) has a cheap watch./(Your mother/I) have breakfast at seven./(Tom/I) has a pretty girlfriend.

(Find verbs according to subjects) Tom (have/has/haves) an expensive car./My father (have/has/haves) dinner at night./He (have/has/haves) a beautiful flower./She (have/has/haves) a long coat./You (have/has/haves) a handsome boyfriend. . . . .

(Find verbs according to subjects) Korea has four seasons./She has many baseballs./Tom has a small bag./Jennifer has a wonderful dress./We have a nice picture./Seoul has many tall buildings./Mary has breakfast at 7 o'clock./I have four classes. . . . .

Sally has an expensive car. (I) I have an expensive./I have dinner at night. (My mother) My mother has dinner at night. . . . .

I have black hair. My daughter has black hair./You have an umbrella. Your sister has an umbrella. . . . .

Unit 2 Do you, I, they, we see . . . . ?/Does he, she see . . . . ? (Questions with verbs) (Questions with verb ‘be’) (Am/Are/Is) I tall?/(Am/Are/Is) you tired?/(Am/Are/Is) it fun?/(Am/Are/Is) she a doctor?. . . .

(Questions with verbs) (Do/Does) you clean your room?/(Do/Does) you run fast?/(Do/Does) she take a shower in the morning?/(Do/Does) he sleep late?/(Do/Does) it taste good?/(Do/Does) they stay in Seoul?/(Do/Does) we work very hard?. . . .

(Find base forms in questions) Do they (swim/swims/swimes) in the sea?/Does he (walk/walks/walkes) to school?/Do you (like/likes/likees) sports?/Does she (take/takes/takees) a shower after work?/Does it (rain/rains/raines) a lot in summer?

(Do/Does) your sister (give/gives/givees) many questions to you?/(Do/Does) your friends (wear/wears/weares) school uniforms?/(Do/Does) the school (close/closes/closees) on the weekend?/(Do/Does) rabbits (eat/eats/eates) carrots?. . . .

Unit 3 I, You, They, We don't see . . . ./He, She doesn't see . . . . (negative sentences of verbs)

(Negative sentences of verb ‘be’) I am not=I'not/You are not=You're not=You aren't/He, She, It is not=He's, She's, It's not=He, She, It isn't

(Negative sentences of verbs) I, You, We, They do not=I, You, We, They don't/He, She, It does not=He, She, It doesn't

You (don't/doesn't) clean your room./Your aunt (don't/doesn't) visit your mother./His sister (don't/doesn't) have a job./

He and his friend (don't/doesn't) enjoy the party./Judy (don't/doesn't) drink milk in the morning./

I (don't/doesn't) take a shower. . . . .

My dog (don't/doesn't) (like/likes/likees) milk./My sister (don't/doesn't) (wash/washs/washes) her hands./

I (don't/doesn't) (feel/feels/feeles) tired today./You (don't/doesn't) (learn/learns/ learnes) Spanish. . . . .

(Make negative sentences of verb ‘be’ and other verbs) You don't get up early./Tom isn't in his room now./You don't clean the room./

They aren't my grandparents./We don't study English very hard./Tom doesn't do his homework after school. . . . .

Unit 4 Yes, I do. , No, I don't/Yes, he does. , No, he doesn't. (positive answer, negative answer)

(Positive/Negative answers to verb questions) Yes, (you, we, they, I) do./No, (you, we, they, I) don't./Yes, (he, she, it) does./No, (he, she, it) doesn't.

Your brother has a red car. (Question) Does your brother have a red car? (Positive answer) Yes, he does./

Tom reads a newspaper in the living room. (Question) Does Tom read a newspaper in the living room? (positive answer) Yes, he does. . . . .

His grandfather likes her. (Question) Does his grandfather like her? (negative answer) No, he doesn't./

We get up early. (Question) Do we get up early? (negative answer) No, we don't. , No, you don't. . . . .

(Positive/Negative answers to verb ‘be’ questions)

Is your father a doctor? Yes, he is. No, he isn't./Are my brother and I very tall? Yes, you are. No, you aren't. . . . .

(Verb questions & positive/negative answers) Does Tom have a nice hobby? Yes, he does. No, he doesn't./

Do their parents know me? Yes, they do. No, they don't./Do you cook very well? Yes, I do. No, I don't. . . . .

The seventh layer is a stage to learn about past tense verbs, and is configured to provide 1,600 iterative learnings of various expressions of declarative sentences, questions, negative sentences, positive answers and negative answers in the past tense based on various sentences with verb ‘be’ and other verbs learned in the first to sixth layers, so that the learner can learn about past tense verbs, which are foundational to learning of contents from the eighth layer to the 33^{rd} layer that the learner will learn later. Examples of the contents of the seventh layer to be learned are as follows.

Unit 1 Past tense of verb ‘be’ & Change of regular verbs in past tense (+d,+ed, +ied)

(verb ‘be’ past form)—am was/are were/is was (verb ‘be’ in past tense) He was ten years old last year./I was in Australia./They were at the beach yesterday./She was sick. . . . .

(Negative sentences of verb ‘be’ in the past form) Your key was on the sofa. (negative sentence) Your key was not (wasn't) on the sofa. . . . .

(Question of verb ‘be’ in the past form) Tom was at the library. (Question) Was Tom at the library?. . . .

(Regular verbs in the past form 1) Verb+ed

(Regular verbs in the past form 2) Verb+d if the verb ends in−e. [thanked/helped/ checked/listened/answered/cooked/liked/loved/hated/closed/shared/exercised/ wasted/arrived . . . .]

(Regular verbs in the past form 3) For verbs that end in a consonant+y, we remove the y and add ‘ied’/For verbs that end in a vowel+y, ‘ed’ is added [studied/carried/cried/copied/worried/married/tried/played/enjoyed/stayed/prayed/annoyed/destroyed/sprayed . . . .]

(Regular verbs in the past form 4) For verbs that end in ‘consonant+vowel+consonant’, we add the final consonant once more and add ‘ed’ [begged/planned/skipped/dropped/stopped/grabbed/hugged/opened/fixed/mixed/bowed/towed/showed/visited . . . .]

I studied science./My brother exercised at the gym./They skipped their classes./We tried our best./My friends visited me. . . . .

Unit 2 There is/There are, Past tense verb pronunciation rules (/d/,/t/,/id/)

(Past tense verb pronunciation rule 1) If the verb base ends in a voiced sound, then the ‘−ed’ ending sounds like ‘d’. [smiled/opened/enjoyed/received/delayed . . . .]

(Past tense verb pronunciation rule 2) If the verb base ends in a voiceless sound, then the ‘−ed’ ending sounds like ‘t’. [asked/watched/brushed/helped/looked/passed . . . .]

(Past tense verb pronunciation rule 3) If the verb base ends in a ‘t’ or ‘d’ sound already, then the ‘−ed’ ending sounds like ‘id’. [wanted/started/needed/tasted/visited/counted . . . .]

(Introductory there) There is+Singular noun/There are+Plural noun (Introductory there in the present tense) There (is/are) a bus on the road./There (is/are) many chairs in the room. . . . .

(Introductory there in the past tense) There (was/were) a bus on the road./There (was/were) many chairs in the room. . . . .

(Introductory there in negative sentences) There (is/are) not a bus on the road./There (was/were) not many chairs in the room. . . . .

(Introductory there in questions) There (is/are) a bus on the road. (Question) Is there a bus on the road?/There (was/were) many chairs in the room. (Question) Were there many chairs in the room?. . . .

(Verb form according to time expressions)—[cry] His baby cries every day. His baby cried yesterday./[watch] I watch TV every day. I watched TV last night./[wash] My mom washes her hair every night. My mom washed her hair last night. . . . .

Unit 3 Past tense irregular verbs (1/3)

(Past tense irregular verbs) [began/bit/blew/broke/brought/built/burnt/bought/ caught/chose/came/cost/cut/did/drew/drank/drove/ate/fell/fed/felt/fought/found/forgot/froze/flew]

(Expressions of past tense irregular verb) I bought many books./She drank a glass of milk./My school began at eight thirty./

They built many houses./Emily and Tony caught fish./My mother brought some food./I cut an apple in half . . . .

(Verb expressions according to time expressions) [drink] Judy drinks coffee every day. Judy drank coffee two hours ago./[cut] I cut my fingernails every Sunday. I cut my fingernails last Sunday. . . . .

They built many houses./His dog bit him./Lisa and David caught many fish./I did my homework last night. . . . .

(Make sentences with past tense verbs) He bought three books yesterday./She drank some orange juice./My father drove his car. . . . .

Unit 4 Past tense irregular verbs (2/3)

(Past tense irregular verbs) [got/gave/went/grew/hung/had/heard/hid/hit/held/hurt/kept/left/lent/lost/meant/met/paid/put/read/rode/rang/ran/took]

(Expressions of past tense irregular verbs) I got a letter from my uncle./He gave me flowers./Tim went to work by car./

She grew up in America./They had nice cars./My dog hid under the bed./The player hit a home run. . . . .

(Verb expressions according to time expressions) [grow] She always grow flowers. She grew flowers last month./

[have] They have a problem today. They had a problem three days ago. . . . .

She put her cup on the table./Players hit the ball./My sister had a shower./I went to school yesterday. . . . .

(Make sentences with past tense verbs) My father read a book yesterday./Ben did his homework last night./She gave me some flowers. . . . .

The eighth layer is a stage to learn about past tense verbs, and is configured to provide 1,600 iterative learnings of various expressions of declarative sentences, questions, negative sentences, positive answers and negative answers in the past tense based on various sentences with verb ‘be’ and other verbs learned in the first to seventh layers, so that the learner can learn about past tense verbs, which are foundational to learning of contents from the ninth layer to the 33^{rd} layer that the learner will learn later. Examples of the contents of the eighth layer to be learned are as follows.

Unit 1 Past tense irregular verbs (3/3)

(Past tense irregular verbs) [said/sold/sent/shook/shot/shut/sang/sank/sat/ slept/spent/spoke/stood/stole/swam/took/taught/told/thought/threw/understood/woke/won/wrote]

(Expressions of past tense irregular verbs) I wrote a letter in English./I understood the meaning of the word./They slept in the bedroom./

I shook hands with him./They taught math at school./I took a bus./He stood in front of the table. . . . .

(Change present tense verbs into past tense verbs) She speak English well. (Past) She spoke English well./

We win the game. (Present) We won the game./The bus leaves on time. (Past) The bus left on time. . . . .

Tom went to the theater last Sunday./Kate wrote a letter yesterday./Kelly saw an actor there last time. . . . .

((Make sentences with past tense verbs) Judy slept all day long./Sally sent a letter to him./My friend took a taxi yesterday. . . . .

Unit 2 You needed a house./Did you need a house? (Past tense verbs in questions)

(Past tense verb ‘be’ in questions) (Was/Were) he ten years old last year?/(Was/Were) it your favorite color?/(Was/Were) you fat before?. . . .

(Past tense verb ‘be’ in declarative sentences and questions) I am very tired. (Past) I was very tired. (Past tense question) Was I very tired?. . . .

(Find verb bases in questions) Did I (buy/buys/bought) many books?/Did she (drink/drinks/drank) a glass of milk?. . . .

(Past tense verbs in declarative sentences and questions) My younger brother fights with his friends. (Past) My younger brother fought with his friend.

(Past tense question) Did my younger brother fight with his friends?. . . .

(Make past tense questions) Did you bring any food?/Did the player hit a homerun?/Did your sister swim in the pool?. . . .

Unit 3 Yes, he did./No, he didn't (Positive answer & negative answer to past tense verb questions)

(Past tense verb ‘be’ question & answer) Were you at home? Yes, I was. No, I wasn't. . . . .

(Past tense verb ‘be’ question & answer) He was very sad. (Question) Was he very sad? (Positive) Yes, he was. (Negative) No, he wasn't. . . . .

(Past tense verb question & answer) Did he need a house? (Positive) Yes, he did. (Negative) No, he did not. (didn't) . . . .

(Past tense verb question & answer) I studied science in the library. (Question) Did I study science in the library? (Positive) Yes, you did./

She talked on the phone for a long time. (Question) Did she talk on the phone for a long time? (Positive) Yes, she did. . . . .

(Past tense verb question & answer) We found the lost key. (Question) Did we find the lost key? (Negative) No, you (we) didn't./

Your father visited Europe last year. (Question) Did your father visit Europe last year? (Negative) No, he didn't. . . . .

Unit 4 You didn't need a house. (Past tense verbs in negative sentences)

(Past tense verb ‘be’ in negative sentences) I, He, She, It was not.=I, He, She, It wasn't./You, We, They were not.=You, We, They weren't. . . . .

(Past tense verbs in negative sentences) I needed a house. (Negative sentence) I didn't need a house. . . . .

(Find verbs in past tense negative sentences) She didn't (eat/eats/ate) chocolate cakes./I didn't (find/found) all the answers./

Tom didn't (go/goes/went) to work by car./My dog didn't (hide/hides/hid) under the bed./We didn't (hang/hung) a picture. . . . .

(Make negative sentences with past tense verbs) He didn't come to the party./You didn't draw animals./Apples didn't fall from the tree. . . . .

(Make negative sentences with past tense verbs and verb ‘be’)

They weren't birds./He wasn't in the classroom./It didn't rain a lot yesterday./He didn't have an eraser./

She didn't buy them at the market./Tom didn't do his homework after school./He wasn't a great doctor. . . . .

The ninth layer is a stage to learn about the present continuous tense, and is configured to provide 1,600 iterative learnings of various expressions of declarative sentences, questions, negative sentences, positive answers and negative answers in the present continuous tense based on various sentences with verb ‘be’ and other verbs learned in the first to eighth layers, so that the learner can learn about the present continuous tense, which are foundational to learning of contents from the tenth layer to the 33^{rd} layer that the learner will learn later. Examples of the contents of the ninth layer to be learned are as follows.

Unit 1 She is sleeping. (Present continuous, +ing applied rules 1, 2)

(Present continuous: Subject+be+verb+ing) I am walking./She is sleeping./We are singing./They are working./You re crying. . . . .

(+ing applied rule 1) Verb+ing [hearing/skiing/thinking/dreaming/speaking/ playing/enjoying/saying/eating/meeting . . . .]

(+ing applied rule 2) For verbs that end in ‘-e’, we remove the e′ and add ‘ing’ [taking/living/making/using/losing/giving/receiving/moving . . . .]

Judy is talking with her friend./My father is writing a letter./Tom is fixing his bicycle./They are dancing. . . . .

I am going to school./We are eating strawberries now./Mike is doing his homework./ You are washing your face. . . . .

She bakes cookies. (Present continuous) she is baking cookies./A puppy digs a hole. (Present continuous) A puppy digging a hole. . . . .

He fixes my computer. (Present continuous) He is fixing my computer./Jane plays the piano. (Present continuous) Jane is playing the piano. . . . .

Unit 2 She is sleeping. (Present continuous, +ing applied rules 3, 4)

(Present continuous: Subject+be+verb+ing) Sally is crying./Tom is laughing./They are swimming./The baby is sleeping./The dog is barking. . . . .

They are eating dinner./He is jumping up and down./I am reading a book./My uncle is telling a funny story. . . . .

(+ing applied rule 3) For verbs that end in ‘consonant+vowel+consonant’, we add the final consonant once more and add ‘ing’/(+ing applied rule 4) For verbs that end in ‘−ie ’, we change ‘ie’ into ‘y’ and add ‘ing’.

Many cute boys are cutting the paper./Daniel is swimming in the pool./He is lying on the bed./Many children are dying of hunger. . . . .

I buy many things every day. (Present continuous) I am buying many things now./We use computers every day. (Present continuous) We are using computers now. . . . .

They get ready. (Present continuous) They are getting ready./She draws a picture. (Present continuous) She is drawing a picture. . . . .

(Correct wrong parts) I am chooseing my new bike. I am choosing my new bike./

The police officer is putting on his uniform. The police officer is putting on his uniform. . . . .

(Verbs which are not normally used in the present continuous) [know/forget/understand/remember/like/dislike/love/hate/want/need/cost/sound/own/matter]

I am liking chimpanzees. (X) vs I like chimpanzees. (0)/He is needing my help. (X) vs He needs my help. (0)

Unit 3 Is she sleeping?/Yes, she is./No, she isn't. (Present continuous in questions & answer)

(Present continuous in questions) Chris and Simon are playing computer games. (Question) Are Chris and Simon playing computer games?. . . .

My mother is boiling some water. (Question) Is my mother boiling some water?/He is receiving an award. (Question) Is he receiving an award?. . . .

(Present continuous in question & answer) You are waiting for the next bus. (Question) Are you waiting for the next bus? (Positive answer) Yes, I am. . . . .

(Present continuous in question & answer)

My sister is reading a story. (Question) Is my sister reading a story? (Negative answer) No, she is not.=No, she's not.=No, she isn't. . . . .

(Present continuous & question) She drinks a cup of tea. (Present continuous) She is drinking a cup of tea. (Question) Is she drinking a cup of tea?. . . .

You go to school by bus. (Present continuous) You are going to school by bus. (Question) Are you going to school by bus?

(Positive) Yes, I am. (Negative) No, I'not. . . . .

(Correct wrong parts) Is a girl sit on the bench? (X) vs Is a girl sitting on the bench? (O) . . . .

(Make present continuous quetions) Are they walking?/Is she sleeping?/Is Jessica washing her face?/Is he doing his homework?. . . .

Unit 4 She is not sleeping. (Present continuous in negative sentences)

(verb ‘be’ negative sentence) I am not=I'not/You, They, We are=You, They, We're not/She, He is not=She, He, It's not . . . .

(Present continuous in negative sentence) She is buying a coat. (Negative sentence) She is not buying a coat.=She's not buying a coat.=She isn't buying a coat. . . . .

They are not walking along the beach.=They're not walking along the beach.=They aren't walking along the beach. . . . .

(Present continuous & negative sentence)

We have a snowball fight. (Present continuous) We are having a snowball fight. (Negative sentence) We are not having a snowball fight. . . . .

He is not repairing my watch./She is annoying me./Are you wrapping the gift?/B-boys are dancing on the street./

We are sharing our food./Are your father checking the homework?/She is not combing her hair. . . . .

(Make present continuous sentences)

She is studying./Is she studying?/She is not studying./He is carrying a box./Is he carrying a box?/He is not carrying a box. . . . .

The tenth layer is a stage to learn about the past continuous tense and future tense, and is configured to provide 1,600 iterative learnings of various expressions of declarative sentences, questions, negative sentences, positive answers and negative answers in the past continuous tense and future tense based on various sentences with verb ‘be’ and other verbs learned in the first to ninth layers, so that the learner can learn about the past continuous tense and future tense, which are foundational to learning of contents from the 11^{th} layer to the 33^{rd} layer that the learner will learn later. Examples of the contents of the tenth layer to be learned are as follows.

Unit 1 You were sleeping./Were you sleeping? (Past continuous, questions, answers, and negative sentences)

(Present continuous) I am watching TV./You, We, They are drinking water./He, She, It is jumping on the bed. . . . .

(Past continuous) I was watching TV./You, We, They were drinking water./He, She, It was jumping on the bed. . . . .

(Past continuous) She was reading a book./I was teaching English./They were playing baseball./We were drinking water. . . . .

(Past continuous question) You were talking on the phone. (Question) Were you talking on the phone?. . . .

(Past continuous question & answer) Ben was fixing the radio. (Question) Was Ben fixing the radio? (Positive) Yes, he was.

(Negative) No, he was not.=No, he wasn't. . . . .

(Past continuous & Question) She is looking for the key. (Past continuous) She was looking for the key. (Question) Was she looking for the key. . . . .

(Past continuous in negative sentence) They were speaking French. (Negative sentence) They were not (weren't) speaking French. . . . .

(Make past continuous sentences) You were walking to school./Were you walking to school?/You weren't walking to school. . . . .

Unit 2 She will go home./Will she go home? (Future tense, Questions, Answers, and Negative sentences)

(Verb base/If the subject is in the 3^{rd} personal singular/Past) [watch/watches/ watched , end/ends/ended , study/studies/studied . . . .]

(Future tense: will+verb base) She cleans her room. (Future) She will clean her room./ I am at home. (Future) I will be at home. . . . .

I (will clean/will cleans) my room./He (will help/will helps) me tonight./We (will drinks/will drink) coffee. . . . .

(Future) Many leaves will fall from a tree./I will bring some food./We will hang a picture on the wall. . . . .

(Future tense question) You will watch a talk show. (Question) Will you watch a talk show?. . . .

(Future tense question & answer)

He will attend the class. (Question) Will he attend the class? (Positive) Yes, he will. (Negative) No, he will not.=No, he won't. . . . .

They climbed up the mountain. (Future) They will climb up the mountain. (Question) Will they climb up the mountain?. . . .

(Future tense negative sentence) She will be afraid of snakes. (Negative sentence) She will not be afraid of snakes.=She won't be afraid of snakes. . . . .

Unit 3 (Review of verb ‘be’ and other verbs in present simple, present continuous, past simple, past continuous, and future tense)

(Present and future) (Present) She cleans her room. (Future) She will clean her room./(Present) My mom studies Chinese. (Future) My mom will study Chinese. . . . .

(Past and future) (Past) I went to Australia. (Future) I will go to Australia./(Present) You skipped your math class. (Future) You will skip your math class. . . . .

(Present continuous and future) (Present continuous) They are preparing dinner. (Future) They will prepare dinner./(Present continuous) I am staying at home. (Future) I will stay at home. . . . .

(Past continuous and future) (Past continuous) The dog was running away. (Future) The dog will run away./(Past continuous) We were trying on hats.

(Future) We will try on hats. . . . .

(Present simple, present continuous and past continuous declarative sentences and questions with verb ‘be’) He is a famous actor. (Question) Is he a famous actor?. . . .

(Verbs in present tense and question) Your uncle lives in Japan. (Question) Does your uncle live in Japan?. . . .

(Verbs in past tense and question) They came home at 7 o'clock. (Question) Did they come home at 7 o'clock?. . . .

(Future tense and question) Students will match the pictures with the words. (Question) Will students match the pictures with the words?. . . .

(Present simple, present continuous and past continuous declarative sentences and negative sentences with verb ‘be’) She is talking on the phone now.

(Negative sentence) She is not talking on the phone now. . . . .

(Verbs in present tense and negative sentence) She tells me the truth. (Negative sentence) She doesn't tell me the truth. . . . .

(Verbs in past tense and negative sentence) We learned about animals. (Negative sentence) We didn't learn about animals. . . . .

(Future tense and negative sentence) He will check the weather forecast. (Negative sentence) He won't check the weather forecast. . . . .

(Make sentences according to time expressions) [work] (Present) I work every day. (Present continuous) I am working now. (Past) I worked yesterday.

(Past continuous) I was working when you called me. (Future) I will work tomorrow. . . . .

Unit 4 You are going to sleep./Are you going to sleep?/You are not going to sleep. (be going to which means the future, questions, negative sentences)

(Future tense: will=be going to) I will study math.=I am going to study math. . . . .

(Future tense: ‘be going to’ in question) He is going to leave for Australia. (Question) Is he going to leave for Australia?. . . .

(Present and future tenses: ‘be going to’ in question) Bill takes pictures. (Future) Bill is going to take pictures. (Question) Is Bill going to take pictures?. . . .

(Past and future tenses: ‘be going to’ in question) We began the party at 7 o'clock. (Future) We are going to begin the party at 7 o'clock.

(Question) Are we going to begin the party at 7 o'clock. . . . .

(Future tense: ‘be going to’ in negative sentence) She is going to meet her friends. (Negative sentence) She is not going to meet her friends. . . . .

(Future tense: ‘be going to’ in declarative, question, and negative sentences) (Past) You walked to the post office. (Future) You are going to walk to the post office.

(Question) Are you going to walk to the post office? (Negative sentence) You are not going to walk to the post office. . . . .

(Make declarative sentences according to time expressions) [drink] (Present) He drinks milk every day. (Present continuous) He is drinking milk now. (Past) He drank milk last night.

(Past continuous) He was drinking milk when I saw him. (Future) He will drink milk tomorrow. (Future) He is going to drink milk tomorrow. . . . .

(Make questions according to time expressions) [eat] (Present) Do you eat chicken every day? (Present continuous) Are you eating chicken now? (Past) Did you eat chicken yesterday?

(Past continuous) Were you eating chicken when I called you? (Future) Will you eat chicken tomorrow? (Future) Are you going to eat chicken tomorrow?. . . .

(Make negative sentences according to time expressions) [watch] (Present) He doesn't watch the movie every day. (Present continuous) He is not watching the movie now.

(Past) He didn't watch the movie last night. (Past continuous) He was not watching the movie when I called him.

(Future) He will not watch the movie tomorrow. (Future) He is not going to watch the movie tomorrow. . . . .

The 11^{th} layer is a stage to learn about exclamatory, suggesting, and imperative sentences, and is configured to provide 1,600 iterative learnings of various expressions of exclamatory, suggesting, and imperative sentences based on various present simple, past simple, present continuous, past continuous, and future tense sentences with verb ‘be’ and other verbs learned in the first to tenth layers, so that the learner can learn about exclamatory, suggesting, and imperative sentences, which are foundational to learning of contents from the 12^{th} layer to the 33^{rd} layer that the learner will learn later. Examples of the contents of the 11^{th} layer to be learned are as follows.

Unit 1 What a tall boy (he is)!/Let's go. (Exclamatory sentence with ‘what’, Suggesting sentence with ‘Let’)

(Verb base/If the subject is in the 3^{rd} personal singular/Past/Past continuous) [write/ writes/wrote/writing , stay/stays/stayed/staying . . . .]

(Suggesting sentence: Let's+verb base) Let's (eats/eat/ate) Korean food./Let's (try/tried/trying) one more time. . . . .

(Suggesting sentence & answer) Let's (opens/open/opened) our books. (Positive) Yes, let's. (Negative) No, let's not. . . . .

(Noun) Person [girl/boy/teacher/uncle], Place [school/library/classroom/store], Thing [pencil/book/orange/computer], Animal [cat/dog/cow/elephant]

(Find adjectives) This is a tall tree./My room is clean./They are happy boys./It is an expensive car./Tom is lazy. . . . .

(Exclamatory sentence: what+Singular noun) She is a happy girl. (Exclamatory) What a happy girl she is!. . . .

(Exclamatory sentence: what+Plural noun) They are rich writers. (Exclamatory) What rich writers they are!. . . .

(Exclamatory sentence with ‘what’) He is a fast runner. (Exclamatory) What a fast runner he is!=What a fast runner! (It is possible to omit the subject and verb) . . . .

(Change an exclamatory sentence into a declarative sentence) What a tall building it is! (Declarative) It is a tall building. . . . .

Unit 2 How funny (he is)! (Exclamatory sentence with ‘how’)

(Noun) Person [girl/boy/teacher/uncle], Place [school/library/classroom/store], Thing [pencil/book/orange/computer], Animal [cat/dog/cow/elephant]

(Find adjectives) She is tired./He is a fat boy./This place is nice./He is sick./This jacket is tight./He has big feet. . . . .

(Find adverbs) They walk slowly./We are very hungry./He drives carefully./He is really handsome./She is too tired. . . . .

(Exclamatory sentence with ‘how’) He is quiet. (Exclamatory) How quiet he is!. . . . /She speaks slowly. (Exclamatory) How slowly she speaks!. . . .

(Exclamatory sentence with ‘how’) He is wonderful. (Exclamatory) How wonderful he is!=How wonderful! (It is possible to omit the subject and verb) . . . .

(Use ‘what’ if there is a noun except the subject/Use ‘how’ if there is no noun except the subject)

He is a nice man. (Use ‘what’ because there is a noun) What a nice man he is!=What a nice man!. . . .

He is young. (Use ‘how’ because there is no noun) How young he is!=How young!. . . .

(Position of preposition ‘on’) In case of a noun: try this shirt on (0)=try on this shirt (O)/In case of a pronoun: try it on (0) , try on it (X) . . . .

Unit 3 Study hard./Don't make a noise. (Positive imperative sentence, Negative imperative sentence)

(Verb base/If the subject is in the 3^{rd} personal singular/Past/Continuous) [write/ writes/wrote/writing , stay/stays/stayed/staying . . . .]

(Positive imperative sentence) Verb: You study hard. (Positive imperative) Study hard./ verb ‘be’: You are happy. (Positive imperative) Be happy. . . . .

(Positive imperative sentence) (Listens/Listening/Listen) carefully./(Speak/Spoke/Speaks) out loud. . . . .

(Negative imperative sentence) Verb: You stand up. (Negative imperative) Don't stand up./verb ‘be’: You are late. (Negative imperative) Never be late. . . . .

(Negative imperative sentence) Don't (speak/speaking/spoke) Korean in the classroom./Never (tells/told/tell) a lie to me. . . . .

(Positive imperative sentence) You are kind to your friends. (Positive imperative) Be kind to your friends. . . . .

(Negative imperative with ‘Don't’) You cheat on the exam. (Negative imperative) Don't cheat on the exam. . . . .

(Negative imperative with ‘Never’) You fall asleep during class. (Negative imperative) Never fall asleep during class. . . . .

(Make positive imperative sentences) Open your book./Tell me the truth./Look at me./Speak slowly./Turn on the radio. . . . .

(Make negative imperative sentences) Don't open the window./Don't cry anymore./ Don't worry about me./Never watch TV. . . . .

Unit 4 Exclamatory ‘What’, Exclamatory ‘How’

(Noun) Person [girl/boy/teacher/uncle], Place [school/library/classroom/store], Thing [pencil/book/orange/computer], Animal [cat/dog/cow/elephant]

(Exclamatory sentence) It is an easy question. (Exclamatory) What an easy question it is!/The weather is hot. (Exclamatory) How hot the weather is!. . . .

(Exclamatory ‘what’) He is a nice English teacher he is. (Exclamatory) What a nice English teacher he is!. . . .

(Exclamatory ‘how’) The result is incredible. (Exclamatory) How incredible the result is!. . . .

He is powerful. (Exclamatory) (What/How) powerful he is!/She is a polite student. (Exclamatory) (What/How) a polite student she is!. . . .

(Exclamatory sentence) Your son is active. (Exclamatory) How active your son is!/ You make a wonderful decision. (Exclamatory) What a wonderful decision you make!. . . .

(Exclamatory sentence) Korea is a beautiful country. (Exclamatory) What a beautiful country Korea is!/

This topic is serious. (Exclamatory) How serious this topic is!. . . .

The 12^{th} layer is a stage to learn about tag questions, and is configured to provide 1,600 iterative learnings of various expressions of tag questions based on various present simple, past simple, present continuous, past continuous, and future tense, exclamatory, suggesting, and imperative sentences with verb ‘be’ and other verbs learned in the first to 11^{th} layers, so that the learner can learn about tag questions, which are foundational to learning of contents from the 13^{th} layer to the 33^{rd} layer that the learner will learn later. Examples of the contents of the 12^{th} layer to be learned are as follows.

Unit 1 Mary is smart, isn't she? (Tag questions with verb ‘be’ in positive and negative sentences)

(Tag question with verb ‘be’ in positive sentence) He is a police officer, isn't he?/They are yellow flowers, aren't they?. . . .

(Tag question with verb ‘be’ in positive sentence) I am a student, aren't I?/Tom is your brother, isn't he?. . . .

(Tag question with verb ‘be’ in negative sentence) He is not rich, is he?/You aren't ten years old, are you?. . . .

(Tag question with verb ‘be’ in negative sentence) Sally is not a beautiful lady, is she?/ There are not three mistakes, are there?. . . .

(Tag question with verb ‘be’ in positive past tense) He was ten years old last year, wasn't he?/I was in Australia, wasn't I?. . . .

(Tag question with verb ‘be’ in positive past tense) Your key was on the sofa, wasn't it? /They were not expensive, weren't they?. . . .

(Tag question with ‘be going to’) David is going to study math, isn't he?/You are not going to walk home, are you?. . . .

(Make tag questions) Boys and girls are different, aren't they?/Tom is not lazy boy, is he?. . . .

Unit 2 Your father likes tomatoes, doesn't he? (Verbs in positive sentence, tag questions in negative sentences)

(Tag questions with verbs in positive sentence) She speaks English, doesn't she?/Sarah and I take a piano lesson, don't we?. . . .

(Tag questions with verbs in positive sentence) Their parents know me, don't they?/ You like sports, don't you?. . . .

(Tag questions with verbs in positive sentence) [work] My gather works at the post office, doesn't he?. . . .

(Tag questions with verbs in negative sentence) You don't clean your room, do you?/Your aunt doesn't visit your mother, does she?. . . .

(Tag questions with verbs in negative sentence) Tom doesn't have a new camera, does he?/They don't eat fast food, do they?. . . .

(Tag questions with verbs in negative sentence) [pick] He doesn't always pick up trash, does he?. . . .

(Make tag questions) Tim isn't an elementary school student, is he?/Sally is in her room, isn't she?/

They don't get up early, do they?/We don't study English very hard, do we?. . . .

Unit 3 I bought many books, didn't I? (Positive and negative tag questions in past tense)

(Tag question with verbs in positive past tense) My brother exercised at the gym, didn't he?/We tried our best, didn't we?. . . .

(Tag question with verbs in positive past tense) I bought many books, didn't I?/My school began at eight thirty, didn't it?. . . .

(Tag question with verbs in positive past tense) [build] We built very big apartments last month, didn't we?. . . .

(Tag question with verbs in negative past tense) They didn't work hard, did they?/She didn't go to school, did she?. . . .

(Tag question with verbs in negative past tense) Mike didn't live in Japan, did he?/ They didn't visit their grandparents, did they?. . . .

(Tag question with verbs in negative past tense) [know] Sam didn't know my address, did he?. . . .

(Make tag questions) Mary cried a lot, didn't she?/Kelly didn't like your present, did he?/They washed the dishes in the kitchen, didn't they?/You didn't catch the ball, did you?. . . .

Unit 4 Positive and negative tag questions in future tense, modal verbs, imperative sentences, and suggesting sentences

(Tag questions in positive future tense) I will clean my room, won't I?/Jane will work in a cafe, won't she?. . . .

(Tag questions in positive future tense) [take] Jack and Sam will take an art class, won't they?. . . .

(Tag questions in negative future tense) Kelly and I won't watch a movie, will we?/ Lisa won't miss him, will she?. . . .

(Tag questions in negative future tense) Jacob won't attend the class, will he?/My mom won't join the club, will she?. . . .

(Tag questions in negative future tense) [be] There won't be any problems, will there?. . . .

(Positive tag question with modal verb ‘can’) She can swim well, can't she?/I can climb to the top of the mountain, can't I?. . . .

(Negative tag question with modal verb ‘can’) They can't drink much milk, can they?/ My brother can't go there on foot, can he?. . . .

(Positive tag question with modal verb ‘should’) We should help poor people, shouldn't we?/You should keep your promise, shouldn't you?. . . .

(Negative tag question with modal verb ‘should’) You shouldn't hurry up, should you?/ You shouldn't chew gum in class, should you?. . . .

(Make tag questions) Your mother won't buy a new car, will she?/Her sister can swim well, can't she?. . . .

The 13^{th} layer of the intermediate building structure is a stage to learn about reflexive pronouns and impersonal subject ‘it’, and is configured to provide 1,600 iterative learnings of various expressions of reflexive pronouns and impersonal subject ‘it’ based on the sentence building structure of various tenses (present simple, past simple, present continuous, past continuous, and future) in questions, declarative, negative, exclamatory, suggesting, and imperative sentences learned in the first to 12^{th} layers, so that the learner can learn about reflexive pronouns and impersonal subject ‘it’, which are foundational to learning of contents from the 14^{th} layer to the 33^{rd} layer that the learner will learn later. Examples of the contents of the 13^{th} layer to be learned are as follows.

Unit 1 Reflexive pronouns for reflexiveness, emphasis, and idiomatic expressions

(Declension & reflexive pronouns) [I/my/me/mine/myself, you/your/you/yours/yourself, he/his/him/his/himself, she/her/her/hers/herself,

It/its/it/-/itself, we/our/us/ours/ourselves, you/your/you/yours/yourselves, they/their/them/theirs/themselves]

(Reflexiveness) I drew myself./She hurt herself while she was skating./Kevin protects himself./You enjoy yourself. . . . .

(Reflexiveness) Julia sometimes talks to herself./She is looking at herself in the mirror./You don't know yourself. . . . .

(Emphasis) I myself helped her./Mike baked cookies himself./Kelly bought it herself. . . . .

(Emphasis) I met Jenny herself/We saw Tim himself./Sam and mike talked to Amy herself. . . . .

A: What's wrong with your arm? B: I hurt myself last weekend./A: He looked so happy at the party. B: He enjoyed himself very much. . . . .

(Reflexive pronouns for idiomatic expression) [enjoy oneself/make oneself at home/help oneself/help oneself to/kill oneself/seat oneself/say to oneself/by oneself/for oneself/beside oneself/between ourselves/of itself/in itself]

Please take care of (you/yourself)./She killed (her/herself) last night./I am very proud of (me/myself). . . . .

Unit 2 Reflexive pronouns for reflexiveness, emphasis, and idiomatic expressions

(Declension & reflexive pronouns) [I/my/me/mine/myself, you/your/you/yours/yourself, he/his/him/his/himself, she/her/her/hers/herself,

It/its/it/-/itself, we/our/us/ours/ourselves, you/your/you/yours/yourselves, they/their/them/theirs/themselves]

(Reflexiveness) They enjoyed themselves./We love ourselves./Students will introduce themselves. . . . .

(Emphasis) They fixed it themselves./You can do it yourselves./David and Paul made this cake themselves. . . . .

We don't think about ourselves much./Some people don't love themselves./You and I made ourselves look pretty. . . . .

(Reflexive pronouns for idiomatic expression) [enjoy oneself/make oneself at home/ help oneself/help oneself to/kill oneself/seat oneself/say to oneself/by oneself/for oneself/beside oneself/between ourselves/of itself/ in itself]

He came to the party by (him/himself)./We are enjoying (myself/ourselves) at the concert. . . . .

A: Did you send this package to me? B: No, Jessica herself sent it to you./A: Look at him! B: He likes eating help himself. . . . .

(Make sentences with reflexive pronouns) Did you enjoy yourself at the party?/I want to live for myself/The man is eating lunch by himself. . . . .

(Make sentences with reflexive pronouns) He looked at himself in the mirror./They take care of themselves./I hurt myself in the park. . . . .

Unit 3 Various expressions of impersonal subject ‘it’ (weather, months, seasons, light and shade, and distance)

(Vocabulary related with weather) [weather/stormy/chilly/cloudless/scorching/freezing/frosty/warm/fine/fair/good/beautiful/calm/Mild/genial/clear/sunny/ serene/bad/foul/wretched/terrible/nasty/gloomy/dismal/humid/sultry/rainy/heavy rain/light rain/downpour/drizzle/thundershower/flood/thunder/lightning/storm/snowy/heavy snow/snowfall/powdery snow/large flakes of snow/snow slide/snowflake/ hail/frost/avalanche/blizzard/snowstorm/windy/freeze/windstorm/typhoon/foggy/misty/cloudy/overcast]

(Weather expressions) It is sunny.=It's sunny./It is rainy.=It's rainy./It is snowy.=It's snowy. . . . .

(This/It) will rain tomorrow./(They/It) snowed a lot last winter./(They/It) is raining outside. . . . .

(Season expressions) It is spring.=It's spring./It is summer.=It's summer./It is fall.=It's fall. . . . .

(Month expressions) It is January.=It's January./It is February.=It's February./It is March.=It's March. . . . .

(Distance expressions) It is 15 kilometers.=It's 15 kilometers./It is very close.=It's very close. . . . .

(Select correct answers) How's the weather? It's raining./How far is it? It is about 3 miles./What season is it? It's spring./What was the weather like yesterday? It was very hot./How's your room? It is very dark in my room./What month is it? It's January. . . . .

(Make sentences with impersonal subject ‘it’) It's raining./It's very cold outside./It's summer./It will cloud a lot tomorrow./It's about 5 kilometers to school. . . . .

Unit 4 Various expressions of impersonal subject ‘it’ (time, date, day, and calendar)

(Time expressions) It is one o'clock.=It's one o'clock./It is three o'clock.=It's three o' clock. . . . .

(Time expressions) [1:30] It's one thirty.=It's half past one.=It's half after one. . . . .

(Time expressions) [3:15] It's three fifteen.=It's a quarter past three.=It's quarter after three. . . . .

(Time expressions) [5:45] It's five forty-five.=It's a quarter to six. . . . .

(Time expressions) [3:07] It's three seven.=It's seven past three.=It's seven after three. . . . .

(Day expressions) It is Sunday.=It's Sunday./It is Wednesday.=It's Wednesday. . . . .

(Calendar expressions) It is March first.=It's March first./It is July fourth.=It's July fourth. . . . .

(Select correct answers) What time is it? It's nine forty five./What day is it? It's Wednesday./What date is it? It's May fifth. . . . .

(Make questions with correct expressions) What time is it?/What day is it?/What date is it?. . . .

The 14^{th} layer is a stage to learn about indefinite pronouns and uncountable nouns, and is configured to provide 1,600 iterative learnings of various expressions of indefinite pronouns and uncountable nouns based on the sentence building structure of various tenses (present simple, past simple, present continuous, past continuous, and future) in questions, declarative, negative, exclamatory, suggesting, and imperative sentences learned in the first to 13^{th} layers, so that the learner can learn about indefinite pronouns and uncountable nouns, which are foundational to learning of contents from the 15^{th} layer to the 33^{rd} layer that the learner will learn later. Examples of the contents of the 14^{th} layer to be learned are as follows.

Unit 1 some/any (indefinite pronouns)

(‘some’ is used in positive sentences) I have some problems./He wants some coffee./They needed some coins. . . . .

(‘any’ is used in negative sentences) There aren't any potatoes./I don't have any money./We don't have any coins. . . . .

(Discrimination between some and any) I will need some ice cream./They didn't spend any time together. . . . .

(Change a positive sentence into a negative sentence) I have some money. (Negative) I don't have any money. . . . .

(Change a negative sentence into a positive sentence) We didn't buy any flowers. (Positive) We bought some flowers. . . . .

(‘some’ is used in questions for request or suggestion) Can I have some sugar, please?/ Would you like some bread and butter?. . . .

(‘any’ is used in questions) Do you have any problems?/Are there any hospitals in this area?. . . .

(Discrimination between some and any) Shall I give you some juice?/Do you have any brothers and sisters?. . . .

(Change a declarative sentence into a question) You have some good friends. (Question) Do you have any good friends?. . . .

Unit 2 the other/another, the others/others, one/ones (indefinite pronouns)

(One/the other when two things or people are provided) We have two English teachers. One is a woman and the other is a man. . . . .

(One/another/the other when three things or people are provided) I have three boys. One is a writer, another is a judge, and the other is a police officer. . . . .

(Discrimination of indefinite pronouns) I have two friends. One lives in Sydney and the other lives in London./

She has three skirts. One is black, another is brown, and the other is green. . . . .

(One/the others meaning the rest which are designated) There are six students in the classroom. One is a girl and the others are boys. . . . .

(some/others meaning the rest which are indefinite) Some people like soccer and others like baseball. . . . .

(Discrimination of indefinite pronouns) One drank milk and the others drank water./ Some people are studying and others are dancing. . . . .

(one/ones) I needed a watch, so I bought one./I don't have pencils, so I need ones. . . . .

Unit 3 both/either/neither (indefinite pronouns)

(both) Cathy is married. Sarah is married. Both of them are married. . . . .

(either) Sophia is from France. Chris is from Italy. Either of them is from France. . . . .

(neither) Jim was at home last night. Kevin was at my party last night. Neither of them was in the park last night. . . . .

(Discrimination of indefinite pronouns) Either of them is a student./Both of them are married./Neither of them can swim. . . . .

(both) He got married. She got married. Both of them got married. . . . .

(either) Joe will buy a new computer. Tim will buy a new car. Either of them will buy a new computer. . . . .

(neither) Jane loves western movies. Kevin loves Korean movies. Neither of them hates movies. . . . .

(Indefinite pronouns & verbs) Both of them are engineers./Either of my two sons is married./Neither of her parents works for the company. . . . .

Unit 4 Expressions of uncountable nouns

(Uncountable nouns used with quantifiers to be countable) Singular [a cup of coffee, tea/a carton of milk, juice/a glass of soda, water, milk, juice/

a bottle of water, juice/a bowl of rice, soup, cereal/a tube of toothpaste/a spoonful of sugar, salt/ajar of Jam, honey/

a scoop of ice cream/a bag of flour/a can of soda]

(Uncountable nouns used with quantifiers to be countable) Plural [ two cups of coffee, tea/two cartons of milk, juice/two glass of soda, water, milk, juice . . . . ]

(Uncountable nouns used with terms of shapes to be countable) Singular [a bar of soap/ an ear of corn/a head of lettuce, cabbage, garlic/a loaf of bread/a piece of pizza, cake, chalk, paper, meat/a sheet of paper/a slice of cheese, bread/a stick of butter/a roll of film/a pound of meat]

(Uncountable nouns used with terms of shapes to be countable) Plural [two bars of soap/two ears of corn/two heads of lettuce, cabbage, garlic . . . .]

(Uncountable nouns counted in pair) Singular [a pair of pants, socks, shoes, glasses, gloves, tights, pajamas, scissors, shorts]

(Uncountable nouns counted in pair) Plural [two pairs of pants, socks, shoes, glasses, gloves, tights, pajamas, scissors, shorts]

(Discrimination of units in sentences) He needs a (bag/bar) of flour./I drink a (bowl/cup) of coffee every morning./I lost two (pairs/pair) of scissors. . . . .

(Make sentences with indefinite nouns) She ate a piece of pizza./I opened ajar of jam./We need ten sheets of paper./I bought two pairs of pants. . . . .

The 15^{th} layer is a stage to learn about questions words ‘Wh-’, and is configured to provide 1,600 iterative learnings of various expressions of question words ‘Wh-’ based on the sentence building structure of various tenses (present simple, past simple, present continuous, past continuous, and future) in questions, declarative, negative, exclamatory, suggesting, and imperative sentences learned in the first to 14^{th} layers, so that the learner can learn about question words ‘Wh-’, which are foundational to learning of contents from the 16^{th} layer to the 33^{rd} layer that the learner will learn later. Examples of the contents of the 15^{th} layer to be learned are as follows.

Unit 1 Question words (who, what, which, when, where, why+be verb)

(Interrogative pronouns) What do you like?/Who is cooking dinner?/Which is the best?. . . .

(Interrogative adverbs) When did you brush your teeth?/Where are you going?/Why did John cry?/How was yesterday?. . . .

(Discrimination of question words) (Who/What) do you play tennis with? I play tennis with my sister./(When/What) did you buy yesterday? I bought some food. . . . .

(When question words are used with verb ‘be’: Question word+be verb+subject+complement+adverb phrase?) Where are you?/Why were you happy last night?. . . .

(When question words are used with verb ‘be’) Why were you late?/What is his name? /When are you free?/Where are you going?. . . .

(In case of continuous tense) What are you doing?/Why are you playing soccer?/ Where were you playing tennis last weekend?. . . .

(Future tense with ‘be going to’) When are you going to finish it?/What are you going to eat for lunch?. . . .

Unit 2 Question words (who, what, which, when, where, why+verb)

(Interrogative pronouns) Who is writing the story?/What are you worried about?/Which is better, this one or that one?. . . .

(Interrogative adverbs) When is the next meeting going to begin?/Where are they going to meet?/Why is she sad?. . . .

(When the verb is in the present tense) What do you see?/When do you study English? /Why does he study English every day?. . . .

(When the verb is in the past tense) What did you see?/Where did you meet him?/Why did you study English last night?. . . .

(Interrogative sentences with question words) Why do you want this?/Who did you meet at the station?/Where does the club meet?. . . .

(Interrogative sentences with question words) Who did you invite to your birthday party?/When does the class start?/Where did he buy a gift?. . . .

(Make interrogative sentences with question words) What do you like?/Why do you drink coffee?/When did the book become a best seller?. . . .

Unit 3 few/a few, little/a little, a lot of/lots of, why meaning reason

(few=not many/a few=a small number) There are a few seats on the bus./There are few seats on the bus. . . . .

(little=not much/a little=a small amount) I gave Jenny a little help./I gave Jenny little help. . . . .

A few people were hurt at the accident./Few people were hurt at the accident. . . . .

Mike can speak a little Chinese./Mike can speak little Chinese. . . . .

(Make sentences with quantitative adjectives) There are a few students on the bus./I need a little sugar./He reads few books. . . . .

(a lot of/lots of) He eats a lot of cookies every day.=He eats lots of cookies every day.=He eats many cookies every day. . . . .

(a lot of/lots of) Did you make a lot of money last year?=Did you make lots of money last year?=Did you make much money last year?. . . .

(why=reason) Why don't you ask him?=How about asking him?=What about asking him?. . . .

(why=reason) Why don't we have lunch together?=Shall we have lunch together?=Let's have lunch together. . . . .

Unit 4 which, whose, what, what kind of+noun

(Interrogative adjectives) Whose car is this?/What language do you speak?/Which movie do you usually watch?. . . .

(Interrogative adjectives) Whose pencil are you using?/What topic are they discussing?/Which item are you looking for?. . . .

(what kind of+noun) What kind of food do you want to eat?/What kind of sport do you enjoy?. . . .

(what kind of+noun) What kind of thing do you want?/What kind of activity do you like?. . . .

(what kind of+noun) What kind of training is this?/What kind of advice did he give you?. . . .

(what kind of+noun) What kind of hobby do you have?/What kind of class are you taking?. . . .

(Make sentences with what kind of+noun) What kind of music do you like?/What kind of book are you reading?. . . .

The 16^{th} layer is a stage to learn about the question word ‘How’, and is configured to provide 1,600 iterative learnings of various expressions of the question word ‘How’ based on the sentence building structure of various tenses (present simple, past simple, present continuous, past continuous, and future) in questions, declarative, negative, exclamatory, suggesting, and imperative sentences learned in the first to 15^{th} layers, so that the learner can learn about question word ‘How’, which are foundational to learning of contents from the 17^{th} layer to the 33^{rd} layer that the learner will learn later. Examples of the contents of the 16^{th} layer to be learned are as follows.

Unit 1 how often, how far, how many, how much

(Interrogative pronouns: who, what, which/Interrogative adverbs: when, where, why, how) How did you meet her?. . . .

(Method) How do you go to school?. . . . (Status) How are you feeling today?. . . . (Degree: how+adjective, adverb) How tall are you?/How often do you go there?. . . . (Number) How many students are there in the classroom?. . . . (Quantity) How much coffee do you drink every day?. . . .

(Number, Quantity) How (many/much) books do you have?/How (many/much) money do you earn?. . . .

(Number, Quantity) How many (class/classes) do you have?/How much (cream/cookies) do you want?. . . .

(Degree: how+adjective, adverb) How old are you?/How often do you go there?/How far is Seoul from Paris?. . . .

Unit 2 how old, how tall, how far, how often, how many, how much

(Degree: how+adjective, adverb) How interesting was the movie?/How long is the concert?/How clean is you room?/How fat is she?. . . .

(Degree: how+adjective, adverb) How hard did you work?/How dark was it outside? /How busy are they?. . . .

(Number, Quantity) How (many/much) butter do you need?/How (many/much) skirts did they buy?. . . .

(Expressions with ‘how’) How do you operate the machine?/How was the concert?/ How many countries did you visit?. . . .

(Expressions with ‘how’) How did they build the house?/How bad was the rumor?/ How far do you have to drive?. . . .

(Expressions with ‘how’) How heavy is your bag?/How did you find my book?/How strong is your coffee?. . . .

(Make sentences with ‘how’) How tall is he?/How busy are they?/How hungry are you?. . . .

Unit 3 Useful expressions of ‘how’

(Make sentences with ‘how’ of degree) How smart is he?/How comfortable is your car?/How different are your brothers?. . . .

(Make sentences with ‘how’ of degree) How early did you get up?/How perfect did you finish your homework?/How fast can she run?. . . .

(Make sentences with ‘how’ of number or quantity) How many books did you choose?/How much milk did he drink?. . . .

(Make sentences with ‘how’ of number or quantity) How much gold do you want?/How much seafood did you eat?. . . .

(Make sentences with ‘how’ of number or quantity) How much money did you spend on toys?/How many cookies did you bring?. . . .

(Make sentences with ‘how’) How simple is her story?/How useful is this service?. . . .

(Expressions with ‘how’) How young does she look?/How late were you yesterday?. . . .

(Expressions with ‘how’) How many apples are there in the refrigerator?/How much milk do you drink every morning?. . . .

Unit 4 Useful expressions of ‘how’

(Method) How do you study English?/How can I buy a ticket?/How did you find him?. . . .

(Status) How is the weather Seoul?/How was the concert?/How was the movie?. . . .

(Make sentences with ‘how’ of method) How did he draw the picture?/How did you clean your room?. . . .

(Make sentences with ‘how’ of status) How was the novel?/How was the food?. . . .

(Make sentences with ‘how’ of number) How many tickets do you need?/How many cooks are there in the kitchen?. . . .

(Make sentences with ‘how’ of quantity) How much chocolate did you buy?/How much food are you preparing?. . . .

(Make sentences with ‘how’ of degree) How fun was the show?/How expensive was the ticket?. . . .

(Make sentences with ‘how’) How many plans do we have?/How difficult was the test?. . . .

The 17^{th} layer is a stage to learn about modal verbs, and is configured to provide 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 16^{th} layers, so that the learner can learn about modal verbs, which are foundational to learning of contents from the 18^{th} layer to the 33^{rd} layer that the learner will learn later. Examples of the contents of the 17^{th} layer to be learned are as follows.

Unit 1 Modal verbs: must (necessity), must not (prohibition)

(Allowance) Can I use your phone? (Ability) I can swim. (Possibility) John may come to the meeting. (Future) I will play soccer tomorrow.

(Suggestion, request) Will you feed the goldfish? (necessity) You must study. (Good thing or right thing to do) You should take a rest. . . . .

(Prohibition) You must not run in the classroom. (Necessity) You have to help your father. (Suggestion, request) Could you water the plant?. . . .

(Prohibition) You must not be late for the class./You must not tell a lie. . . . .

(Necessity) It's too cold. You must put on your coat./We must come home on time. . . . .

(Necessity) She comes early. She must come early./He goes to bed early. He must go bed early. . . . .

(Discrimination between necessity and prohibition) You (must/must not) have a driver's license to drive./You (must/must not) be late for the meeting. . . . .

(Make sentences for necessity and prohibition) Judy must practice hard./You must not enter the building./We must not leave the food. . . . .

Unit 2 Modal verbs: must (necessity)=have to=need to/don't have to (unnecessity)

(Modal verbs) Allowance: can, could, may/Ability: can, could/Possibility: may, might/Future: will/Suggestion, request: will, would, could/Necessity: must, have to/

Strong advice: should/Good thing or right thing to do: should/Assurance: must/ Prohibition: must not, should not

(Allowance) Can I bring this dictionary? (Possibility) Tom might come to the meeting. (Ability) I can drive a car.

(Suggestion, request) Could you wait a minute? (Necessity) You must eat more fresh vegetables. (Good thing or right thing to do) You should keep your promise.

(Prohibition) You should not lose this chance. (Future) I will not make a mistake again.

(Necessity) I must help my parents.=I have to help my parents. . . . .

(Unnecessity) You don't have to read a book in the bed./He doesn't have to sell his house. . . . .

(Necessity) You have to help old people.=You must help old people.=You need to help old people.

(Necessity) He must go to school early.=He has to go to school early.=He needs to go to school early.

(Negative) He doesn't have to go to school early. . . . .

Unit 3 Modal verbs: Can I, May I, Could I (allowance)/Will you, Can you, Would you, Could you (suggestion, request)/will (future)

(Modal verbs) Allowance: can, could, may/Ability: can, could/Possibility: may, might/Future: will/Suggestion, request: will, would, could/Necessity: must, have to/

Strong advice: should/Good thing or right thing to do: should/Assurance: must/ Prohibition: must not, should not

(Allowance) Can I stay here until Sunday?/Could I use your computer?. . . .

(Possibility) She may come home earlier than yesterday./It might rain tonight. . . . .

(Ability) I could play the guitar./I can speak English fluently. . . . .

(Suggestion, request) Will you join us?/Would you have some more coffee?/Could you pass me the salt?. . . .

(Necessity) You have to wear a coat./I must wake up early tomorrow. . . . . (Assurance) Tom must be popular among the girls. . . . .

(Good thing or right thing to do) We should obey traffic rules. . . . . (Strong advice) You should exercise regularly. . . . .

(Negative sentence with modal verb ‘can’) I can't run fast. . . . . (Question with modal verb ‘can’) Can she sing beautifully?. . . .

(Suggestion, request) Will you help me?=Can you help me? (More politely) Could you help me?=Would you help me?. . . .

(Future) She comes to the party. She will come to the party. . . . .

Unit 4 Modal verb ‘Can’ (Allowance, ability, and possibility)

(Modal verbs) Allowance: can, could, may/ability: can, could/Possibility: may, might/Future: will/Suggestion, request: will, would, could/Necessity: must, have to/

Strong advice: should/Good thing or right thing to do: should/Assurance: must/Prohibition: must not, should not

(Expressions of modal verbs) Could I ride this bike?/Jennifer can solve the problem./It may snow tomorrow./Tim might come to the meeting. . . . .

(Expressions of modal verbs) The rumor must be false./You must not wake up late tomorrow./We should respect the old. . . . .

(Allowance) Can I go outside?=May I go outside?=Could I go outside?. . . .

(Answer for allowance) May I borrow your dictionary? Yes, you may. No, you may not. . . . .

Can I borrow your dictionary? Yes, you can. No, you can't. . . . .

(Discrimination of modal verbs) You (may/must) wear a seat belt./(May/Have) I use your rest room?/You (are/must) brush your teeth. . . . .

(Discrimination of modal verbs) My son (could/should) read when he was four years old./My daughter (has to/have to) study hard for the test. . . . .

The 18^{th} layer is a stage to learn about modal verbs, and is configured to provide 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 17^{th} layers, so that the learner can learn about modal verbs, which are foundational to learning of contents from the 19^{th} layer to the 33^{rd} layer that the learner will learn later. Examples of the contents of the 18^{th} layer to be learned are as follows.

Unit 1 Modal verbs: may (Allowance, possibility), can=be able to, can=will be able to

(Modal verbs) Allowance: can, could, may/Ability: can, could/Possibility: may, might/Future: will/Suggestion, request: will, would, could/Necessity: must, have to/

Strong advice: should/Good thing or right thing to do: should/Assurance: must/Prohibition: must not, should not

(Expressions of modal verbs) Can I turn off the TV?/Could I call you tonight./She may be sick today./He might want some money. . . . .

(Possibility) He might need some money./They may like ice cream./It may rain tonight. . . . .

(Ability) Jack can drive a car.=Jack is able to drive a car. . . . . [can=be able to]

(Ability) She can't run fast.=She isn't able to run fast. . . . . [can't=be not able to]

(Ability) Past [could=was/were able to], Negative past tense [couldn't=wasn't/weren't able to]. . . .

(Ability) We can skate fast. (Future) We will be able to skate fast. . . . .

Unit 2 Modal verb should (Strong advice, Good thing or right thing to do, and prohibition)

(Modal verbs) Allowance: can, could, may/Ability: can, could/Possibility: may, might/Future: will/Suggestion, request: will, would, could/Necessity: must, have to/

Strong advice: should/Good thing or right thing to do: should/Assurance: must/ Prohibition: must not, should not

(Expressions of modal verbs) Can I join the club?/Could I ask you something?/I might leave my bag here./You may call me late tonight. . . . .

(Expressions of modal verbs) Would you show me the way to the park?/It must be new./You should not bother him. . . . .

(Good thing or right thing to do) You should follow the rules. . . . . (Strong advice) You should exercise regularly. . . . .

(Prohibition) You shouldn't play with a knife./You shouldn't eat much sweet food. . . . .

Unit 3 Modal verb rules, negative sentences and questions with modal verbs

(Verbs used together with modal verbs are in the base form) Could I use your computer?/She may come home earlier than yesterday. . . . .

(Discrimination of verb base forms) Tom may (come/comes) to the meeting./She must (save/saves) money to buy a car. . . . .

(Negative sentences with modal verbs: modal verb+not+verb base) I can't catch the first train./She may not be sick today. . . . .

(Negative form of ‘must’=don't have to) Judy must break the bottle. (Negative) Judy don't have to break the bottle. . . . .

(In the question with a modal verb, the subject follows the modal verb) I must go. Must I go?/I should lose some weight. Should I lose some weight?. . . .

(Modal verb ‘can’ in question)—Chris can play the flute. (Question) Can Chris play the flute?. . . .

(Modal verb ‘have to’ in question)—He has to pay the phone bill. (Question) Does he have to pay the phone bill . . . .

Unit 4 Modal verb rules and tenses

(The past form of ‘can’ is ‘could’, and then, the verb base is used regardless of tenses) I can play soccer yesterday. (Past) I could play soccer yesterday. . . . .

(could=was/were able to) She could swim fast.=She was able to swim fast. . . . .

(couldn't=wasn't/weren't able to) You couldn't speak Spanish.=You weren't able to speak Spanish. . . . .

(Present) I know the problem. I think I can fix it. (Negative present tense) I can't sleep in my room now because of too much noise.

(Past) He could finish his homework last night. (Negative past tense) She couldn't carry a heavy box because her back hurts. . . . .

(Questions and answers with modal verbs) [can/will/may/must/do/should] Can you get to the airport in time? Yes, I can. No, I can't. . . . .

(Expressions of modal verbs) You should wash your hands before you eat something./ Amy may be studying in her classroom./

Should I memorize all these English sentences at once?/May I use your phone?. . . .

(Discrimination of modal verbs) Do you (must/have to) go to the bank to borrow some money?/Daniel (has to/have to) go to see a doctor./

We (must not/have not to) disturb others./They (musted not/didn't have to) get up early. . . . .

(Discrimination of modal verbs) It (may/can) be cloudy in the afternoon./How (may/ can) I get to the station?/

What (would/should) you like to drink?/I don't like yellow. (Can/Must) I see different colors?. . . .

The 19^{th} layer is a stage to learn about the comparatives and the superlatives, and is configured to provide 1,600 iterative learnings of various expressions of the comparatives and the superlatives based on the sentence building structure of various tenses (present simple, past simple, present continuous, past continuous, and future) in questions, declarative, negative, exclamatory, suggesting, and imperative sentences learned in the first to 18^{th} layers, so that the learner can learn about the comparatives and the superlatives, which are foundational to learning of contents from the 20^{th} layer to the 33^{rd} layer that the learner will learn later. Examples of the contents of the 19^{th} layer to be learned are as follows.

Unit 1 How to express the comparatives, Regular forms and irregular forms of adjectives in comparative

(To form the comparative, we normally add er than') [longer/cheaper/taller/slower/ lower/weaker/colder/harder/cooler/faster/older . . . .]

(When an adjective ends in ‘e’, we just add ‘r than’) [larger/nicer/cuter/safer/closer/wider/wiser . . ..]

(When an adjective ends in ‘consonant+vowel+consonant’ (C+V+C), we normally double the last letter and add ‘er than’) [bigger/hotter/thinner/fatter/slimmer/sadder/ wetter . . . .]

(When an adjective ends in ‘consonant+y’, we remove the −y and add ‘ier than’) [easier/happier/angrier/busier/lazier/dirtier/luckier/earlier/lonelier/heavier . . . .]

(Irregular forms) [good, well batter/bad, ill worse/many, much more/little less . . . .]

(For adverbs ending in ‘ly’ or adjectives with three or more syllables, we use ‘more’ before the adverb or the adjective and ‘than’ after the adverb or the adjective) [more difficult/more expensive/more interesting/more dangerous/more slowly . . . .]

(Comparative) Mike is (taller/more tall) than his older brother./Math is (difficulter /more difficult) than English to me./

My car is (more good/better) than yours./Yesterday was (hoter/hotter) than today. . . . .

(Make sentences with the comparative) China is bigger than Japan./A motorcycle is more dangerous than a car./She is more careful than her husband. . . . .

Unit 2 How to express the superlatives, Regular forms and irregular forms of adjectives in superlative

(the+adjective+est) [longest/cheapest/tallest/slowest/weakest/coldest/hardest/coolest/fastest/oldest . . . .]

(the+adjective ending in e′+st) [largest/nicest/cutest/safest/closest/widest/ wisest . . . .]

(the+when an adjective ends in C+V+C, we double the last letter+est) [biggest/hottest/thinnest/fattest/slimmest/saddest . . . .]

(the+when an adjective ends in ‘consonant+y’, we remove the ‘y’+iest) [easiest/happiest/angriest/busiest/laziest/dirtiest/luckiest/earliest . . . .]

(the+most+adverb ending in ‘ly’ or adjective with three or more syllables) [most difficult/most expensive/most interesting/most dangerous/most slowly . . . .]

(Irregular forms) [good, well best/bad, ill worst/many, much most/little least . . . .]

(Superlative) She is the (taller/tallest) of all./It was the (worse/worst) movie in the year./

The watch is the (most expensive/expensivest) in this store./Bob is the (busyest/busiest) of all. . . . .

(Make sentences with the Superlative) Winter is the coldest season./The shark is the most dangerous animal./Mike's backpack is the heaviest. . . . .

Unit 3 Various expressions of the comparative and the superlative

(Positive, Comparative, Superlative degrees) [short-shorter-shortest/big-bigger-biggest/difficult-more difficult-most difficult/good-better-best . . . .]

(Comparative of equality: as+positive degree+as) Math is as (difficult/more difficult) as English./My car is as (good/better) as yours. . . . .

(Comparative of equality) This show is as (funny/funnier) as that show./John draws as (better/well) as Kevin. . . . .

(Comparative of equality in negative sentences: not+as+positive degree+as) Tim is not as tall as Simon./He does not study as hard as his brother. . . . .

(Comparative of equality in negative sentences) The blue bike is not as expensive as the yellow bike./Simon does not run as fast as Chris. . . . .

(Comparative of equality: as+much+uncountable noun+as, as+many+plural noun+as) My school has as many students as his school./Nick ate as much pizza as his brother yesterday. . . . .

(Superlative: one of the+superlative+plural noun) Seoul is one of the biggest cities in the world./She is one of the most beautiful girls in her school. . . . .

(Expressions of the higher degree: the+ordinal number+superlative+singular noun) Tom is the third tallest boy in the class./Busan is the second biggest city in Korea. . . . .

Unit 4 Various expression of comparatives and superlatives/Superlatives of adverbs

(Positive, Comparative, Superlative degrees) [short-shorter-shortest/big-bigger-biggest/difficult-more difficult-most difficult/good-better-best . . . .]

(Discrimination of positive degree and comparative degree) I am as (smart/smarter/smartest) as my sister./I am (heavy/heavier/heaviest) than my mother./The cheetah is the (fast/faster/fastest) animal in the world./The eagle is (as/more/the most) dangerous bird.

(Discrimination of positive degree and comparative degree) She talks (as/more/the most) loudly as her sister./He is one of the (good/better/best) students in his class. . . . .

(‘the’ may be omitted in front of the superlative of adverb) I like blue the best./He runs the fastest in my class./Bill swims the fastest of all. . . . .

(Comparative degree meaning the superlative degree 1: adjective+er+than any other+singular noun) That is taller than any other building in this area.=That is the tallest Building in this area. . . . .

(Comparative degree meaning the superlative degree 2: adjective+er+than all the other+plural noun) My cousin is prettier than all the other girls in her class.=My cousin is the prettiest girl in her class. . . . .

The 20^{th} layer is a stage to learn about number expressions and adverbs of frequency, and is configured to provide 1,600 iterative learnings of various expressions of number expressions and adverbs of frequency based on the sentence building structure of various tenses (present simple, past simple, present continuous, past continuous, and future) in questions, declarative, negative, exclamatory, suggesting, and imperative sentences learned in the first to 19^{th} layers, so that the learner can learn about number expressions and adverbs of frequency, which are foundational to learning of contents from the 21^{th} layer to the 33^{rd} layer that the learner will learn later. Examples of the contents of the 20^{th} layer to be learned are as follows.

Unitl a lot of/lots of, a few/few, a little/little, many, much (quantitative adjective)

(a lot of/lots of+plural noun) I ate a lot of apples.=I ate lots of apples./We will need a lot of desks.=We will need lots of desks. . . . .

(a lot of/lots of+uncountable noun) We drink lots of water.=We drink a lot of water./I want a lot of sugar.=I want lots of sugar. . . . .

(a few+plural noun) [a small number] There are (a few/few) apples in the basket./I bought (few/a few) pencils. . .

(few+plural noun) [not many] There are (few/a few) eggs in the refrigerator./I ate (few/a few) tomatoes. . . . .

(a little+uncountable noun) [a small amount] There is (little/a little) juice in the bottle./I need (little/a little) butter. . . . .

(little+uncountable noun) [not much] Judy ate (little/a little) ice cream./Tim drank (little/a little) coffee. . . . .

(many+plural noun) [a large number of] Jack has (many/much) friends./Did you eat (many/much) cookies last night?. . . .

(much+uncountable noun) [a large amount of] She doesn't have (many/much) free time./We didn't eat (many/much) bread. . . . .

(many, a few, few)+plural noun/(much, a little, little)+uncountable noun/(a lot of, lots of)+plural noun, uncountable noun

Unit 2 Numbers (cardinal number, ordinal number), expressions of address, and expressions of phone talk

(Cardinal/ordinal) [one first, two second, three third , four fourth, five fifth . . . . nineteen nineteenth, twenty twentieth. . . .]

(Cardinal numbers) [21 twenty one, 60 sixty, 100 one hundred, 1,000 one thousand, 10,000 ten thousand, 100,000 one hundred thousand, 1,000,000 one million, 1,000,000,000 one billion . . . .]

(Phone number) 573-3100 five seven three three one o(zero) o(zero)/02-123-4567 o two one two three four five six seven . . . .

(Expressions of phone talk) This is Mary speaking./I′d like to speak to Jennifer, please./Is Jennifer in?/Could I talk to Jennifer?/

Would you like to leave a massage?/She is not here now./The line is busy./Stay on the line. . . . .

Unit 3 Decimals, fraction, money, years, mathematical symbols, and formula expressions

(Decimals) 25.47 twenty-five point four seven/0.3974 zero point three nine seven four . . . .

(Fractions) When a numerator is 1: 1/5 one fifth/When a numerator is 2 or more: 3/5 three fifths . . . .

(Fractions) When a denominator and a numerator are 10 or more: 11/14 eleven over fourteen . . . .

(Fractions) When a fraction is a mixed number: 3 2/7 ^{th} ree and two sevenths/3 1/5 three and one fifth . . . .

(Expression of 1/2) one second/a second/one half/a half (Expression of 1/4) one fourth/a fourth/one quarter/a quarter

(Money) −$2.53 two dollars (and) fifty three cents . . . ./‘5C150 one hundred (and) fifty won . . . .

(Years) 1995 nineteen ninety-five/2002 two thousand two . . . .

World War II World War two, The second World War . . . . Elizabeth II Elizabeth the second . . . .

(Formulas) 23+17=40 Twenty-three plus (and) seventeen equals(is) forty . . . .

(Formulas) 8-1=7 Eight minus one is seven., One from eight leaves seven. . . . .

(Formulas) 4×7=28 Four multiplied by seven equals twenty-eight., Four times seven equals twenty-eight. . . . .

(Formulas) 30/5=6 Thirty divided by five equals six. . . . .

Unit 4 always, usually, often, sometimes, seldom, rarely, never (Adverbs of frequency)

(Find verbs and adverbs) We listen to our teacher carefully./The train stopped slowly.

(Find adjectives and adverbs) This soup is very delicious./My uncle is really nice. . . . .

(Find adverbs) We won the game very easily./She was walking so quickly. . . . .

(Adverbs of frequency) always usually often sometimes rarely (seldom) never 100% 0%

(Adverbs of frequency) I usually get up at 6 o'clock./Cindy often watches movies./My dad never drinks soda./I rarely play basketball./

My sister sometimes reads comic book./He always exercises at the gym./We seldom watch TV together. . . . .

(Position of adverbs of frequency) In front of a verb: She often reads books in the library. . . . .

(Position of adverbs of frequency) Next to verb ‘be’ or a modal verb: I am always nervous before the test./She will always remember you. . . . .

(Position of adverbs of frequency) In a negative sentence, next to a negator: I don't usually work on Saturdays./He is not always happy. . . . .

(Position of adverbs of frequency) In a question, next to a subject: Are you always happy?/Do you often go to Canada?/Will you always remember me?. . . .

The 21^{st} layer is a stage to learn about adjectives, adverbs, indefinite articles, and the definite article, and is configured to provide 1,600 iterative learnings of various expressions of adjectives, adverbs, the indefinite article, and the definite article based on the sentence building structure of various tenses (present simple, past simple, present continuous, past continuous, and future) in questions, declarative, negative, exclamatory, suggesting, and imperative sentences learned in the first to 20^{th} layers, so that the learner can learn about adjectives, adverbs, the indefinite article, and the definite article, which are foundational to learning of contents from the 22^{nd} layer to the 33^{rd} layer that the learner will learn later. Examples of the contents of the 21^{st} layer to be learned are as follows.

Unit 1 Roles of adjectives and adverbs, discrimination between adjectives and adverbs, and use rules of adverbs

(When adjectives have the same shape as adverbs) [fast/hard/early/late/long/high/right/daily/weekly]

(For adjectives that end in ‘y’, in order to make an adverb form, we remove the ‘y’ and add ‘ily’) [angry angrily/happy happily/easy easily/heavy heavily . . . .]

(In order to make an adverb form, adjective+ly) [careful carefully/quiet quietly/quick quickly/slow slowly/clear clearly . . . .]

(For adjectives that end in ‘ic’, adjective+ally) [dramatic dramatically/automatic automatically/economic economically . . . .]

(Roles of adverbs) Adverbs modify verbs: My father runs fast./Adverbs modify adjectives: It is very easy./

Adverbs modify other adverbs: I know him very well./Adverbs modify the whole sentence: Happily, I met my friends. . . . .

(Discrimination between roles of adjectives and those of adverbs) My father is (quiet/quietly)./He writes the story (simple/simply). . . . .

(Arrangement of adverbs) Place+method+time: I went there by bus last night. . . . . / Small place+large place: John moved to Seoul in Korea. . . . ./

Short time+long time: I arrived at 7 o'clock this morning. . . . .

(Not adverbs but adjectives that end in ‘ly’) [friendly/lovely/lonely/timely/lively/ ugly]

(Adverbs that have the same forms as adjectives but are different in meaning from adjectives) [late, lately/high, highly/deep, deeply. . . .]

Unit 2 Usage and various meanings of indefinite article ‘a’/‘an’

(Number of nouns) Singular countable nouns: a pen, an orange . . . . , Plural countable nouns: pens, oranges . . . . , Uncountable nouns: water, bread, coffee . . . .

(Singular countable noun starting with a consonant: a+noun) a shopping mall, a word, a bathroom, a lawyer . . . .

(Singular countable noun starting with a vowel: an+ [symbol] ) an insect, an airplane, a near, an octopus . . . .

(Irregular form: ‘an’ used when the next word starts with a vowel sound, and ‘a’ used when the next word starts with a consonant sound) a uniform, a university, an hour, an honest boy . . . .

(Meaning of indefinite article) One: I have a sister. . . ./Certain: A boy came to see me. . . . . /Per: I meet Tom once a week. . . . ./

Any: A lemon is sour. . . . ./The same: These are of a size. . . . ./Like: I want to be a Newton. . . . .

Unit 3 When the definite article ‘the’ is used

(To indicate a noun stated before is stated again) They have (a/an/the) son. (A/An/The) son is a doctor. . . . .

(To indicate a singular or plural noun when it is clear which person or thing we are talking about) Open the door./How was the movie?/She is in the living room. . . . .

(When a noun is determined by a modifier phrase or clause) The milk in the refrigerator is mine./Did you know the guy with the glasses?. . . .

(To indicate something that is unique or there is only one) The earth goes around the sun./The moon shines brightly. . . . .

(Directions, the east, the west, the south, the north, the right, and the left) The wind blows from the east./We turned to the right. . . . .

(In front of superlatives) This is the easiest problem in the test./She is the most beautiful girl in her class. . . . .

(In front of cardinal numbers) I am in the second grade in middle school./I couldn't take the first bus. . . . .

(In front of musical instruments) I like playing the violin./He played the guitar for two hours. . . . .

(In front of public offices and public places) The British Museum is very educational./ Please tell me the way to the city hall. . . . .

(In front of names of rivers, seas, oceans, mountain ranges and deserts) There are many kinks of fish in the Amazon./The Pacific Ocean is the largest ocean. . . . .

Unit 4 We use no indefinite article and definite article with:

(Vocative case—When you call someone) (A/An/The/−) Waiter, can I have some water?/What seems to be the problem, (a/an/the/−) doctor?. . . .

(When buildings or places are used for their original purposes) I go to school from Monday to Friday. (school to study) . . . .

(names of sports) We are playing tennis now./They played soccer on the playground.

(names of seasons, months, and days) Spring comes after winter./We are closed on Sunday./February has only 28 days. . . . .

(names of diseases) My aunt had lung cancer./Influenza can be dangerous. . . . . (however, the definite article is used in front of slight illness: a headache, a toothache . . . . )

(names of subjects) I am interested in studying science./She learns history at school. . . . .

(names of transportation means and communication means) I go to work by subway./ Please contact me by e-mail. . . . .

(names of meals, such as breakfast, lunch, and dinner) We are having lunch now./I have dinner at 7 in the evening. . . . .

The 22^{nd} layer is a stage to learn about prepositions and prepositional phrases, and is configured to provide 1,600 iterative learnings of various expressions of prepositions and prepositional phrases based on the sentence building structure of various tenses (present simple, past simple, present continuous, past continuous, and future) in questions, declarative, negative, exclamatory, suggesting, and imperative sentences learned in the first to 21^{st} layers, so that the learner can learn about prepositions and prepositional phrases, which are foundational to learning of contents from the 23^{rd} layer to the 33^{rd} layer that the learner will learn later. Examples of the contents of the 22^{nd} layer to be learned are as follows.

Unit 1 Meaning and usage of preposition (preposition of location)

(at: in front of a noun indicating a relatively small place, specific or exact point, event, or meeting/in; in front of a noun indicating a relatively wide place, building, or transportation, or inside of a container) A man is standing (at/in) the bus stop./I spent a few days (at/in) Italy. . . . .

(up: at or to a higher position/down: at or to a lower position) He climbed up the ladder./He jumped down the ladder. . . . .

(on: On refers to the things touching and are above something/under: Under denotes object being exactly below or vertically down and are not in contact) A box is on the chair./A box is under the chair. . . . .

(above: Above means to denote the sense of an object being vertically higher than other thing in which both are not in contact/over : Over denotes something covering higher) The birds are flying over the tree./The light is above my desk. . . . .

(below: Below denotes something lower than other things and are not in contact with each other/beneath: under a thing in contact with the thing) They live in the apartment below us./A worm is moving beneath my foot. . . . .

(next to/by/beside: at the side of) He is standing next to the tree./He is standing by the tree./He is standing beside the tree. . . . .

(between: a position which separates two things/among: the belonging of a thing or a person to a group) She is between Sam and Paul./He is standing among many children. . . . .

(in front of: In front of gives the sense of facing something/behind : Behind gives the sense of something at the back) Cars are in front of the store./There is a parking lot behind the building. . . . .

Unit 2 Meaning and usage of prepositions (preposition of direction)

(into: to the inside/out of: to the outside) She is coming into her room./She is going out of her room. . . . .

(from: the source of something) He came from Canada./She walked from the bed to the door. . . . .

(along: toward one end of a thing/through: Through refers in the sense of crossing) We are walking along the beach./Water flows through the pipe. . . .

(around: around refers in the sense of surrounding/across: across refers in the sense of going from one side of it to the other) They are sitting around the table./We went across the river by boat. . . . .

(toward: Toward refers to the direction of the place where somebody is going/across from: Across from refers to the opposite side of) The train is running toward the south./She lives across from the street. . . . .

(by: If you do something by a particular means, you do it using that thing/about: something relates to or concerns: I go to work by bus./Let's talk about the problem. . . . .

(for: For is used in the sense of start of a movement to the certain place or destination, or is used with the period of time/with: with is used in the sense of being together or using a tool, an object or a substance) I write books for children./Dry your hair with this towel. . . . .

Unit 3 Meaning and usage of prepositions (preposition of time)

(at: used to indicate fixed point of time/on: used to indicate date, day and special day) The plane leaves at 2:35 pm./I don't go to work on Sundays. . . . .

(in: used to indicate seasons, months, years, centuries, morning, afternoon, evening, and a period of time) He was born in 1992./I will go back to Australia in two years. . . . .

(by: used to denote the time before the given time or before the end of given time/ until: used to show a particular time) I will come home by six./I will wait here until six. . . . .

(from: from is used with the beginning of a period of time/from—to : used to indicate the beginning and the ending of a task/period of time) The store is open from 9 am to 7 pm./ He lived in Seoul from 2007. . . . .

(before: before is used with the time prior to the beginning or completion of the given time/after: after is used with the completion of any work or used to denote the later time) I watched TV after dinner./My father takes a shower before breakfast. . . . .

(for: for is used with the period of time indicated with numbers)/during: during is used with a specific period)

She always runs for an hour every morning./I visited Italy during the summer vacation.

Unit 4 Various expressions of prepositional phrases

(Expressions of prepositional phrases 1) [listen to/wait for/look at/look for/put on/ take off/pick up/put down/look like/because of/ask about]

(Expressions of prepositional phrases 2) [be afraid of/be different from/be full of/be good at/be interested in/be married to/be made from/be proud of/be angry with/be angry about/be angry at/be sorry for]

(Expressions of prepositional phrases) Bread is made from flour./She was very angry with me./I am interested in science./She is good at dancing. . . . .

(Review of prepositions) He came (by/for/in/from) Japan./She is (in/from/for/ at) her room./

I study English (to/for/in/on) three hours./Please listen (to/for/on/at) me./Try to put (from/of/on/at) shorts./

He is very angry (in/at/for/with) me./He goes fishing (from/of/on/at) Sundays./ Are you afraid (for/by/at/of) mice?/

I always play outside (in/at/for/with) my brother./She started (from/to/on/down) America last Friday./

She was running (across/down/off/on) the stairs./I saw her (on/in/at/until) the bus stop. . . . .

(Interpret prepositions) I am thinking about the game./The bridge is built over the river./Many students came out of the classroom./

I take a piano lesson after dinner./My sister loves eating at a nice restaurant./Cheese is made from milk./

The room is full of people./My teacher is really angry with me./He took off his hat./I am sorry for being late./

He is waiting for me./He is married to a nurse./What are you looking for?. . . .

The 23^{rd} layer is a stage to learn about conjunctions, and is configured to provide 1,600 iterative learnings of various expressions of conjunctions based on the sentence building structure of various tenses (present simple, past simple, present continuous, past continuous, and future) in questions, declarative, negative, exclamatory, suggesting, and imperative sentences learned in the first to 22^{nd} layers, so that the learner can learn about conjunctions, which are foundational to learning of contents from the 24^{th} layer to the 33^{rd} layer that the learner will learn later. Examples of the contents of the 23^{rd} layer to be learned are as follows.

Unit 1 and, but, or, so, imperative sentence+and, that as a noun clause (coordinating, correlative, and subordinating conjunctions)

(Coordinating conjunctions: to connect words, phrases, and clauses having the same grammatical roles or functions)

(and) I am good at soccer and baseball./She cleaned the room and washed the dishes. . . . .

(but) You can't swim, but I can./She has two sons, but I have two daughters. . . . .

(or) Which do you like better, tea or coffee?/Are you going to stay at home or go out?. . . .

(Subject+verb, so subject+verb: therefore, ˜) She is sick, so she can't go to school./It was very hot, so I opened the window. . . . .

(Imperative sentence, and) Hurry up, and you will catch the bus./Study hard, and your dream will come true. . . . .

(Imperative sentence, or) Hurry up, or you will miss the train./Study hard, or you will fail the test. . . . .

(that as a noun clause) That she is a teacher is certain./My wish is that you get better soon. . . . .

Unit 2 when, after, before, because, if, unless, though, although (subordinating conjunction of time, reason and condition)

(Conjunction of time: when, after, before) When she came home, I was watching TV./

We have to wash our hands before we eat food./She always watches TV after she finishes her homework. . . . .

(Conjunction of reason: because) Everybody likes her because she is kind./Because he told a lie, I couldn't believe him. . . . .

(Conjunction of condition: if, unless) You can pass the test if you study hard./You will receive a bad grade unless you study hard. . . . .

(Concessive conjunction: though, although) Though he is not rich, he is always happy.=Although he is not rich, he is always happy. . . . .

(Select conjunctions after reading the sentences) They were enjoying video games (when/after) I saw them./

She was very sad (because/unless) the test result was bad./(After/If) he cleaned his room, he went out to play./(Although/

(Although/Because) she was busy, she helped me with my homework. . . . .

Unit 3 both A and B, either A or B, neither A nor B, not only A but also B, as well as (correlative conjunction)

(Meaning of correlative conjunction) [both A and B: A [symbol] B [symbol] , either A or B: A [symbol] B, neither A nor B: A [symbol] B [symbol] not only A but also B: A [symbol] B [symbol] B as well as A: A [symbol] B

[symbol]

(Make sentences with correlative conjunction)—Both Tom and Jack are very tall./Either he or she is wrong./Jane is neither an actress nor a singer./

Not only he but also I will start for New York./Jessica can speak Japanese as well as English. . . . .

(Interpret correlative conjunctions) Neither he nor she is going to eat out./Either he or I should take care of the baby./

Fall is not only hot but also cold./Both Judy and Bob invited me yesterday./He is smart as well as handsome. . . . .

(Interpret correlative conjunctions) The test was neither easy nor simple./Both Ben and Sally are sitting on the bench./

Jack has to not only finish his homework but also clean his room./I will call either you or your brother./

The book was interesting as well as thrilling. . . . .

Unit 4 Correct use of conjunctions according to situations

(Coordinating conjunctions)—It was raining, so we went outside./He wants to buy a car, but he doesn't have money./Which

Which do you like better, blue or red?/I will visit my uncle in January and February. . . . .

(Imperative sentence, and/imperative sentence, or) Buy her some flowers, (and/or) she will forgive you./Drive slowly, (and/or) I will get off the car. . . . .

(Roles of ‘that’ as a noun clause)

Subject: That she will pass the exam is certain./Object: I thought that he was telling a lie./Complement: My problem is that I am not brave. . . . .

(Subordinating conjunctions) When I am alone, I read books./He will come here unless he is sick./If it rains, I will carry an umbrella./

I called him because I wanted to talk to him./Though she is rich, I don't like her./ Before he arrived, the meeting was over./

You can go home after you finish your work./Unless you hurry, you will miss the express. . . . .

(Meaning of correlative conjunction) [both A and B: A [symbol] B [symbol] , either A or B: A [symbol] B, neither A nor B: A [symbol] B [symbol] , not only A but also B: A [symbol] B [symbol] B as well as A: A [symbol] B

[symbol]

(Correlative conjunction) (Both/Either) Sam and Tom are writers./(Either/Neither) you or he has to drive./

(Both/Neither) you nor I am wrong./I like (both/neither) Korean food and Chinese food. . . . .

The 24^{th} layer is a stage to learn about possessive pronouns, selection of verbs, agreement on number, inversion, and emphasis, and is configured to provide 1,600 iterative learnings of various expressions of possessive pronouns, selection of verbs, agreement on number, inversion, and emphasis based on the sentence building structure of various tenses (present simple, past simple, present continuous, past continuous, and future) in questions, declarative, negative, exclamatory, suggesting, and imperative sentences learned in the first to 23^{rd} layers, so that the learner can learn about possessive pronouns, selection of verbs, agreement on number, inversion, and emphasis, which are foundational to learning of contents from the 25^{th} layer to the 33^{rd} layer that the learner will learn later. Examples of the contents of the 24^{th} layer to be learned are as follows.

Unit 1 Expressions of possessive pronouns

(How to express possession) [I my, you your, he his, she her, it its, we our, they their]

He has a car. This is his car./She has daughters. They are her daughters./I have a computer. This is my computer./We

We have customers. They are our customers./They have a garden. This is their garden. . . . .

('s: used to show that something belongs to someone or something) Whose house is this? This is Mr. Brown's house./Whose ticket do you have? I have my brother's ticket. . . . .

(Nouns of persons ending in ‘-s’: the noun+‘) This house is my parents’ house./This is James' instruction. . . . .

(Possessives with ‘of’+thing) Look at the house's window.=Look at the window of the house. . . . .

('s is used to talk about time, price, distance and weight) Where can I find today's newspaper./

Five dollars' worth of salt is enough./Two miles' walk every morning makes me healthy./I bought ten pounds' grapes. . . . .

Unit 2 Selection of verbs and agreement on number according to subjects

(Agreement between a subject and verb ‘be’) My sister and I (am/are/is) very close./I (am/are/is) rich./He (am/are/is) poor. . . . .

(Agreement between a subject and a verb) I (teach/teaches) English every day./The plane (leave/leaves) Seoul at 11:30. . . . .

(every, each+noun are treated as a singular form) Every teacher and student wants to play baseball./Each speaker makes a speech. . . . .

(time, distance, price, and weight are treated as a singular form) Five hours is enough for me to clean the house./Two miles is enough for him to run. . . . .

(Nouns ending in ‘ics’, country names, and names of disease are treated as a singular form) Physics is difficult for many girls./The United States has many cities. . . . .

(both A and B, and A and B are treated as a plural form) Both Tom and Jane are my classmates./A boy and a girl are in the first grade. . . . .

(A and B is treated as a singular form when they indicate one thing) Toast and jam is my favorite breakfast. . . . .

(nouns in pair are treated as a plural form) My gloves are very old. . . . .

(not only A but also B=B as well as A: verb is agreed with B) Not only she but also her students were happy./Her students as well as she were happy. . . . .

(either A or B, Neither A nor B: verb is agreed with B) Either you or your sister has a camera. . . . .

(modifiers between a subject and a verb do not have any influence on the verb) The rule of these games is very difficult. . . . .

(partial expression+of+noun: verb is agreed with the noun) All of the students are in the school. . . . .

(fraction+of+noun: verb is agreed with the noun)—Two thirds of the money is mine./Two thirds of the books are mine. . . . .

Unit 3 Understanding and various expressions of inversion

(Inversion: the subject comes after the verb) Here comes the school bus./There goes my uncle. . . . .

(If the subject is a pronoun, the subject comes first) There he goes./Here we are. . . . .

(Inversion of sentences with verb ‘be’) I am never rich. Never am I rich./She was hardly angry. Hardly was she angry. . . . .

(Inversion of sentences with modal verbs) I can never swim. Never can I swim./I will never see him. Never will I see him. . . . .

(Inversion of sentences with verbs in past tense) I never saw him. Never did I see him. . . . .

(Inversion of sentences with verbs in present tense) I hardly see him. Hardly do I see him. . . . .

(Inversion in positive sentences: So+verb+subject) My brother is a student. I am a student, too.=So am I./

I can speak English. He can speak English, too.=So can he./I play the piano well. He plays the piano well, too.=So does he. . . . .

(Inversion in negative sentences: Neither+verb+subject) My brother is not tall. I am not tall, either.=Neither am I./

He can't skate well. I can't skate well, either.=Neither can I./He doesn't have a cellphone. I don't have a cellphone, either.=Neither do I. . . . .

Unit 4 Understanding and various expressions of emphasis

(Emphasis: It is(was) ˜that ˜)

Tom plays the piano in his room on Sundays. (Tom [symbol] ) It is Tom that (who) plays the piano in his room on Sundays. . . . .

Tom plays the piano in his room on Sundays. (the piano is emphasized) It is the piano that (which) Tom plays in his room on Sundays. . . . .

Tom plays the piano in his room on Sundays. (in his room is emphasized) It is in his room that (where) Tom plays the piano on Sundays. . . . .

Tom plays the piano in his room on Sundays. (on Sundays is emphasized) It is on Sundays that (when) Tom plays the piano in his room. . . . .

(Emphasis of noun: the very+noun) It is the very book that I was looking for. . . . .

(Emphasis of verb: do, does, did+verb) She does look happy./I do know his name./We did win the game. . . . .

(Emphasis of question: questions word+on earth, in the world) How on earth did you solve this problem?/What in the world happened?. . . .

(Emphasis of negative sentence: at all, in the least, whatever) I don't eat breakfast at all./I don't have anything in the least. . . . .

The 25^{th} layer of the advanced building structure is a stage to learn about infinitives, and is configured to provide iterative learnings so that the learner can perfectly understand usages of to-infinitive through various expressions including various tenses based on the sentence building structure completed from the first to 24^{th} layers and can learn about infinitives, which are associated with various English expressions from the 26^{th} layer to the 33^{rd} layer that the learner will learn later. Examples of the contents of the 25^{th} layer to be learned are as follows.

Part 1 Infinitive as noun

(As a noun subject) To study English is important./To understand foreign culture is not easy. . . . .

(Placeholder ‘it’ and real subject in a sentence with infinitive as noun) It is important to study English./It is not easy to understand foreign culture. . . . .

(As a noun object) I want to study English in Canada./She likes to eat Italian food. . . . .

(As a noun object: verbs which need to-infinitive as an object) I [want] to study English every day. . . . .

[want/hope/decide/promise/expect/wish/choose/care/agree/plan/need/ refuse/fail]

(As a noun complement) My favorite hobby is to play tennis.=(My favorite hobby=to play tennis) . . . .

(As a noun: question word+to-infinitive=question word+subject+should+verb base)

(what) I don't know what to say.=I don't know what I should say. . . . .

(when) Please tell me when to start.=Please tell me when I should start. . . . .

(where) I have no Idea where to go for a vacation.=I have no idea where I should go for a vacation. . . . .

(how) I don't know how to use the copy machine.=I don't know how I should use the copy machine. . . . .

Part 2 To-infinitive as an adjective/To-infinitive as an adverb

(to modify a noun as an adjective) I need water to drink./There are many books to read in the library. . . . .

(To-infinitive+preposition as an adjective) I have a chair to sit on./I need some friends to play with. . . . .

(As an adverb—purpose) I got up early to catch the first train./I study hard to pass the exam. . . . .

(As an adverb—cause) I am glad to meet you./He was surprised to hear the news. . . . .

(As an adverb—result) She grew up to be a famous artist./We woke up to find the house on fire. . . . .

(As an adverb—ground of judgment) You are stupid to believe him./She must be diligent to work hard. . . . .

(As an adverb—condition) You will be astonished to taste this food./He will be shocked to hear the news. . . . .

(As an adverb—to modify an adjective) Sending an e-mail is easy to learn./This book is not easy to understand. . . . .

(As an adverb-independent infinitive) To tell the truth/To begin with/To make matters worse/Strange to say/so to speak/

not to mention/To make a long story short/To be sure/Needless to say

Part 3 Negative of to-infinitive/Sense subject of to-infinitive/idiomatic expressions of to-infinitive

(Negative of to-infinitive: not+to-infinitive) We decided not to go on a picnic because of the rain./She wanted not to fail in the test. . . . .

(Sense subject of to-infinitive: for+objective case/for+noun)

It is difficult for me to speak English./It is hard for me to keep a diary in English. . . . .

(When the sense subject of the to-infinitive is an adjective to express a person's personality or characteristic: of+object case/of+noun) [kind, careful, wise, foolish . . . .]

It is kind of her to help me./It is careless of him to make a mistake again and again. . . . .

(Idiomatic expression of to-infinitive 1)

I study hard in order to get a good grade.=I study hard so as to get a good grade.=I study hard to get a good grade. . . . .

(Idiomatic expression of to-infinitive 2) He is too young to ride a bike.=He is so young that he can't ride a bike. . . . .

(Idiomatic expression of to-infinitive 3) He is rich enough to buy a building.=He is so rich that he can buy a building. . . . .

Part 4 Verbs which need to-infinitive as an object/bare infinitive

(Verbs which need to-infinitive as the object) I [want] to be a designer./I [decided] to study hard. . . . .

[want/hope/decide/promise/expect/wish/choose/care/agree/plan/need/ refuse/fail]

(Verbs in the form of ‘subject+verb+object+to-infinitive’) He [asked] his brother to fix the door. . . . .

[want/ask/tell/order/advise/allow/expect/encourage/warn/persuade/ recommend]

(Causative verbs make, have, let+object+verb base)

[let: permit someone to want/have: give someone else the responsibility to do something/make: force someone to take an activity]

I made her wash the dishes./My father let me go to the party./I had him paint the wall. . . . .

(help+object+verb base=help+object+to-infinitive) He helped me get a house in Seoul.=He helped me to get a house in Seoul. . . . .

(Causative verb+object+to-infinitive/present participle) [see/watch/look at/hear/ listen to/feel/notice]

(bare infinitive is centered to activity) I saw him get on the bus. . . . . (present participle is centered to a progressive state of activity) I saw him getting on the bus. . . . .

The 26^{th} layer is a stage to learn about gerunds, and is configured to provide iterative learnings so that the learner can understand usages of gerunds and present participles in connection with to-infinitive through various expressions including various tenses based on the sentence building structure completed from the first to 25^{th} layers and can learn about gerunds, which are associated with various English expressions from the 27^{th} layer to the 33^{rd} layer that the learner will learn later. Examples of the contents of the 26^{th} layer to be learned are as follows.

Part 1 Roles of gerund

(Gerund as a subject) Learning English is very fun./Taking a shower after running makes me feel good. . . . .

(Gerund as an object) I like playing the piano./He finally gave up smoking and drinking. . . . .

(Gerund as a complement) My hobby is collecting coins./My favorite activity is playing the guitar in the school band. . . . .

(Gerund as an object of preposition) I am interested in reading comic books./We learn by listening. . . . .

Part 2 Negative of gerunds/verbs which need gerunds as an object

(Negative of gerund) Thank you for not being late. . . . .

(Verbs which need gerunds as an object) They [enjoy] playing soccer. (0) They enjoy to play soccer.(X) . . . . [enjoy/finish/practice/suggest/mind/give up/avoid/deny/consider/ escape/imagine]

(Verbs which need infinitives as an object) I [want] to be a designer. . . . . [want/hope/ decide/promise/expect/wish/choose/care/agree/plan/need/refuse/fail]

(Verbs which can use both of gerunds and to-infinitives as an object—if they have the same meaning) I [like] flying kites.=I [like] to fly kites. . . . . [like/begin/start/love/hate/continue]

(Verbs which can use both of gerunds and to-infinitives as an object—if they have different meanings) I remembered to give you 1,000 won. [symbol] [symbol] [symbol] . . . . I remembered giving you 1,000 won. [symbol] [symbol] [symbol] . . . . [remember to: remember something to do in the future remember ˜ing: remember something that I did], [forget to: forget something to do in the future≠forget ˜ing: forget something that I did], [stop to: stop in order to do something≠stop ˜ing: stop what I am doing], [try to: make an effort to do something≠try ˜ing: do something on trial]

Part 3 Sense subject of gerunds/idiomatic expressions of gerunds

(It is a principle that a possessive case is used in front of a gerund, but an object case is also possible) I am proud of your (you) winning the prize. . . . .

(Idiomatic expressions of gerunds)

[be busy ˜ing/keep ˜ing=go on ˜ing/feel like ˜ing/go ˜ing/How about ˜ing?/ What about ˜ing?/

cannot help ˜ing/look forward to ˜ing/spend ˜ing/It is no use ˜ing/be worth ˜ing/ be used to ˜ing/

have a hard time ˜ing=have trouble ˜ing=have difficulty ˜ing/on ˜ing/prevent+object+from ˜ing/

object to ˜ing/there is no ˜ing ]

Part 4 Gerund & present participle

(Discrimination of gerund and present participle)

Gerund: when it used as a noun in the next of verb ‘be’/when it used to have the meaning of use or purpose in front of a noun)

[smoking room, sleeping bag, waiting room, drinking water, parking lot, frying pen, sleeping pill, swimming pool . . . .]

Present participle: when it is used to have the meaning of a continuous tense in the next to verb ‘be’/when it is used as an adjective in front of a noun

[running girl, sleeping baby, smoking man, rising star, falling leaf, barking dog, walking woman, burning building . . . .]

(Gerund in the next to verb ‘be’: verb ‘be’+verb base+˜ing)

My job is teaching English./My favorite activity is taking pictures. . . . .

(Present participle in the next to verb ‘be’: verb ‘be’+verb base+˜ing)

My father is working on the farm./Jane is helping her mom. . . . .

(Gerund in front of a noun: meaning of use or purpose)

Look at the smoking room./I want to buy a sleeping bag for the camping trip. . . . .

(Present participle in front of a noun: it indicates an activity or a status of a noun modified by the present participle)

Look at the smoking man./Please be quiet for a sleeping baby. . . . .

The 27^{th} layer is a stage to learn about kinds of verbs and sentence structures, and is configured to provide iterative learnings so that the learner can understand constituent parts of sentences, kinds of sentences, sentence structures, and discrimination of parts of speech through various expressions including various tenses based on the sentence building structure completed from the first to 26^{th} layers, and learn about kinds of verbs and sentence structures, which are associated with various English expressions from the 28^{th} layer to the 33^{rd} layer that the learner will learn later. Examples of the contents of the 27^{th} layer to be learned are as follows.

Part 1 Constituent parts of sentence

(Subject: noun, pronoun, gerund, noun phrase, noun clause, to-infinitive as a noun, and so on)

The book is very interesting. (noun)/She is cute. (pronoun)/Riding a bike is fun. (gerund)/

How to live is more important matter. (noun phrase)/What I want is time. (noun clause)/To study English is important. (to-infinitive)

(Verb: to indicate a status or an activity of a subject)

He is my English teacher. (verb ‘be’)/Jane likes making cookies. (general verb) . . . .

(Object: noun, pronoun, gerund, noun phrase, noun clause, to-infinitive as a noun, and so on)

I like horror movies. (noun)/He loved her. (pronoun)/Tom wanted to buy a new car. (to-infinitive)/

Matt enjoys surfing the internet. (gerund)/My grandfather doesn't know how to use the computer. (noun phrase)/

Jane knows that he told a lie. (noun clause) . . . .

(indirect object, direct object) She gave me (indirect object) a cup of coffee. (direct object) . . . .

Part 2 Constituent parts of sentence

(Subjective complement) My father is a fire fighter. (Subjective complement) . . . .

(Objective complement) I saw her dancing on the stage. (Objective complement) . . . .

(Modifier: adjective, adverb, and prepositional phrase)

I know that pretty girl. (adjective modifying a noun)/The bird in the cage has colorful feathers. (prepositional phrase modifying a noun)/

He runs very fast. (adverb modifying an adverb)/Luckily, Tom passed the exam. (adverb modifying a sentence) . . . .

(8 parts of speech: noun, pronoun, verb, adjective, adverb, preposition, conjunction, and interjection)

Learning to correctly understand the meanings of parts of speech and discriminate the parts of speech through various sentences

Part 3 Kinds of verbs & five basic structures of sentence

(Five basic structures of sentences according to whether of existence of objects and complements)

(Type 1 S-V: subject+complete intransitive verb) They sing beautifully. . . . .

(Type 2 S-V-C: subject+incomplete intransitive verb+complement) His father was a pilot. . . . .

(incomplete intransitive verbs) [become/get/grow/turn/keep/remain/stay], verbs of perception [look/smell/sound/taste/feel]

(Type 3 S-V-O: subject+complete transitive verb+object) Jane bought a new electronic dictionary. . . . .

Part 4 Kinds of verbs & five basic structures of sentence

(Type 4 S-V-IO-DO: subject+dative verb+indirect object+direct object) My mother gave my brother a toy. . . . .

Dative verbs[give/show/buy/make/teach/bring/lend/send/ask . . . .]

(Change a sentence of S-V-IO-DO into a sentence of S-V-O) She sent me a post card. She sent a post card to me. . . . .

(Type 5 S-V-O-OC: subject+incomplete intransitive verb+object+objective complement (noun)) We call our captain ‘Joker’. . . . .

(Type 5 S-V-O-OC: subject+incomplete intransitive verb+object+objective complement (adjective)) Her smile made me happy. . . . .

(Type 5 S-V-O-OC: subject+dative verb+object+objective complement (bare infinitive)) Our teacher [made] us keep a diary. . . . .

Dative verbs [make/have/let]

(Type 5 S-V-O-OC: subject+verb of perception+object+objective complement (bare infinitive/present participle)) I [heard] her play the piano at the concert hall. . . . .

Verbs of perception [see/watch/hear/feel/notice/look at/listen to]

(Type 5 S-V-O-OC: Sentence with to-infinitive as an objective complement) Mr. Lee [told] them to be quiet. . . . .

[want/ask/tell/order/advise/allow/expect/encourage/warn/persuade/recommend . . . .]

The 28^{th} layer is a stage to learn about participles, and is configured to provide iterative learnings so that the learner can understand kinds and roles of participles, participle forms of emotions, understanding of present participle and gerund, and forms of participle constructions through various expressions including various tenses based on the sentence building structure completed from the first to 27^{th} layers, and learn about participles, which are associated with various English expressions from the 29^{th} layer to the 33^{rd} layer that the learner will learn later. Examples of the contents of the 28^{th} layer to be learned are as follows.

Part 1 Kinds of participles/roles of participles

(Present participle: regular and irregular verb+ing)

Verb base+ing [eat-eating . . . . ], for verbs ending in ‘e’, we remove the ‘e’, and add ‘ing’. [make-making . . . .],

For verbs that end in ‘short vowel+short consonant’, we add the final consonant once more and add ‘ing’. [swim-swimming . . . .], For verbs that end in ‘ie’, we change the ‘ie’ into ‘y’ and add ‘ing’ [die-dying . . . .]

(Meaning of present participle) A rolling stone gathers no moss. rolling stone: progress/It was an interesting novel. interesting novel: active . . . .

(Regular verbs in past participle tense: verb base+d/+ed)

Verb base+ed [play-played . . . .], For verbs ending in e′, we add ‘d’ [use-used . . . .],

For verbs that end in a consonant+y, we remove the y and add ‘ied’ [study-studied . . . .], For verbs that end in ‘short vowel+short consonant’, we add the final consonant once more and add ‘ed’ [stop-stopped . . . .]

(Irregular verbs in past participle tense: A-A-A verb base, past, past participle all have the same form) [cost-cost-cost, cut-cut-cut . . . .]

(Irregular verbs in past participle tense: A-B-A verb base and past participle have the same form) [come-came-come, run-ran-run, become-became-become]

(Irregular verbs in past participle tense: A-B-B past and past participle have the same form) [bend-bent-bent, buy-bought-bought . . . .]

(Irregular verbs in past participle tense: A-B-C verb base, past, and past participle all have different forms from one another) [bite-bit-bitten, do-did-done . . . .]

(Meaning of past participle: passive meaning) Don't sit on the broken chair. . . . .

(Participle as an adjective in front of a noun) This is an exciting game./The wounded soldier is recovering now. . . . .

(Participle as an adjective in the next to a noun) The girl playing the piano in the living room is Jane./The language spoken in America is English. . . . .

(Participle as a subjective complement) My father sat reading a newspaper./The mystery remains unsolved. . . . .

(Participle as an objective complement) I saw Ann cooking in the kitchen./John had his money stolen on the subway. . . . .

Part 2 participle forms of emotions, understanding of present participle and gerund

(Participle forms having different meanings in connection with things or persons) interest (take an interest)-interesting (cause an interest)-interested (get an interest)

[excite/surprise/bore/disappoint/shock/amaze/move/touch/depress/tire/confuse/frighten/fascinate/embarrass/amuse/impress/satisfy]

(thing+verb ‘be’+present participle: make someone feel some emotion) The news was surprising. . . . .

(person+verb ‘be’=past participle: a person feels something) I was surprised at the news. . . . .

(Gerund: next to verb ‘be’) My hobby is collecting foreign coins. . . . .

(Present participle: Gerund: next to verb ‘be’—continuous tense) My mother is cooking in the kitchen. . . . .

(Gerund: in front of a noun) These running shoes are comfortable. . . . .

(Present participle: in front of a noun) Look at the dancing girl. . . . .

Part 3 Forms of participle constructions

(When a subordinate clause and a main clause have the same subject)

Because she won the first prize, she felt happy. Winning the first prize, she felt happy. . . . .

(When a subordinate clause and a main clause have the same subject but have different forms)

While Jennifer does her homework, she listens to music. Doing her homework, Jennifer listens to music. . . . .

(when it is necessary to clarify the meaning, a conjunction is not omitted)

After she finished the work, she went to bed After finishing the work, she went to bed. . . . .

(Being+present participle, being+past participle: it is possible to omit ‘Being’)

While we were watching TV, we laughed a lot. (Being) Watching TV, we laughed a lot. . . . .

(When a subordinate clause and a main clause have different subjects)

When the festival was over, we were tired out. The festival being over, we were tired out. . . . .

Part 4 Forms of participle constructions

(Meaning of participle construction: time) When I heard the news, I couldn't say anything. Hearing the news, I couldn't say anything. . . . .

(Meaning of participle construction: reason) Because she studied hard, she got a good score. Studying hard, she got a good score. . . . .

(Meaning of participle construction: condition) If you save money, you can travel around the world. Saving money, you can travel around the world. . . . .

(Meaning of participle construction: concession) Though she was tired, she cooked a turkey for us. Being tired, she cooked a turkey for us. . . . .

(Meaning of participle construction: simultaneous motion) While they sang merrily, they walked together. Singing merrily, they walked together. . . . .

(Meaning of participle construction: continuous motion) He sang a song and came down from the stage. He sang a song, coming down from the stage. . . . .

(when a negative, such as not or never, is used in front of a negative participle construction)

As I didn't have enough money, I couldn't buy a new car. Not having enough money, I couldn't buy a new car. . . . .

(Independent participle construction in impersonal form)—Strictly speaking, he is overweight./Frankly speaking, I envy his success./

Generally speaking, girls are more emotional than boys./Speaking of movies, I want to be a movie director./

Judging from her looks, she seems to be a model./Considering his salary, he spends a lot of money on his hobbies. . . . .

The 29^{th} layer is a stage to learn about tenses of verbs, and is configured to provide advanced learning processes of present, past, future, present perfect, past perfect, future perfect, present continuous, past continuous, future continuous, and present perfect continuous tenses through various expressions including various tenses based on the sentence building structure completed from the first to 28^{th} layers and provide iterative learnings so that the learner can complete the sentence building structure of all tenses including the perfect tenses and learn about tenses of verbs, which are associated with various English expressions from the 30^{th} layer to the 33^{rd} layer that the learner will learn later. Examples of the contents of the 29^{th} layer to be learned are as follows.

Part 1 Present tense/past tense/future tens (review & advanced)

(Present tense of verb ‘be’) [first person: in singular, I am/in plural, We are], [second person: in singular, You are/in plural, You are], [third person: in singular, He, She, It is/in plural, They are]

(verb form for third person singular in present tense) [first and second person plural subjects need verb bases], [third person singular: verb+s, es, ies/have has]

(Present tense: to express the present facts or state) Mary lives in Canada. . . . .

(Present tense: to express regular habits or repeated activitys) Ann gets up at 6 every morning. . . . .

(Present tense: to express facts or truths regardless of a flow of the present time period, and proverbs or sayings) The earth is round. . . . .

(Present tense: to express something that is fixed in the future) The last train leaves at 11 tonight. . . . .

(Present tense: to talk about the future in adverbial clauses of time and condition) When it rains tomorrow, we won't go on a picnic. . . . .

[Time: when/until/before/while], [Condition: if/unless]

(past tense of verb ‘be’) [First person: Singular, I was/plural, We were], [second person: Singular, You were/Plural, You were], [third person: Singular, He, She, It was/Plural, They were]

(regular verbs in past tense) [verb base+ed, d, ied]

(Irregular verbs in past participle tense: A-A-A verb base, past, past participle all have the same form) [cost-cost-cost, cut-cut-cut . . . .]

(Irregular verbs in past participle tense: A-B-A verb base and past participle have the same form) [come-came-come, run-ran-run, become-became-become]

(Irregular verbs in past participle tense: A-B-B past and past participle have the same form) [bend-bent-bent, buy-bought-bought . . . .]

(Irregular verbs in past participle tense: A-B-C verb base, past, and past participle all have different forms from one another) [bite-bit-bitten, do-did-done . . . .]

(Past tense: to express activity or states in the past) It was very cold yesterday. . . . .

(Past tense: to express historical facts in the past) The Korean War broke out in 1950. . . . .

(Future tense: to express a supposition or meaning of a future situation) I will do it for myself. . . . .

(Future tense: to express something decided to do in the future) I will (=be going to) take a yoga class during the vacation. . . . .

Part 2 Present perfect tense

(Present perfect: have/has+past participle) We became friends a year ago. We are still friends. We have been friends for a year. . . . .

(Present perfect: to express an experience from the past to the present, and you can use the present perfect with ever, never, once, and before) I have eaten Italian food [before]. . . . .

(Present perfect: to express that an activity of the past is completed now, and you can use the preset perfect with just, already, and yet) They have [just] arrived in Seoul. . . . .

(Present perfect: to express that an activity of the past continues until now, and you can use the present perfect with for, since, how long, and so far) I have studied Spanish [for] three years. . . . .

(Present perfect: to express an activity that occurred in the past but has a result in the present) Ann has lost her wallet. . . . .

(Present perfect application rule 1: Do not use the present perfect when you talk about a finished time with yesterday, ago, last, in+years, and the interrogative ‘when.

(Present perfect application rule 2: Do not use a first person subject or a second person subject with ‘have/has gone to’ which means a result.

(Present perfect application rule 3: I have been to the station to buy a ticket. —which means I have gone to a place and returned (completion)/I have been to America twice. —which means I have an experience up to the present (experience).

Part 3 Past perfect tense/future perfect tense

(Past perfect: had+past participle) When I arrived at the station, the train had already left. . . . .

(Past perfect: experience) As I had seen Ann several times before, I knew her at once. . . . .

(Past perfect: completion) When he got there, she had already left the restaurant. . . . .

(Past perfect: continuity) I had used this computer for 10 years until I sold it. . . . .

(Past perfect: result) My uncle had joined the army when I was born. . . . .

(Future perfect: will have+past participle: To express an activity, which means an experience, a completion, a continuity, and a result, that will be completed between now and some point in the future.

If I watch this movie once more, I will have watched it three times.

Part 4 Present continuous/past continuous/future continuous/present perfect continuous

(Present continuous: verb ‘be’+verb base+ing: activity or state that is currently in progress) I am washing my hair now. . . . .

(Present continuous instead of future tense: in this case, the present continuous uses verbs go, come, start, leave, begin, and so on) We are going camping tomorrow. . . . .

(Verbs which are not used for present continuous) I know him (0), I am knowing him (X) . . . .

[have/like/respect/understand/admire/own/love/want/forget/belong/hate/ know/remember]

(Past continuous: past form of verb ‘be’+verb base+ing: activity or state that was in progress in the past) I was playing baseball with my friends. . . . .

(Future continuous: will be+verb base+ing : activity or state that will be in progress in future) We will be having dinner then. . . . .

(Present perfect continuous: have/has been+verb base+ing: the non-restrictive of the present perfect and the present perfect continuous are all used to express a period of time that continues from the past until now, but the present perfect continuous emphasizes that the activity is still happening.)

I started to write a letter at nine o'clock.+I am still writing a letter. I have been writing a letter since nine o'clock. . . . .

The 30^{th} layer is a stage to learn about the subjunctive and speech, and is configured to provide iterative learnings so that the learner can understand kinds of the subjunctives, various forms of the subjunctives, and changes of speech through various expressions including various tenses based on the sentence building structure completed from the first to 29^{th} layers and learn about the subjunctive and speech, which are associated with various English expressions from the 31^{st} layer to the 33^{rd} layer that the learner will learn later. Examples of the contents of the 30^{th} layer to be learned are as follows.

Part 1 Kinds of subjunctives

(Kinds of moods) Indicative mood: State an actuality or a fact—I am a student./Imperative mood: Make an order, request, suggestion or prohibition-Look at me.

Subjunctive mood: Express a doubtful condition (contrary to fact)—If I were a bird, I would fly to you. . . . .

(Subjunctive past perfect: If+subject+had+P.P., subject+would, should, could, might+have P.P.)

If he had studied harder, he would have passed the exam.=As he didn't study harder, he did not pass the exam. . . . .

(Subjunctive past: If+subject+past verb, subject+would, should, could, might+verb base) After ‘if’ and ‘wish’, we use ‘were’ regardless of the first person, the second person and the third person.

If I were a bird, I would fly to you.=As I am not a bird, I can not fly to you. . . . .

(The subjunctive past is changed into the present tense when it is changed into direct speech.)

If Jane knew his phone number, she would call him.=As Jane doesn't know his phone number, she doesn't call him. . . . .

(Mixed subjunctive: subjunctive past perfect+subjunctive past) If he had studied harder, he could pass the exam. . . . .

Part 2 Various forms of subjunctives

(Subjunctive future: If+subject+should+verb base, subject+will/would, can/could, may/might, shall/should+verb base)

If it should rain tomorrow, I shall not start./If I should fail, I would try again. . . . .

(Ellipsis and inversion of ‘if’) If I had studied harder, I would have passed the exam.=Had I studied harder, I would have passed the exam./

If I were not sick, I could go to the concert.=Were I not sick, I could go to the concert. . . . .

(Subjunctive past perfect with ‘I wish’: I wish+subject+had+P.P.) I wish I had had many friends.=I'sorry I didn't have many friends. . . . .

(Subjunctive past with ‘I wish’: I wish+subject+past verb=I wish+subject+could+verb base) I wish I were rich.=I'sorry I am not rich./

I wish I could speak English fluently enough to travel alone.=I'sorry I can't speak English fluently enough to travel alone. . . . .

(Subjunctive past perfect with ‘as if’: as if+subject+had+P.P.)

My brother talks as if he had washed the car by himself.=In fact, my brother didn't wash the car by himself. . . . .

(Subjunctive past with ‘as if’: as if+subject+past verb) She acts as if she were sick.=In fact, she is not sick. . . . .

(Subjunctive past perfect with ‘Without˜’, ‘But for˜’, ‘If it had not been for˜’: subject+would, could, should, might+have+P.P.)

Without the courage, he could not have fought with a robber.=But for the courage, he could not have fought with a robber.

=If it had not been for the courage, he could not have fought with a robber. . . . .

(Subjunctive past with ‘Without˜’, ‘But for˜’, ‘If it had not been for˜’: subject+would, could, should, might+verb base)

Without you help, I could not write a poem in English.=But for your help, I could not write a poem in English.

=If it were not for your help, I could not write a poem in English. . . . .

Part 3 Change of speech

(General rule for changing speech) Use a ‘reporting verb’, remove comma and quotation marks and use ‘that’, change the ‘person’, change the tense in the reported speech, and change adverbs of time and place and demonstrative pronouns.

(Direct speech) He said, “I am tired”. (Reported speech) He said that he was tired. . . . .

(Change of speech in declarative sentence) Use a ‘reporting verb’, remove comma and quotation marks and use ‘that’, change the ‘person’, change the tense in the reported speech, and change adverbs of time and place and demonstrative pronouns.

(Direct speech) Jason said to me, “I want to go to a movie with you tomorrow.”. . . .

(Reported speech) Jason told me that he wanted to go to a movie with me the next day. . . . .

(Change of speech in declarative sentence) If you report the currently regular habit or something hasn't changed, you do not need to change the verb.

(Direct speech) Aden said, “I go to church every Sunday.”. . . .

(Reported speech) Aden said that he goes to church every Sunday. . . . .

(Change of speech in declarative sentence) If you report a historical fact, you have to express it in the past tense.

(Direct speech) He said to us, “The French Revolution broke out in 1789.”. . . .

(Reported speech) He told us that the French Revolution broke out in 1789. . . . .

(Change of speech in question with no question word) Change the reporting word into ‘asked’, and then, arrange in order of ‘if/whether+subject+verb’.

(Direct speech) He said to me, “Do you know the myth about the Pandora's box?”. . . .

(Reported speech) He asked me If I knew the myth about the Pandora's box. . . . .

(Change of speech in question with a question word) Change the reporting word into ‘asked’, and then, arrange in order of ‘question word+subject+verb’.

(Direct speech) My teacher said to me, “What are you watching now?”. . . . (Reported speech) My teacher asked me what I was watching then. . . . .

(Change of speech in question with a question word) In case that the question word is a subject, arrange in order of ‘question word+verb’.

(Direct speech) She said, “Who broke this vase?”. . . . (Reported speech) She asked who had broke that vase. . . . .

Part 4 Change of speech

(Change of speech in positive imperative sentence) Change a verb base into ‘to+verb base’.

(Direct speech) Jane said to me, “Call me tomorrow.”. . . . (Reported speech) Jane told me to call her the next day. . . . .

(Change of speech in negative imperative sentence) Change a verb base into ‘not to+verb base’.

(Direct speech) The doctor said to her, “Don't eat too much fast food for your health.”. . . .

(Reported speech) The doctor advised her not to eat too much fast food for her health.”. . . .

(Change of speech in imperative sentence) For an imperative sentence with ‘please’, use ‘ask’ as the ‘reporting word’.

(Direct speech) He said to her, “Please, send me your photos.”. . . . (Reported speech) He asked her to send him her photos. . . . .

(Change of speech in exclamatory sentence) Use a ‘reporting word’, such as exclaim, cry, shout, or sigh, and change the exclamation ‘Hurrah’ into ‘with delight’.

(Direct speech) He said, “How nice this jacket is!”. . . . (Reported speech) He exclaimed how nice that jacket was. . . . .

(Change of speech in optative sentence) In case of praying God, use a ‘reporting word’ with ‘pray’.

(Direct speech) He said, “May God save my son!”. . . . (Reported speech) He prayed that God save his son. . . . .

(Change of speech in optative sentence) In case of wishing a person, use a ‘reporting word’ with ‘express one's wish tha’.

(Direct speech) She said, “May he come safely!”. . . . (Reported speech) She expressed her wish that he might come safely. . . . .

The 31^{st} layer is a stage to learn about modal verbs, and is configured to provide iterative learnings so that the learner can understand modal verbs, do, have, can, may, must, should/ought to, will, would, and used to through various expressions including various tenses based on the sentence building structure completed from the first to 30^{th} layers and learn about the modal verbs, which are associated with various English expressions from the 32^{nd} layer to the 33^{rd} layer that the learner will learn later. Examples of the contents of the 31^{st} layer to be learned are as follows.

Part 1 Modal verbs do, have

(Modal verb do) For verbs in questions and negative sentences—She studies English. (Question) Does she study English? (Negative sentence) She doesn't study English?. . . .

(Modal verb do) Modal verb ‘do’ emphasizes a verb and means ‘really’ and ‘surely’.

I finished my homework before school started. (Emphasis of verb) I did finish my homework before school started. . . . .

(Modal verb do) Modal verb ‘do’ is used as a pro-verb to avoid repetition of the verb used previously.

Do you remember Jane's birthday? Yes, I do./I like classical music as much as Jane does. . . . .

(do) When verb ‘do’ is used as a main verb: I can do it by myself./I have done reading. . . . .

(have) When verb ‘have’ is used as a main verb: present perfect, past perfect, and future perfect—I have some books./I have made the toy car. . . . .

(Modal verb have) to express supposition or regret of the past fact

(Uncertain supposition of the past fact: may+have+pp) Daniel may have forgotten the appointment with Jane. . . . .

(Certain supposition of the past fact: must+have+pp) Someone must have broken the fence. . . . .

(Negative supposition of the past fact: cannot+have+pp) He cannot have told a lie to me. . . . .

(Regret of the past fact: should+have+pp) You should have joined the debate. . . . .

Part 2 Modal verbs can, may

(can for ability and possibility) Anne can solve the problem./A computer can store a lot of information. . . . .

(can for ability and possibility=be able to) (Present tense) I can swim in the river.=I am able to swim in the river. . . . .

(Past tense) He could play the guitar.=He was able to play the guitar. . . . . (Future tense) She will be able to solve the problem. . . . .

(can for permission) You can leave now./Can I stay here until Friday?. . . .

(can for request) Can you carry this box?/Can you pass me the salt?. . . .

(can not for supposition) She can't tell a lie./They can't such a thing. . . . .

(can for strong doubt) Can the news be true?/Can it be possible?. . . .

(may for permission) You may come whenever you have time./May I use your electronic dictionary?. . . .

(may for supposition) She may come home earlier than usual./The rumor may be true.

(may for pray or wish: may+subject+verb base) May you live long!/May you succeed!. . . .

(Idiomatic expressions of may 1) I will start early so that I may get a good seat./You must study hard in order that you may pass the test. . . . .

(Idiomatic expressions of may 2) You may well be surprised at the news./She may well say so. . . . .

(Idiomatic expressions of may 3) You may as well take a rest.=You had better take a rest. . . . .

Part 3 Modal verbs must, should/ought to

(must, which means obligation caused from necessity,=have to) I must finish the work before watching TV./Ann has to take care of her little sister every Sunday. . . . .

(Past tense and future tense of ‘must’) (Past) I had to finish the work before watching TV. (Future) I will have to finish the work before watching TV. . . . .

(must not for prohibition) You must not park here. . . . . (don't have(need) to for unnecessity) I don't have to take this medicine any more. . . . .

(must to sure that something is true (certainty) Eric must be popular among the girls./ The rumor must be false. . . . .

(A negative form of ‘must’ for certainty is ‘can't be’) The rumor can't be false./They can't be hungry now. . . . .

(should/ought to for obligation or advice) You should keep your promise./We ought to obey the traffic rules. . . . .

(Negative form of ‘should/ought to’) You should not lose this chance./You ought not to tell the secret. . . . .

(should to express regret, repent and reproach of the past: should+have+pp) I should have worked harder./I should have locked the door. . . . .

(Special usage of ‘should’ 1) To emphasize rational judgment/feelings: It is+adjective of rational judgment/feeling+that+subject+should+verb base

It is important that you should study hard in your school days./It is necessary that he should admit his fault. . . . .

(Special usage of ‘should’ 2) in case of verbs for suggestion, insistence, advice, and so on: subject+verb+that+subject+should (omittable)+verb base

He suggested that I (should) go to the party with him./She insisted that we (should) stay here. . . . .

Part 4 Modal verbs will, would, used to

(will to express a will, a supposition, or a schedule) I will not make a mistake again./ Jane will study harder to pass the exam. . . . .

(will=be going to) I will clean my room.=I am going to clean my room. . . . .

(will to express a request or a suggestion) Will you show me the way to the City Hall?/ Will you join us?. . . .

(will to express the present habit) I will often sit up all night./My son will often come on Sunday. . . . .

(The past form of will is would) She believed that he would get well soon./I thought that she would try it again. . . . .

(would to express the past habit) I would often sit up all night./My son would often come on Sunday. . . . .

(would to express a polite request) Would you do me a favor?/Would you mind opening the window?. . . .

(would like to+verb base) I would like to buy an MP3 player./What would you like to do?. . . .

(would like+noun) I′d like a hamburger and chicken salad./Would you like something to drink?. . . .

(would rather+verb base) I would rather give up the marathon./I would rather stay home than go out with him. . . . .

(‘used to’ for past habit) Jane used to live in France./There used to be a big well here. . . . .

(‘used to’ for past habit or state=would) He used to go to church on Sundays.=He would go to church on Sundays. . . . .

The 32^{nd} layer is a stage to learn about the passive voice, and is configured to provide iterative learnings so that the learner can understand the meaning and forms of the passive voice, passive tenses, modal verbs in the passive voice, the passive voice from which ‘by’ is omitted, prepositions in the passive voice, sentence kinds in the passive voice, sentence structures in the passive voice through various expressions including various tenses based on the sentence building structure completed from the first to 31^{st} layers and learn about the passive voice, which is associated with various English expressions of the 33^{rd} layer that the learner will learn later. Examples of the contents of the 32^{nd} layer to be learned are as follows.

Part 1 Meaning and forms passive voice, and passive tense

(How to change the active into the passive: subject+be+P.P.+by+objective case) (Active) I make a cake. (Passive) A cake is made by me. . . . .

(Meaning of passive) (Active) Dad repairs my bike. (Passive) My bike is repaired by dad. . . . .

(Form of passive) subject (subject case of active object)+be (must agree with the subject in person and number)+P.P.+by+object (objective case of active subject) . . . .

(Present passive: be+P.P.) (Active) We respect out homeroom teacher. (Passive) Our homeroom teacher is respected by us. . . . .

(Past passive: past verb ‘be’+P.P.) (Active) She wrote a book. (Passive) A book was written by her. . . . .

(Future passive: will be+P.P.) (Active) Our club will hold the spring festival in May. (Passive) The spring festival will be held in May by our club. . . . .

Part2 Passive tense, modal verbs in the passive voice, the passive voice from which ‘by’ is omitted, prepositions in the passive voice

(Present perfect passive: have been+P.P.)—(Active) Jane has cleaned the room. (Passive) The room has been cleaned by Jane. . . . .

(Past perfect passive: had been+P.P.)—(Active) John had invited us to the concert. (Passive) We had been invited to the concert by John. . . . .

(Future perfect passive: will have been+P.P.)—(Active) She will have written this book. (Passive) This book will have been written by her. . . . .

(Present continuous passive: be+being+P.P.)—(Active) My father is repairing the fence. (Passive) The fence is being repaired by my father. . . . .

(Past continuous passive: past verb ‘be’+being+P.P.)—(Active) They were discussing the topic. (Passive) The topic was being discussed by them. . . . .

(Modal verb in passive voice: modal verb+be+P.P.)—(Active) Sally can solve the problem. (Passive) The problem can be solved by Sally. . . . .

(Active) She may write the letter. (Passive) The letter may be written by her. . . . .

(Active) The participators must obey these rules. (Passive) These rules must be obeyed by the participators. . . . .

(‘by+objective case’ may be omitted when a doer is not clear) English is spoken in England (by people)./A full moon can be seen on Chuseok (by us). . . . .

(When it is unclear who is a doer, ‘by+object’ may be omitted) He was killed in the Korean War./My MP3 player was stolen at the library. . . . .

(Prepositions besides ‘by’) [be filled with/be covered with/be pleased with/be crowded with/be satisfied with/be disappointed with/be interested in/be surprised at/be known as/be known to/be known for/be tired of/be made of/be ashamed of/be excited about/be worried about . . . .]

Part 3 Sentence kinds in the passive voice

(Present tense in negative sentence) (Active) Jane doesn't play the piano. (Passive) The piano is not played by Jane. . . . .

(Past tense in negative sentence) (Active) Jane didn't write this novel. (Passive) This novel was not written by him. . . . .

(Negative sentence with ‘can’) (Active) Julie can't solve the math problem. (Passive) The math problem can't be solved by Julie. . . . .

(Future tense in negative sentence) (Active) Mr. Brian will not publish the magazine next month. (Passive) The magazine will not be published next month by Mr. Brian. . . . .

(Questions with no questions words) (Active) Does she play the piano? (Passive) Is the piano played by her?/

(Active) Did he make this robot? (Passive) Was this robot made by him?. . . .

(Questions with questions words) (Active) When did he build this house? (Passive) When was this house built by him?. . . .

(When the question word ‘who’ is a subject) (Active) Who broke the window? (Passive) By whom was the window broken?. . . .

(Positive imperative sentence) (Active) Finish the report. (Passive) Let the report be finished. . . . .

(Negative imperative sentence) (Active) Don't forget this lesson. (Passive) Don't let this lesson be forgotten. . . . .

Part 4 Sentence structures in passive voice

(Sentence type 3 S-V-O) (Active) Jane wrote a thank-you card. (Passive) A thank-you card was written by Jane. . . . .

(When a direct object of the sentence type 4 S-V-IO-DO becomes a subject) (Active) He gave me an interesting novel. (Passive) An interesting novel was given to me by him. . . . .

(Verbs which use only the direct object of the sentence type 4 S-V-IO-DO as a subject in passive voice) [buy/write/make/find/bring/sell/sing . . . .]

(When an indirect object of the sentence type 4 S-V-IO-DO becomes a subject) (Active) He gave me an interesting novel. (Passive) I was given an interesting novel by him. . . . .

(Sentence type 5 S-V-O-C) (Active) Her smile made him happy. (Passive) He was made happy by her smile. . . . .

(Sentence type 5 S-V-O-C) A verb base which is used as an objective complement of a causative verb [make] and a verb of perception [see/watch/look at/listen to/hear/feel/notice . . . .] is changed into to-infinitive when the sentence is changed into the passive voice.

(Causative verbs and verbs of perception in the sentence type 5 S-V-O-C) (Active) My father made me read more books. (Passive) I was made to read more books by my father. . . . .

(‘let’ in the sentence type 5 S-V-O-C is changed into ‘be allowed to-infinitive in the passive voice) (Active) My mom let me go to the party.

(Passive) I was allowed to go to the party by my mom. . . . .

(A transitive verb phrase is also used as a phrase even in the passive voice) [look into/ attend to/listen to/speak to/account for/send for/run over/look after/laugh at . . . .] (Active) Wendy looked after my puppy. (Passive) My puppy was looked after by Wendy. . . . .

The 33^{rd} layer is a stage to learn about relative pronouns and relative adverbs, and is configured to provide iterative learnings so that the learner can perfectly understand relative pronouns who, which, that, and what, usage and ellipsis of the relative pronouns, relative adverbs where, when, why, and how, and usage and ellipsis of the relative adverbs through various expressions including various tenses based on the sentence building structure completed from the first to 32^{nd} layers, thereby having a good command of English in all expressions that the learner can express in his or her native language by perfectly learning all English grammatical structures through various sentences with 20,000 or more words and 860 or more idioms.

Part 1 Relative pronouns who, which, whose, of which, whom

(Role of relative pronouns: We use a relative pronoun in relative clauses instead of a conjunction and a pronoun) I know Jennifer.+She has brown eyes.=I know Jennifer who has brown eyes. . . . .

(who as a subjective case) I don't know Mr. Park.+He lives next door.=I don't know Mr. Park who lives next door. . . . .

(whose as a possessive case) I met a boy.+His name is Kevin.=I met a boy whose name is Kevin. . . . .

(whom as an objective case) This is the lady.+I met her at the party.=This is the lady whom I met at the party. . . . .

(whom as an objective case of a preposition) This is Ann.+I played tennis with her last weekend.=This is Ann whom I played tennis with last weekend. . . . .

(which as a subjective case) I have a book.+It is very interesting.=I have a book which is very interesting. . . . .

(which as an objective case) This is a bike.+I bought it yesterday.=This is a bike which I bought yesterday. . . . .

(whose, of which as a possessive case) I found a book.+Its cover is green.

=I found a book whose cover is green.=I found a book of which the cover is green.=I found a book the cover of which is green. . . . .

Part 2 Relative pronouns that, what

(that as a subjective case) This is John.+He came here yesterday.=This is john that (=who) came here yesterday. . . . .

(that as an objective case) Ann is the girl.+I wanted to meet her.=Ann is the girl that (=whom) I wanted to meet. . . . .

(that as an object of a verb or a preposition) This is the house.+She lives in it.=This is the house in that she lives in. . . . .

(We must use ‘that’) when an antecedent is [person+animal], [person+thing], or a superlative adjective, or is modified by an ordinal number

When the same, the only, the very, or the like is used, when the relative pronoun is used with all, every, any, no, and thing, or when a question word is used,

Look at the boy and his dog that are crossing the street./This is the tallest building that I have ever seen. . . . .

(what) When ‘what’ serves as a subject, a complement or an object and introduces a noun clause, an antecedent is not used in front of ‘what’ because the ‘what’ includes the antecedent.

(Subject) What he said is true. (Object) I can't believe what he said. (Complement) That is what he said. . . . .

Part 3 Restrictive and nonrestrictive clauses of relative pronouns/ellipsis of relative pronouns

(Restrictive clause of relative pronoun) I know a boy.+He speaks English very well.=I know a boy who speaks English very well./

This is the letter.+John sent it to me.=This is the letter which John sent to me. . . . .

(Nonrestrictive clause of relative pronoun) She has two daughters, who became teachers.=She has two daughters, and they became teachers./We

We trust John, who has never told a lie.=We trust John, because he has never told a lie. . . . .

(Ellipsis of object relative pronoun) I know the boy.+You like him.=I Know the boy whom (that) you like.=I know the boy you like./

We wanted to eat the cake.+She made it.=We wanted to eat the cake which (that) she made.

=We wanted to eat the cake she made. . . . .

(Ellipsis of ‘subject relative pronoun+verb be’)

Ellipsis of ‘subject+verb be+present participle’: Look at the girl who (that) is playing the guitar.=Look at the girl playing the guitar. . . . .

Ellipsis of ‘subject+verb be+past participle’: My father gave me a box which (that) was made of wood.=My father gave me a box made of wood. . . . .

Ellipsis of ‘subject+verb be+adjective phrase’: The pink dress which (that) is in the closet is my sister's.=The pink dress in the closet is my sister's. . . . .

Part 4 Relative adverbs where, when, why, and how/Restrictive and nonrestrictive clauses of relative adverbs/Ellipsis of relative adverb and antecedent

(Relative adverb where) The hotel was very clean.+We stayed there.=The hotel where we stayed was very clean. . . . .

(Relative adverb when=on, in, at which) March 30^{th} is the day.+I got a driver's license then.=

March 30^{th} is the day on which I got a driver's license.=March 30^{th} is the day when I got a driver's license. . . . .

(Relative adverb why=for which) This is the reason.+I was late for school for the reason.=

This is the reason for which I was late for school.=This is the reason why I was late for school. . . . .

(Relative adverb how=in which) Tell me the way.+You know the direction in the way.=

Tell me the way in which you know the direction.=(ellipsis of antecedent ‘the way’) Tell me how you know the direction. . . . .

(Restrictive clause of relative adverbs) Sunday is the day.=We have no class on the day.=Sunday is the day when we have no class./I

I know the reason.+He ran away for the reason.=I know the reason why he ran away. . . . .

(Nonrestrictive clause of relative adverbs) We went to the city, where we stayed for a week.=We went to the city, and there we stayed for a week

In the present invention, because the higher layers are configured to be higher in learning level than the lower layers, if the learner proceeds to the higher stage without completing learning of contents in the lower stages, the learner cannot obtain proper learning effects. So, the present invention provides a building type education that the learner learns English in consecutive order from lower stages to higher stages after directly checking his or her learning status progressed up to recently or after the control part 110 reads and checks the learner's learning status from the learner database 12.

For instance, if the learner completed his or her learning to ‘Modal verbs’, which correspond to the 31^{st} layer, during the previous learning hours, when the learner logs in, the corresponding contents is read from the learner information of the learner database 12, and then, the learning stage corresponding to ‘Passive voice’ of the 32^{nd} layer, which is the next stage, is automatically selected by control of the control part 110 and by the learning stage selection module 130, so that the learner can progress his or her learning.

The learning stage selection module 130 is located inside the learning operating server 10, and first selects one of the learning stages stored in the learning contents database 120, which the learner wants to learn. In this instance, in connection with the learning stages, the learning stage of the lowest level that the learner did not complete the stage may be automatically selected by the control part 110 or the learner may directly select one of the learning stages of the learning contents database 120 by the input part 22.

After that, the learning stage selection module 130 displays the selected title or the table of learning contents and summarized contents, which the learner wants to learn, on a first screen, so that the learner can see them. For instance, when the ‘passive’ learning stage is selected by the learning stage selection module 130, the contents of “passive voice, meaning and forms of passive voice, passive tenses, and sentence structures in passive voice” may be displayed on the first screen of the display part 21.

The level of the learning stage currently selected may be displayed on the display part 21. The level may be displayed in basic, intermediate and advanced levels or the equivalents classified by categories according to levels of learning difficulty. Numbers to indicate detailed stages by each stage may be followed to the corresponding learning level. For instance, in case of ‘Passive voice’ corresponding to the eighth stage of the advanced level, it may be displayed in the form of ‘Advanced 8’.

Moreover, if necessary, ‘Passive voice’ in English and in the learner's native language may be displayed together on the first screen. As described above, through the leveled learning stages and the numbers corresponding to the detailed stages which are displayed on the screen, the learner can easily grasp the level of the corresponding learning stage.

The learning contents display module 140, which is located inside the learning operating server 10, actuates the learning stage selection module 130 and displays the detailed learning contents to be learned in the selected learning stage on a second screen of the display part 21, so that the learner can effectively learn the contents of the corresponding learning stage through the displayed learning contents.

The learning contents display module 140 includes a learning goal display part 141, a sub-table of contents display part 142, and an example sentence display part 143.

The learning goal display part 141 displays the table of contents in the stage selected by the learning stage selection module 130 and a learning goal on the second screen of the display part 21. The sub-table of contents display part 142 divides the learning contents of the selected stage into a plurality of sub-tables of contents and displays them on the second screen of the display part 21, so that the learner can easily grasp the contents to be learned.

The example sentence display part 143, which is a part that the learner can actually progress learning, provides the second screen of the display part 21 with a plurality of the example sentences having the contents related with the sub-table of contents provided by the sub-table of contents display part 142, so that the learner can learn the contents corresponding to the sub-table of contents through the example sentences. In this instance, separate descriptions are written for the example sentences in Korean to guide the learner.

In this instance, the contents displayed by the example sentence display part 143 are classified into corresponding parts according to parts of speech or various learning purposes of the corresponding learning contents, and are displayed in their own colors, so as to enhance the learner's concentration and learning effects.

For example, when the “Passive” is selected as a learning stage, “(Active) I made a cake. [symbol] [symbol] and “(Passive) A cake was made by me. [symbol] [symbol] [symbol] are displayed together so that the learner can progress his or her learning. In this instance, it is possible to underline each word to enhance discrimination, and parts of speech, such as a subject, a verb, and an object, or grammar forms, such as verb ‘be’, P.P., and by+object, of the corresponding words are written below the underlined words to help the learner's understanding.

The utilization history providing module 150 is located in the user terminal 20. When the learner terminates the executive program or application after finishing his or her learning, the utilization history providing module 150 sends the learned contents and the utility history of the learning stage to the learning operating server 10 through the communication network, and the user database 12 updates and stores the corresponding contents and enables the learner to utilize the updated contents when he or she logs in.

In the meantime, the sentence build-up English learning system 100 may further include a learning stage progress display module 160. The learning stage progress display module 160 includes a learning stage progress display part of a multi-layer structure so that the learner can easily recognize the learning progress at a glance, and serves to display the progress status of the current learning stage on a part of the first or second screen of the display part 21 or on a separate window.

In this instance, the learning stage progress display module 160 displays the learning stages by finished stages, learning stages in progress, and stages before learning in their own colors, so that the learner can easily recognize his or her current learning progress. For instance, the finished stages are displayed in blue, the learning stages in progress are displayed in red, and the stages before learning are displayed in green.

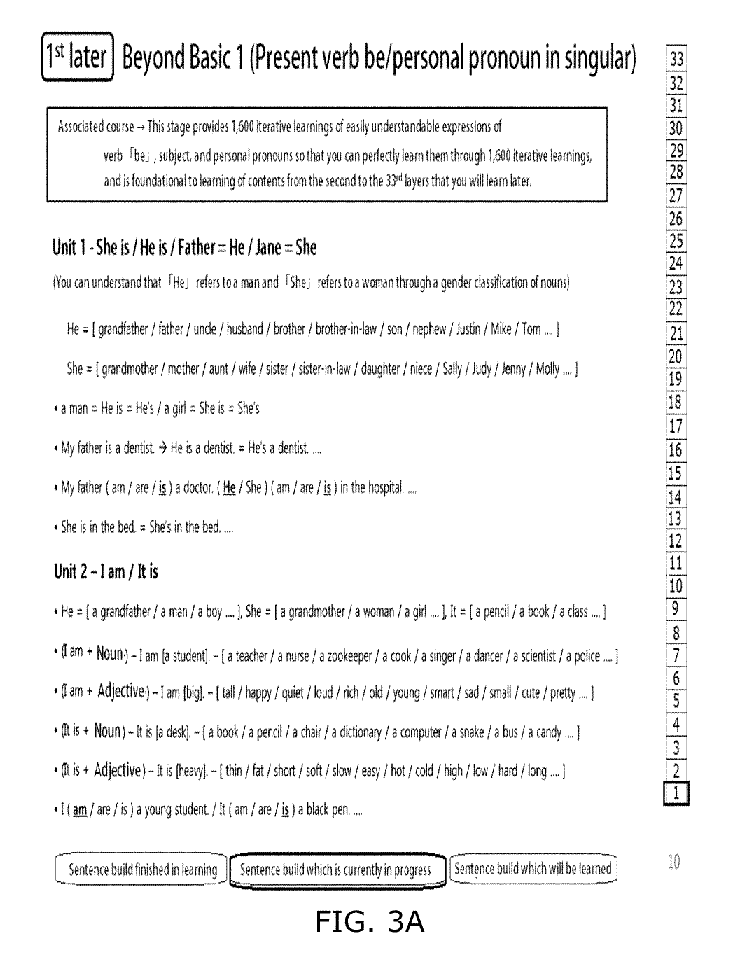

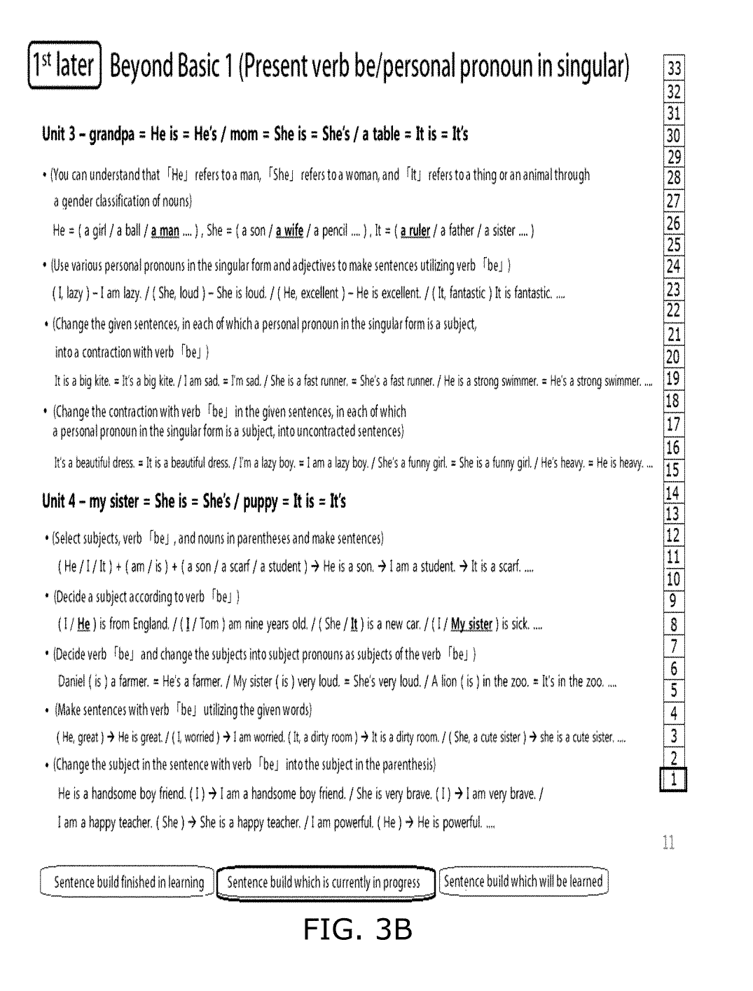

FIGS. 3A and 3B illustrate a state where the learner first starts English learning after logging on to the user database 12 of the learning operating server 10 using the user terminal 20. In this instance, the control part 110 recognizes that the learner first starts learning from information of the user database 12, and makes the learning stage selection module 130 select the first stage, “Verb ‘be’ present tense/personal pronouns in the singular form”, out of the learning stages stored in the learning contents database 120. After that, the learning contents display module 140 reads the learning contents corresponding to the first stage from the learning contents database 120, and displays the corresponding learning contents on the second screen of the display part 21 so that the learner can progress his or her learning.

In this instance, “Verb ‘be’ present tense/personal pronouns in the singular form” which is the learning contents of the first stage is displayed at the top of the second screen, and “Basic 1” which expresses the level of the learning stage in word and number is further displayed next to the “Verb ‘be’ present tense/personal pronouns in the singular form”. Here, “Basic 1” means the first stage of the basic learning level.

Furthermore, below the table of contents of the second screen, the learning goal display part 141 of the learning contents display module 140 displays a sentence, “Associated course →This stage provides 1,600 iterative learnings of easily understandable expressions of verb ‘be’, subject, and personal pronouns so that you can perfectly learn them, and is foundational to learning of contents from the second to the 33^{rd} layers that you will learn later”, as a learning goal of the first stage.

Additionally, below the learning goal, the sub-table of contents display part 142 displays “Unit 1—She is/He is/Father=He/Jane=She”, “Unit 2—I am/It is”, “Unit 3—grandpa=He is=He's/mom=She is=She's/a table=It is=It's”, and “Unit 4—my sister=She is=She's/puppy=It is=It's” at predetermined intervals in a vertical direction.

In addition, the example sentence display part 143 displays at least one example sentence with the contents corresponding to a sub-table of contents below the sub-table of contents. For instance, if the sub-table of contents is “Unit 1—She is/He is/Father=He/Jane=She”, “(You can understand that ‘He’ refers to a man and ‘She’ refers to a woman through a gender classification of nouns), He=[grandfather/father/uncle/husband/brother/brother-in-law/son/nephew/Justin/Mike/Tom. . .” may be displayed.

Here, words associated to the learning subject in the first layer are displayed in red to enhance discrimination and concentration. Moreover, high priority words may be underlined or displayed in bold so that the learner can recognize that the corresponding words are very important. Furthermore, explanation of the example sentence is displayed in black, and parts which are not associated with or are distant from the learning subject in the first layer may be displayed in a color different from red and black (in this embodiment, green) so that the learner can easily recognize the corresponding contents.

Additionally, the learning stage progress display part of the multi-layer structure is displayed at the right side of the second screen. In this instance, the learning stage progress display module displays columns corresponding to the first stage in red on the learning stage progress display part to show that the learner is currently learning the contents of the columns and displays columns corresponding to the 2^{nd} to 33^{rd} stages in green on the learning stage progress display part to show that the contents of the columns will be learned in the future.

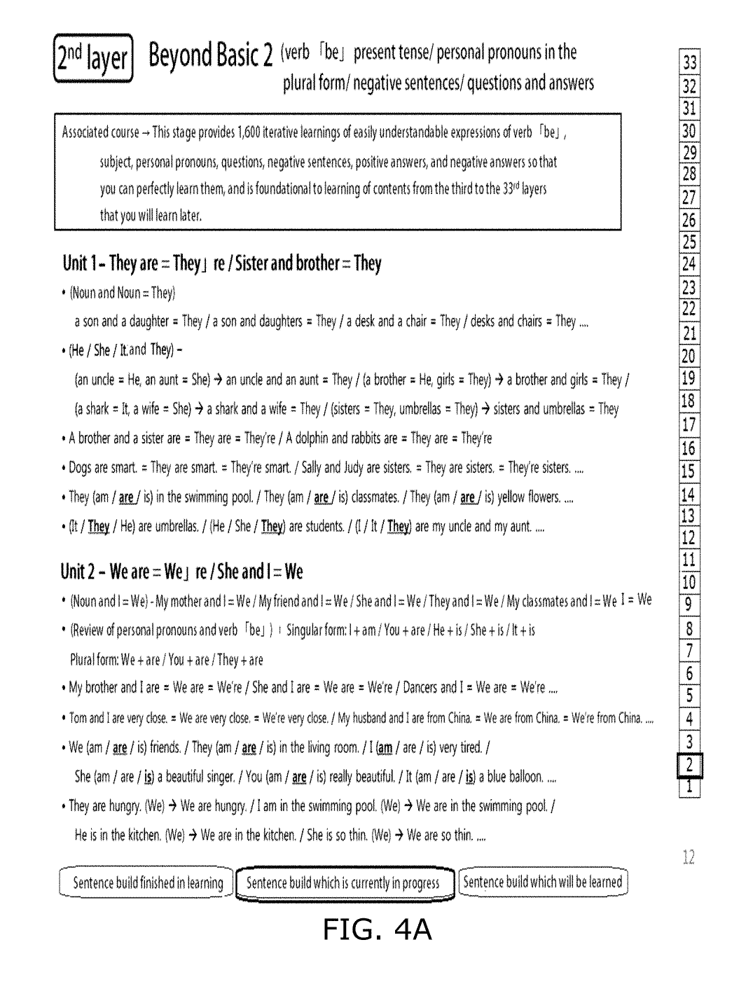

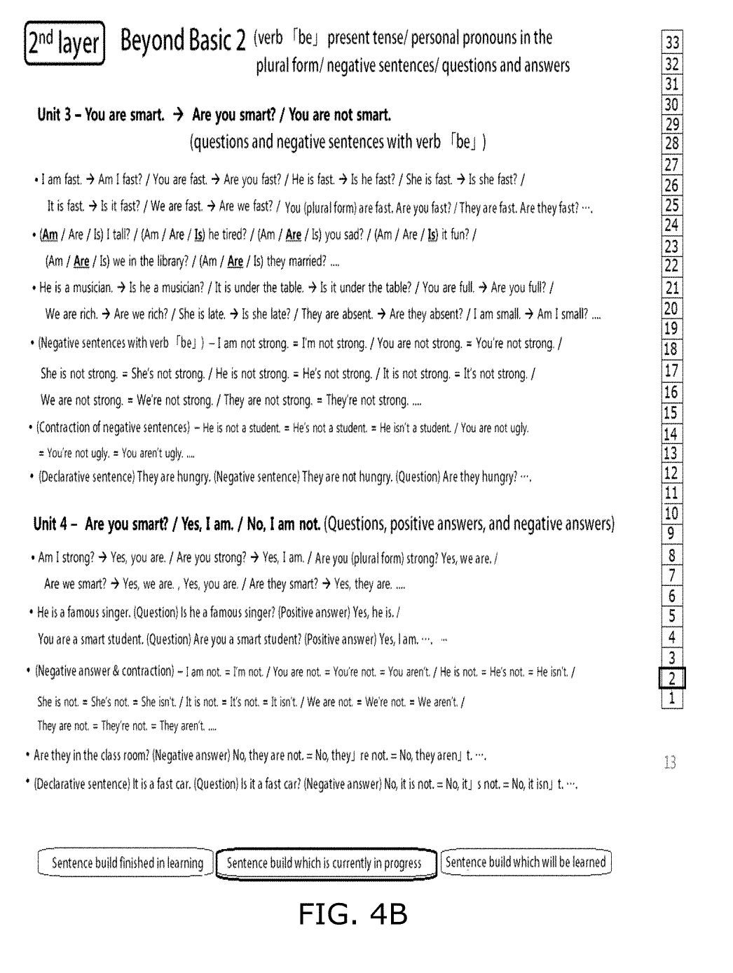

As another embodiment of the present invention, FIGS. 4A and 4B illustrate a state where the learner logs on to the user database 12 of the learning operating server 10 using the user terminal 20 to progress learning in the second stage after finishing learning of the first stage. In this instance, the control part 110 recognizes that the learner has to learn the second stage from information of the user database 12, and makes the learning stage selection module 130 select the second stage, “Verb ‘be’ present tense/personal pronouns in the plural form/negative sentences/questions and answers”, out of the learning stages stored in the learning contents database 120. After that, the learning contents display module 140 reads the learning contents corresponding to the second stage from the learning contents database 120, and displays the corresponding learning contents on the second screen of the display part 21 so that the learner can progress his or her learning.

In this instance, “Verb ‘be’ present tense/personal pronouns in the plural form/negative sentences/questions and answers” which is the learning contents of the second stage is displayed at the top of the second screen, and “Basic 2” which expresses the level of the learning stage in word and number is further displayed next to the “Verb ‘be’ present tense/personal pronouns in the plural form/negative sentences/questions and answers”. Here, “Basic 2” means the second stage of the basic learning level.

Furthermore, below the table of contents of the second screen, the learning goal display part 141 of the learning contents display module 140 displays a sentence, “Associated course →This stage provides 1,600 iterative learnings of easily understandable expressions of verb ‘be’, subject, personal pronouns, questions, negative sentences, positive answers, and negative answers so that you can perfectly learn them, and is foundational to learning of contents from the third to the 33^{rd} layers that you will learn later”, as a learning goal of the second stage.

Additionally, below the learning goal, the sub-table of contents display part 142 displays “Unit 1—They are=They're/Sister and brother=They”, “Unit 2—We are=We're/She and I=We”, “Unit 3—You are smart. —>Are you smart?/You are not smart”, and “Unit 4—Are you smart?/Yes, I am./No, I am not” at predetermined intervals in a vertical direction.

In addition, the example sentence display part 143 displays at least one example sentence with the contents corresponding to a sub-table of contents below the sub-table of contents. For instance, if the sub-table of contents is “Unit 1—They are=They're/Sister and brother=They”, “(noun and noun=They)—a son and a daughter=They/a son and daughters=They/a desk and a chair=They/desks and chairs=They. . .” may be displayed. In this instance, because the learner finished learning of “present tense verb ‘be’/singular form/personal pronouns” in the first stage, the learner can smoothly learn “Verb ‘be’ present tense/personal pronouns in the plural form/negative sentences/questions and answers”.

Moreover, the learning stage progress display part of the multi-layer structure is displayed at the right side of the second screen. In this instance, the learning stage progress display module displays the columns corresponding to the first stage in blue on the learning stage progress display part to show that the learner finished learning of the columns, displays columns corresponding to the second stage in red on the learning stage progress display part to show that the learner is currently learning the contents of the columns, and displays columns corresponding to the 3^{rd} to 33^{rd} stages in green on the learning stage progress display part to show that the contents of the columns will be learned in the future.

Here, words associated to the learning subject in the second layer are displayed in red to enhance discrimination and concentration. Moreover, high priority words may be underlined or displayed in bold so that the learner can recognize that the corresponding words are very important. Furthermore, explanation of the example sentence is displayed in black, and parts which are not associated with or are distant from the learning subject in the second layer may be displayed in a color different from red and black (in this embodiment, green) so that the learner can easily recognize the corresponding contents.

Because verb ‘be’ is foundational to all sentences necessary for obtaining English skills, it is learned in the first and second layers which are the beginning stages, and is continuously used in learning of the building structure that the learner will learn later.

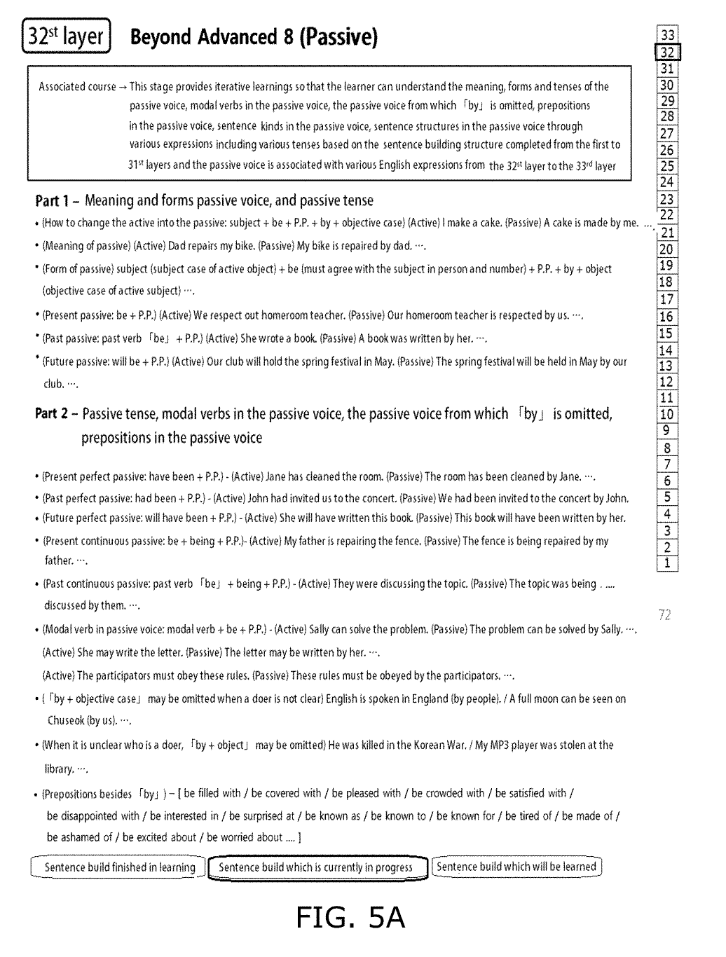

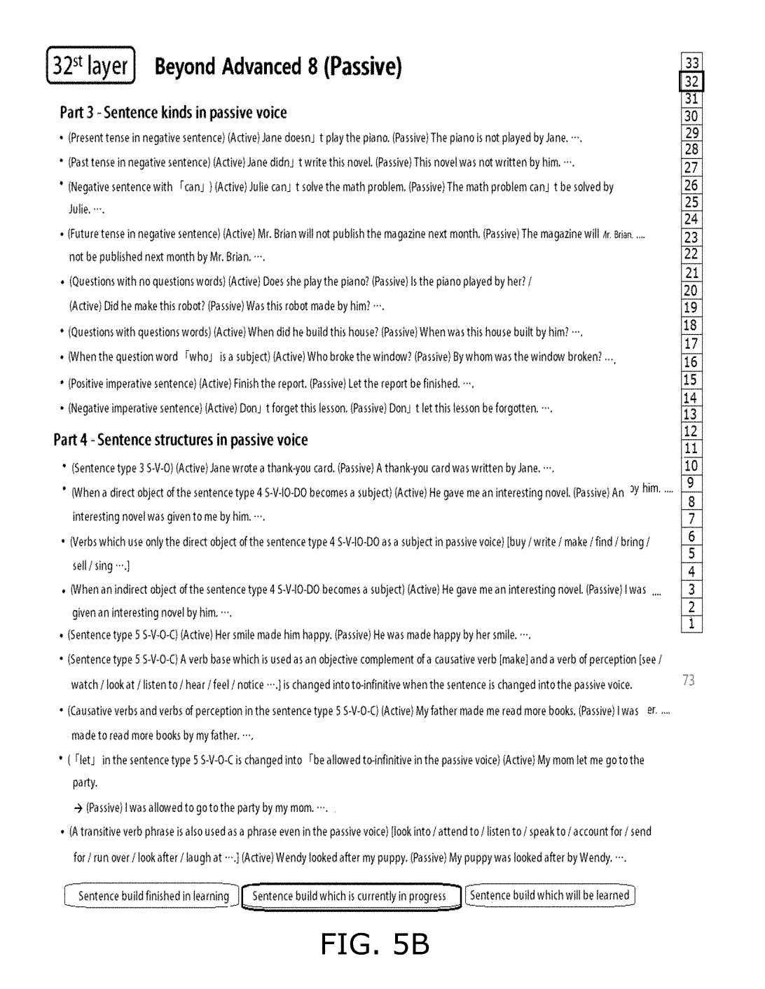

As a further embodiment of the present invention, FIGS. 5A and 5B illustrate a state where the learner logs on to the user database 12 of the learning operating server 10 using the user terminal 20 to progress learning in the 32^{nd} stage after finishing learning of the 1^{st} to 31^{st} stages.

In this instance, the control part 110 recognizes that the learner has to learn the 32^{nd} stage from information of the user database 12, and makes the learning stage selection module 130 select the 32^{nd} stage, “Passive voice”, out of the learning stages stored in the learning contents database 120. After that, the learning contents display module 140 reads the learning contents corresponding to the 32^{nd} stage from the learning contents database 120, and displays the corresponding learning contents on the second screen of the display part 21 so that the learner can progress his or her learning.

In this instance, “Passive voice” which is the learning contents of the 32^{nd} stage is displayed at the top of the second screen, and “Advanced 8” which expresses the level of the learning stage in word and number is further displayed next to the “Passive voice”. Here, “Advanced 8” means the eighth stage of the advanced learning level.

Furthermore, below the table of contents of the second screen, the learning goal display part 141 of the learning contents display module 140 displays a sentence, “Associated course →This stage provides iterative learnings so that the learner can understand the meaning, forms and tenses of the passive voice, modal verbs in the passive voice, the passive voice from which ‘by’ is omitted, prepositions in the passive voice, sentence kinds in the passive voice, sentence structures in the passive voice through various expressions including various tenses based on the sentence building structure completed from the first to 31^{st} layers and the passive voice is associated with various English expressions from the 32^{st} layer to the 33^{rd} layer”, as a learning goal of the second stage.

Additionally, below the learning goal, the sub-table of contents display part 142 displays “Part 1—Meaning, forms and tenses of the passive voice”, “Part 2—Tenses of the passive voice, modal verbs in the passive voice, the passive voice from which ‘by’ is omitted, prepositions in the passive voice”, “Part 3—Sentence kinds in the passive voice”, and “Part 4—Sentence structures in the passive voice” at predetermined intervals in a vertical direction.

In addition, the example sentence display part 143 displays at least one example sentence with the contents corresponding to a sub-table of contents below the sub-table of contents. For instance, if the sub-table of contents is “Part 1—Meaning, forms and tenses of the passive voice”, “(How to change the active into the passive: subject+be+P.P.+by+object)—(Active) I make a cake→(Passive) A cake is made by me” may be displayed. In this instance, learning of the contents of the 32^{nd} stage can be achieved smoothly because the learner finished learning from the 1^{st} to the 31^{st} stages, which include the contents of sentence structures prerequisite to the passive voice.

Here, words associated to the learning subject in the 32^{nd} layer are displayed in red to enhance discrimination and concentration. Moreover, high priority words may be underlined or displayed in bold so that the learner can recognize that the corresponding words are very important. Furthermore, explanation of the example sentence is displayed in black, and parts which are not associated with or are distant from the learning subject in the 32^{nd} layer may be displayed in a color different from red and black (in this embodiment, green) so that the learner can easily recognize the corresponding contents.

Moreover, the learning stage progress display part of the multi-layer structure is displayed at the right side of the second screen. In this instance, the learning stage progress display module displays the columns corresponding to the 1^{st} to 31^{st} stages in blue on the learning stage progress display part to show that the learner finished learning of the columns, displays columns corresponding to the 32^{nd} stage in red on the learning stage progress display part to show that the learner is currently learning the contents of the columns, and displays columns corresponding to the 33^{rd} stage in green on the learning stage progress display part to show that the contents of the columns will be learned in the future.

Therefore, the sentence build-up English learning system according to the embodiments of the present invention provides a manualized and standardized table of learning contents stored in the learning contents database in such a way that the contents are associated from the first stage to the final stage or higher stages include the contents of lower stages, so that the learner cannot obtain desired effects at the next high stage if the learner did not learn the contents of a lower stage sufficiently and the learner has to progress his or her learning from a lower stage to higher stages in a determined order, thereby guaranteeing the same learning outputs regardless of teachers because the learner systematically learns correct sentence structures of English by elements and stages. Accordingly, the learner can make correct English sentences and have a good command of English.

Hereinafter, how to progress English learning using the sentence build-up English learning system according to the embodiment of the present invention will be described.

The English learning method according to this embodiment of the present invention is a learning method, which enables a learner to express all expressions that he or she can express in his or her native language into English expressions through various expressions based on systematic order and accuracy, and for this, is configured to progress learning from a lower stage to higher stages in determined order.

First, an administrator stores a table of contents made in determined learning order and learning contents previously produced by stages in the learning contents database 120 of the learning operating server 10.

The learner logs on to the user database 12 of the learning operating server 10 using his or her own ID and password through the communication network. When log-in is achieved, the learning operating server 10 shows the learner's identity and the learning progress status till now, and then, moves on to the next learning stage.

In this instance, in the step of logging in, the learning stage progress display part of the multi-layer structure classifies the up-to-date learning stage progress status of the learner into finished stages, learning stages in progress, and stages before learning and displays them on the display part 21 of the user terminal 20 in their own colors, so that the learner can easily recognize his or her current learning progress.

Next, in the step of selecting a learning stage, the learning stage selection module allows the control part 110 to automatically select the learning stage of the lowest level, which the learner did not complete, out of the learning stages stored in the learning contents database 120 of the learning operating server 10 or enables the learner to directly select one of the learning stages in the table of contents using the input part 22.

Furthermore, the learning stage selection module 130 displays the table of learning contents of the selected learning stage and summarized contents, which the learner wants to learn, on the first screen of the display part 21 of the user terminal 20, so that the learner can see them.

Next, after the step of selecting the learning stage, the detailed learning contents associated with the selected learning stage is displayed on the second screen of the display part 21, so that the learner can progress learning of the basic level while getting the learning contents with his or her eyes.

In this instance, in the basic learning level, the contents to be learned are divided into a plurality of sub-table of contents by the sub-table of contents display part 142, and the example sentence display part 143 displays explanation of the sub-table of contents and a plurality of example sentences containing contents related with the sub-table of contents on the second screen of the display part 21.

Next, when the learner terminates learning after finishing the basic learning level, the utility history of the learning level, such as the learning contents that the learner learned after logging on to the user database 12 of the learning operating server 10 and the learning progress, is updated and stored.

In the meantime, according to the present invention, the table of learning contents stored in the learning contents database 120 is configured to have contents associated from the 1^{st} stage to the final stage and to progress learning from a lower stage to higher stages in determined order so as to enhance learning effects and English skills.

Hereinafter, an electronic teaching method using the sentence build-up English learning system according to the embodiment of the present invention will be described.

When the learner progresses learning in the corresponding layer after user authentication through the learner's log-in, the control part reads the contents corresponding to the corresponding layer from an electronically standardized learning manual stored in the learning operating server and displays the read contents on a part of the screen of the display part or a separate window.

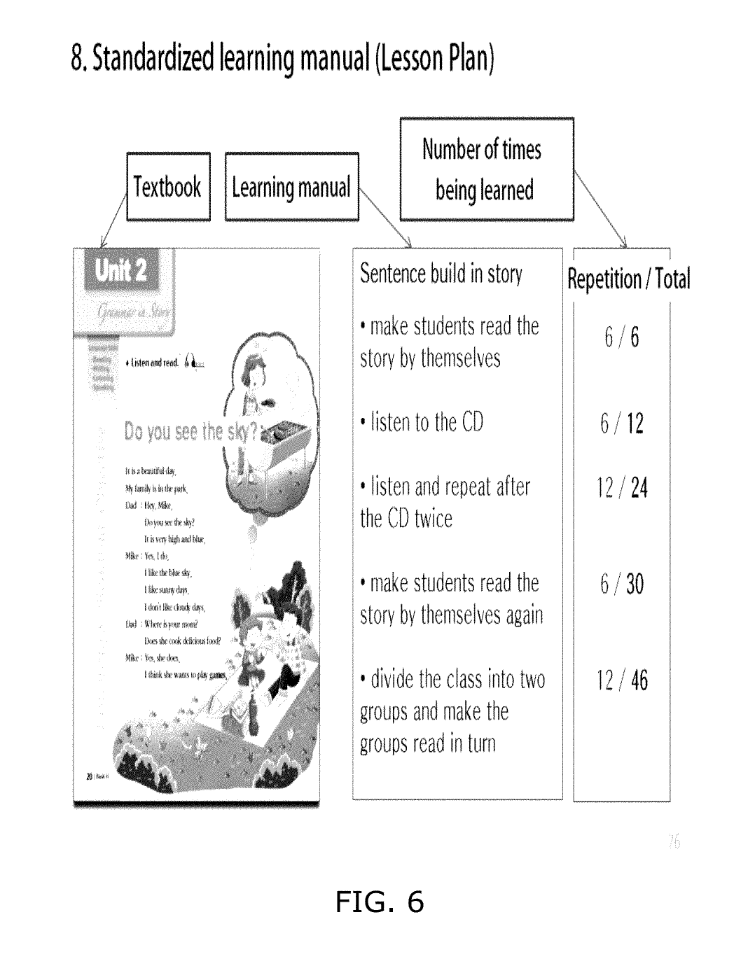

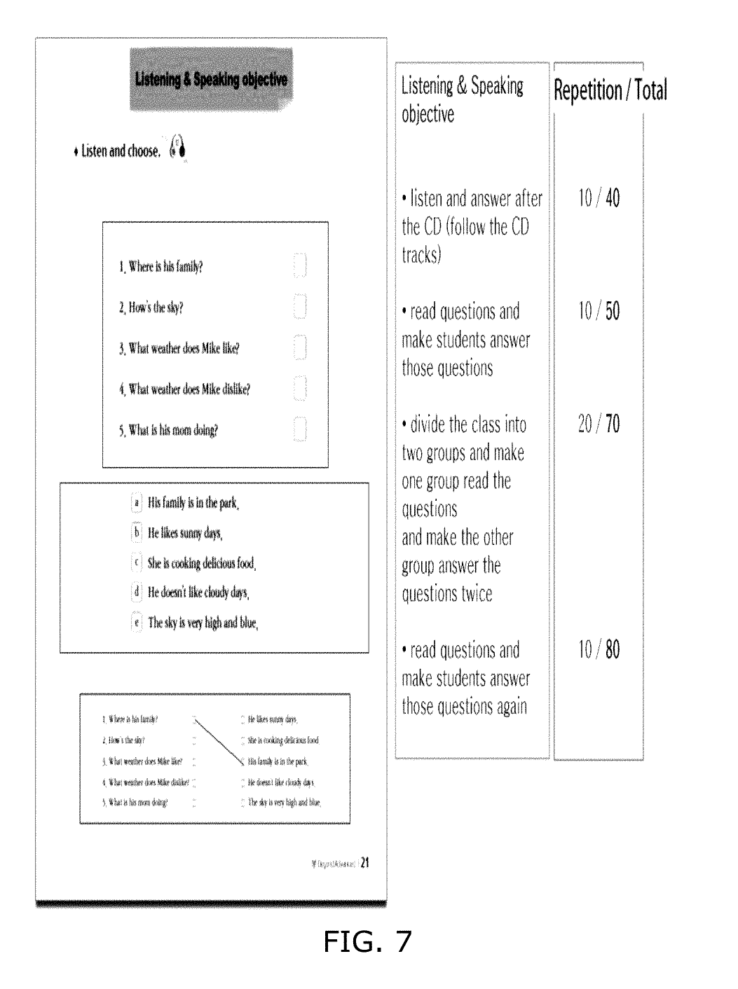

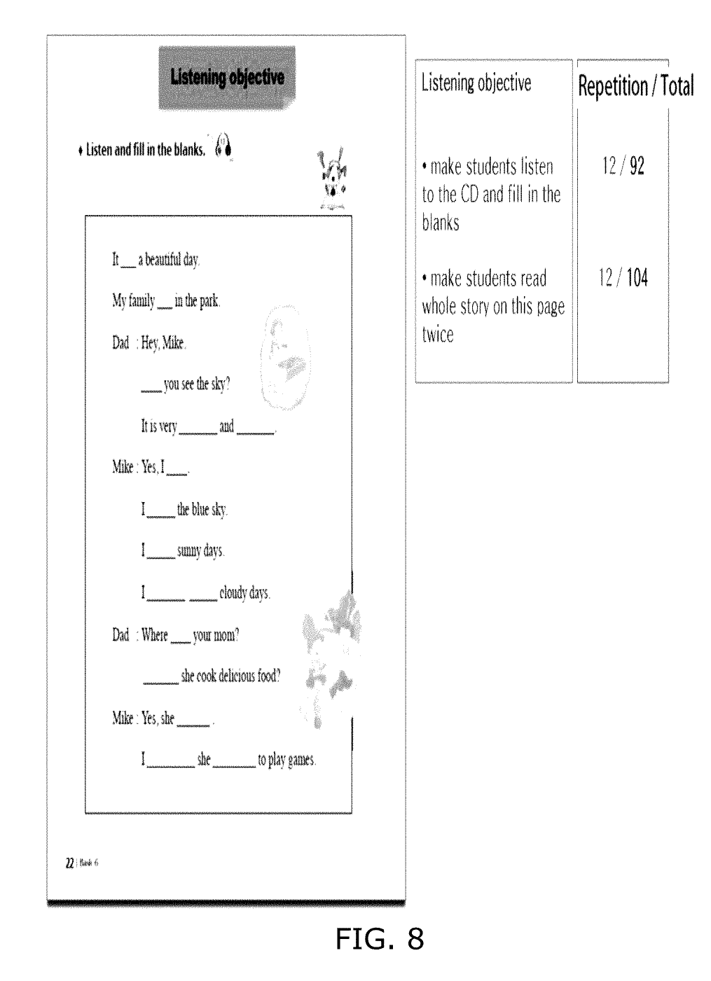

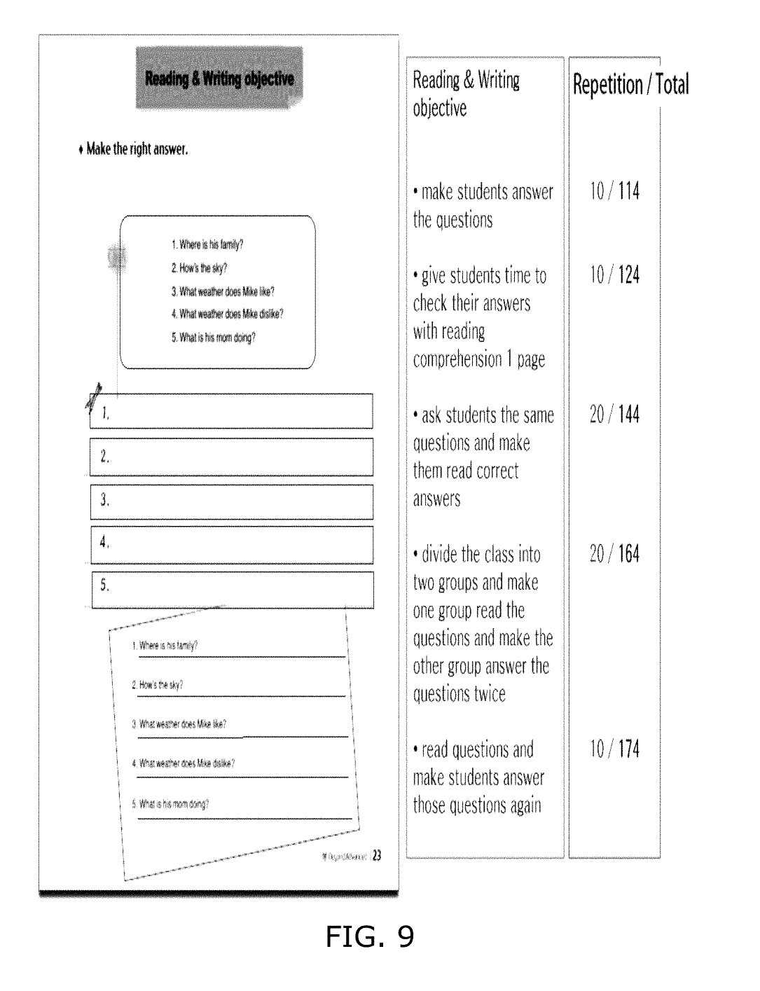

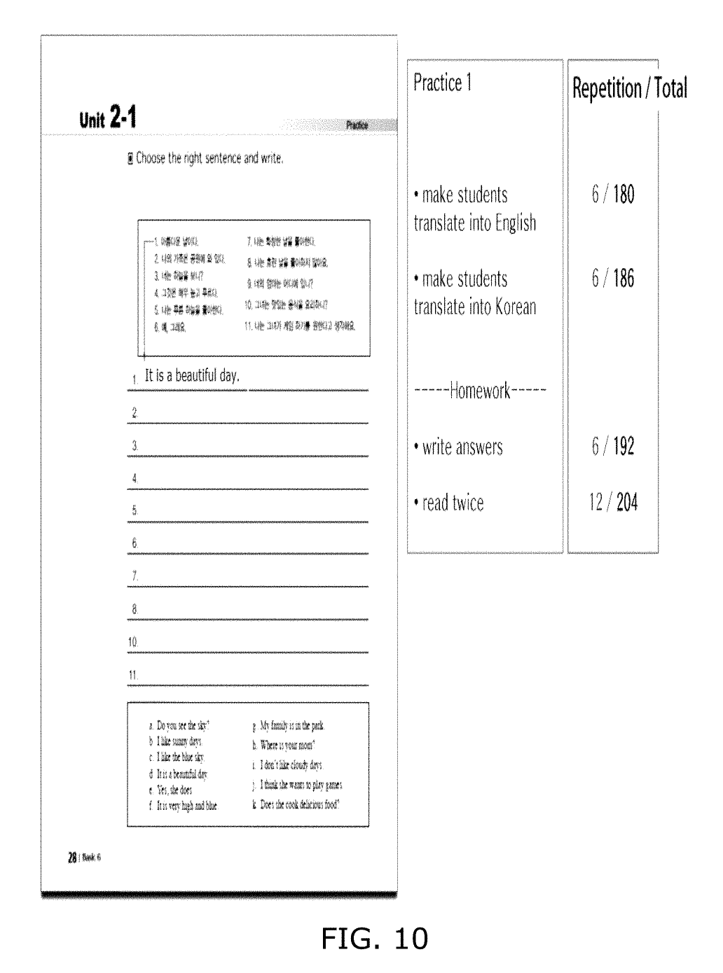

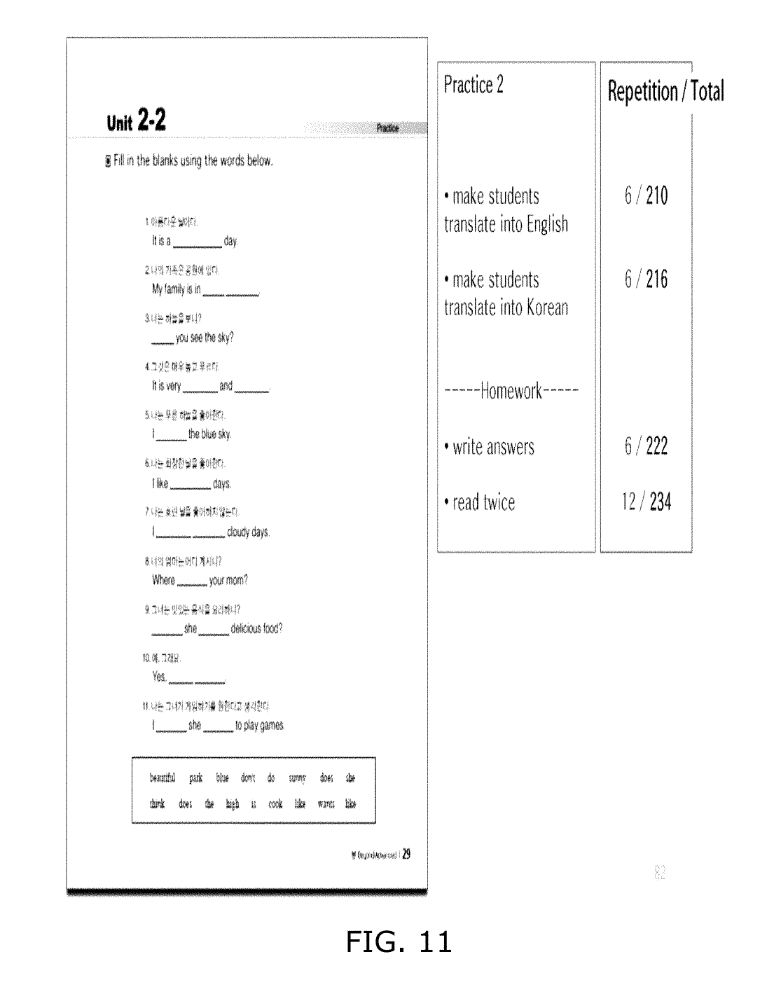

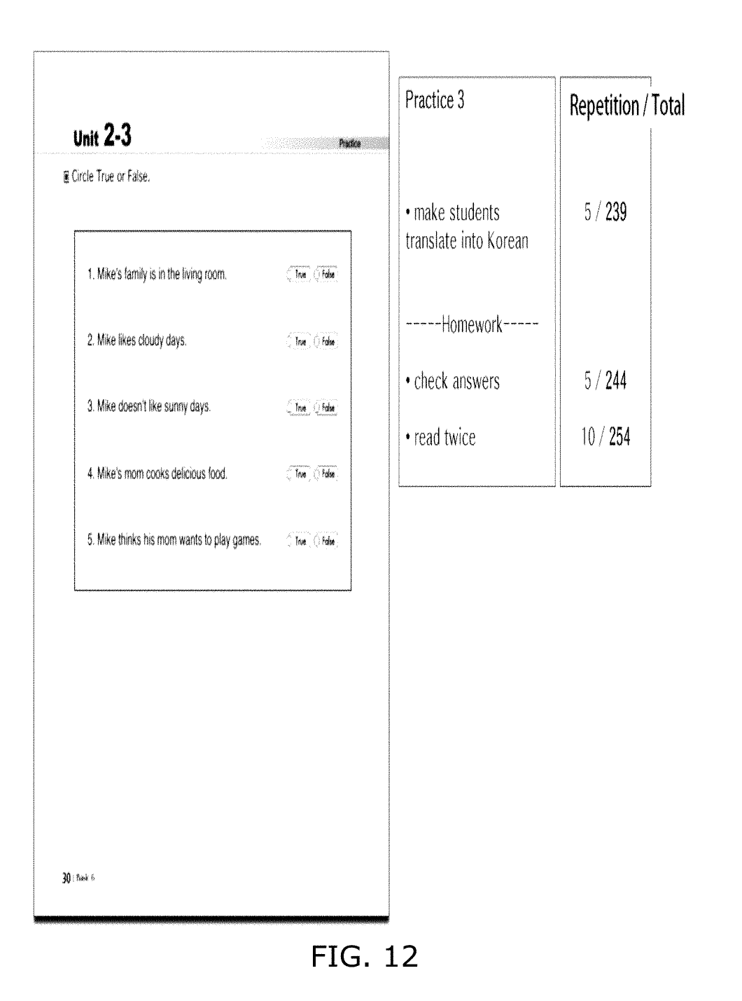

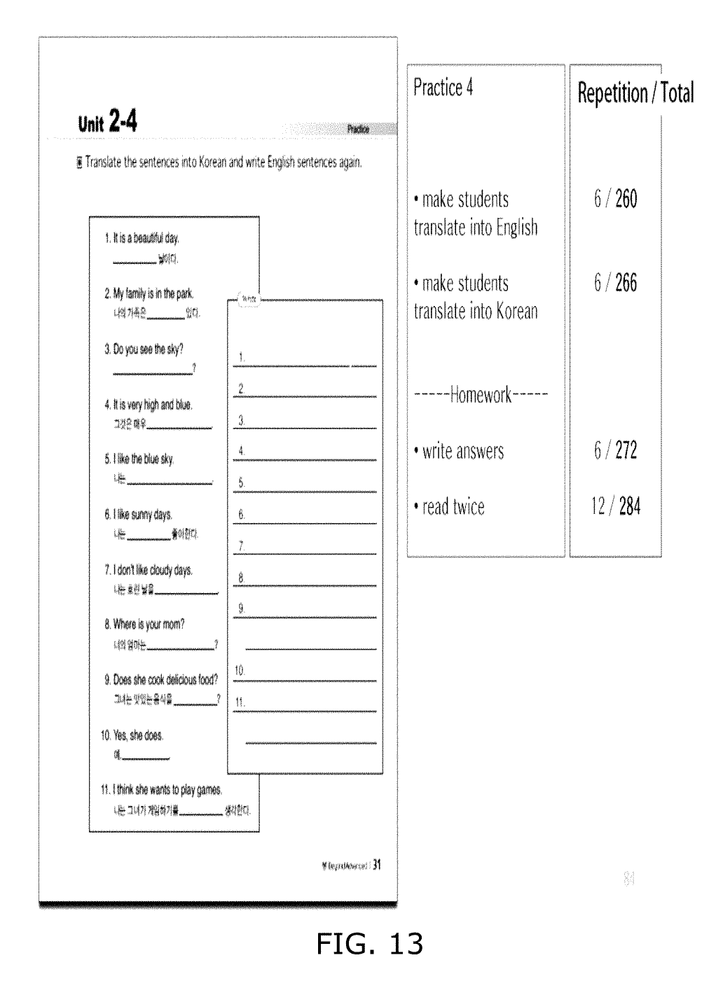

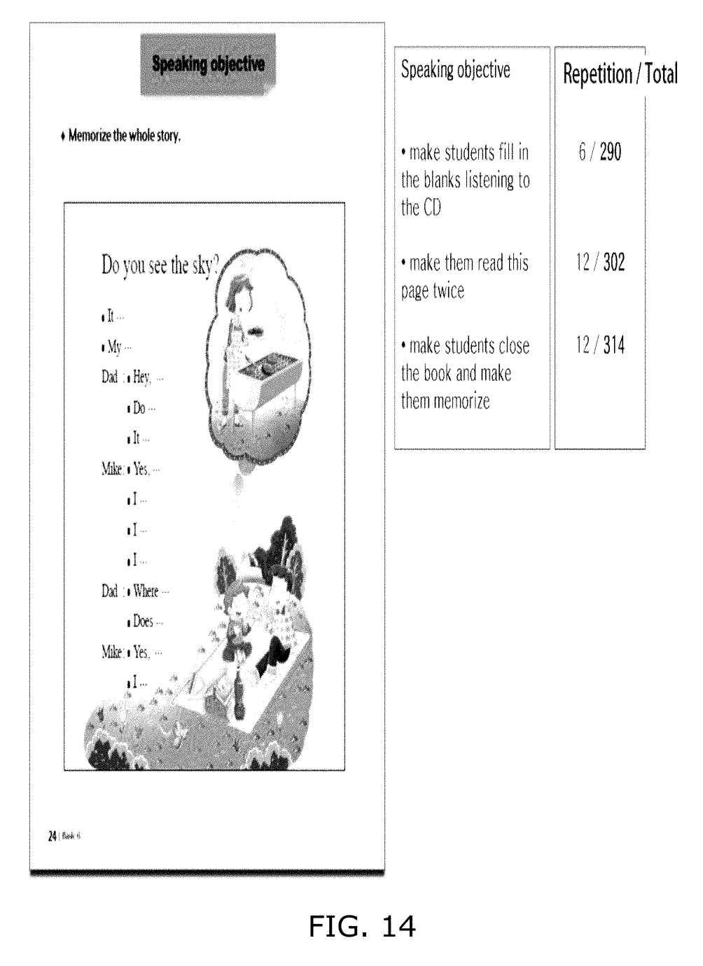

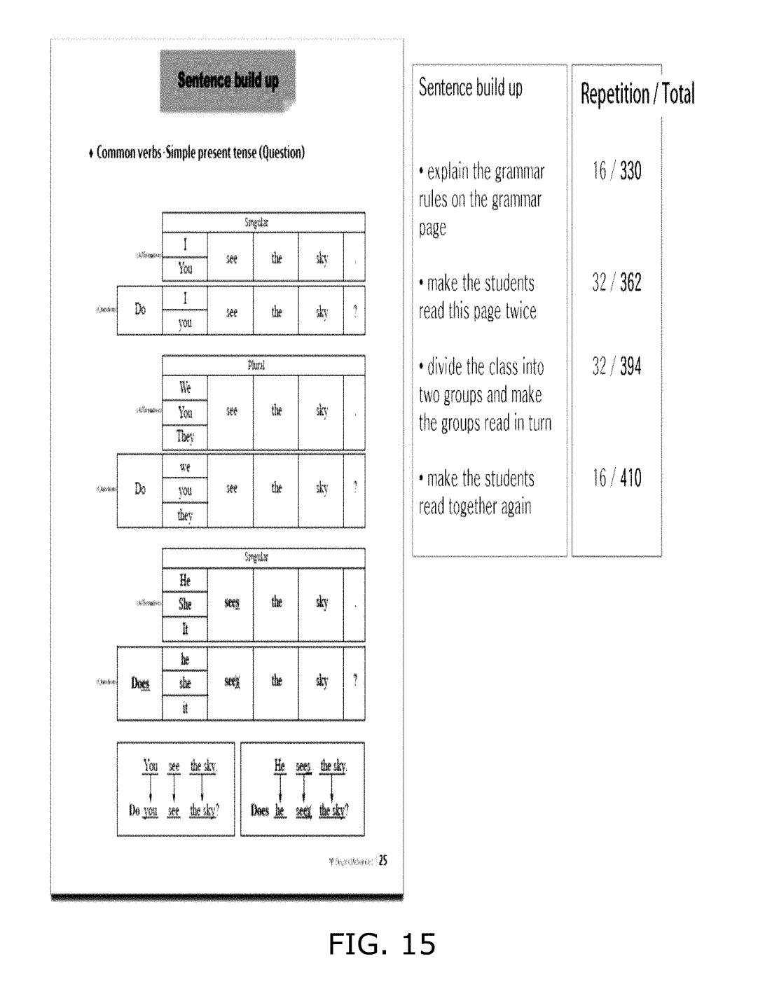

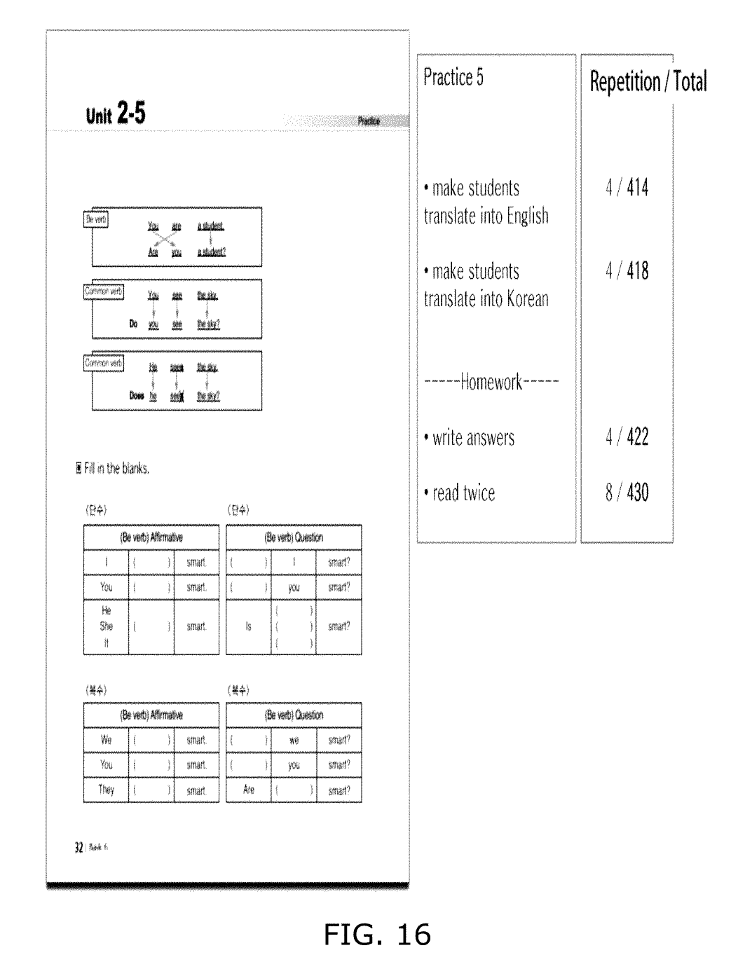

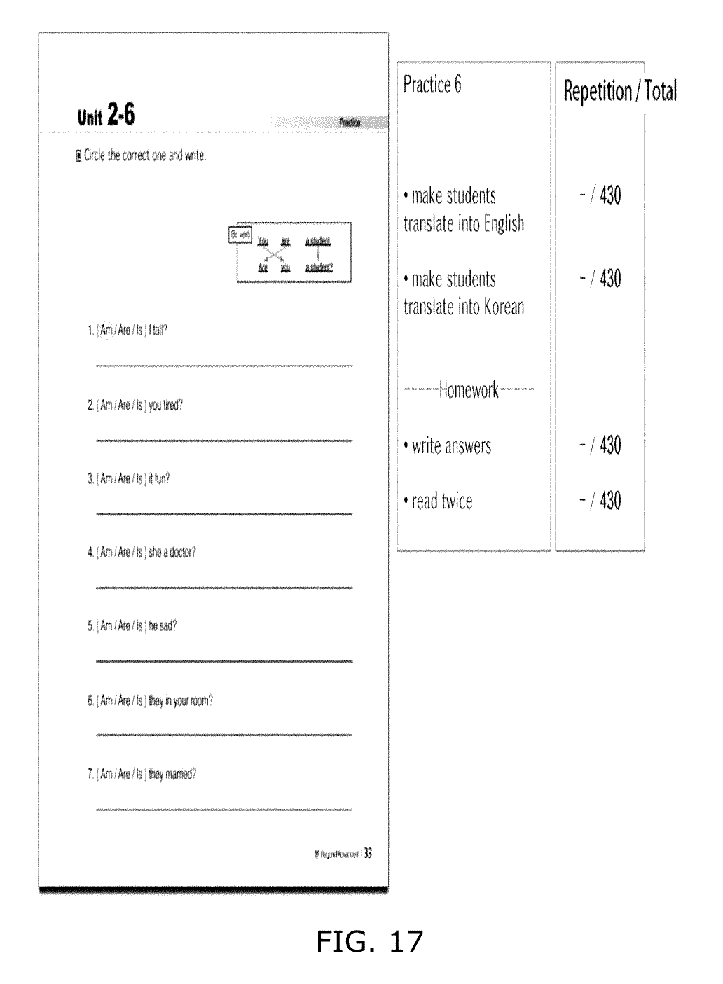

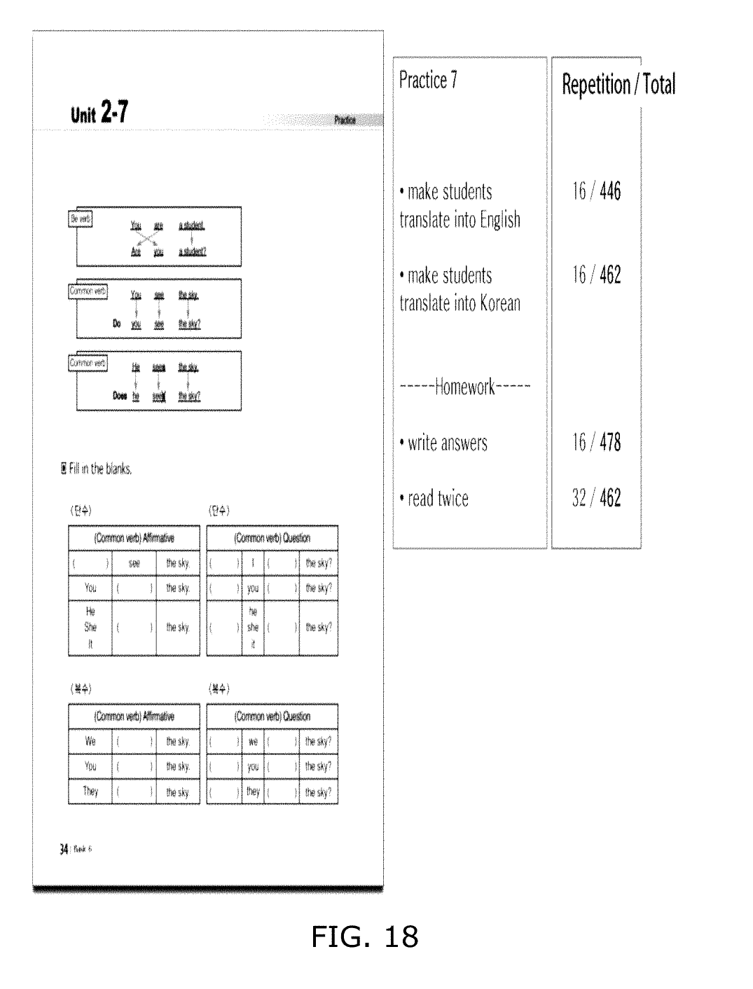

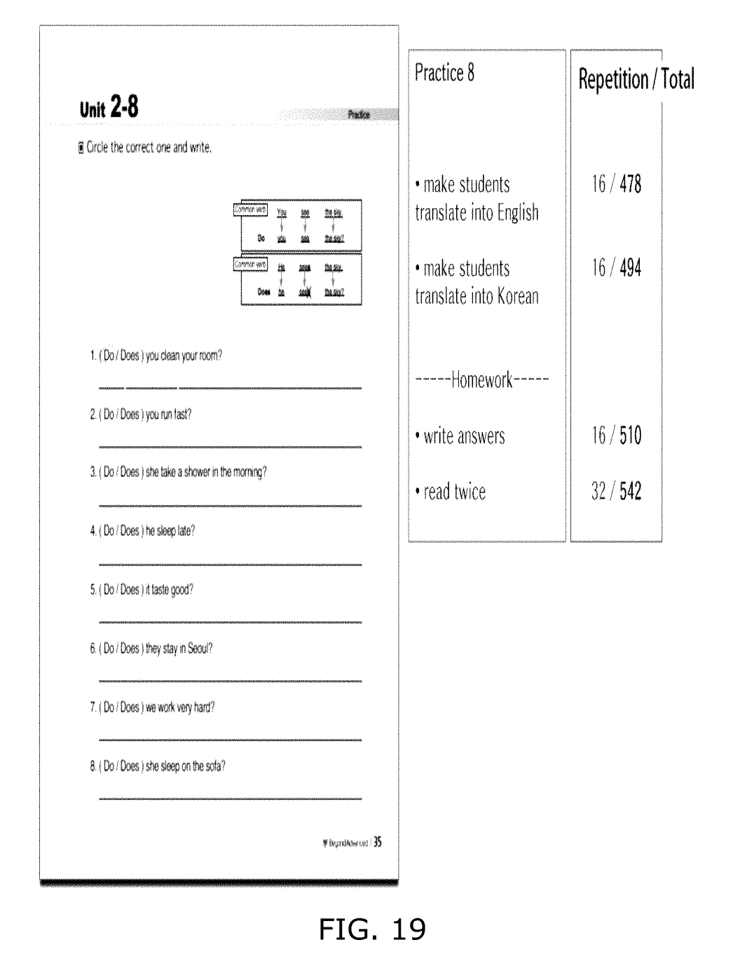

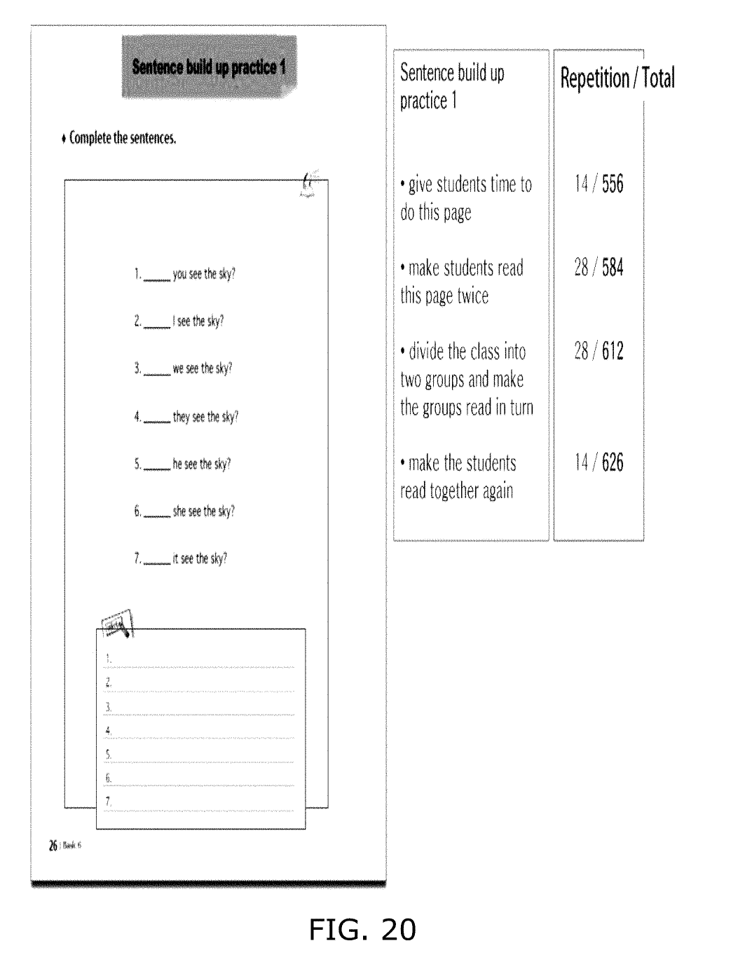

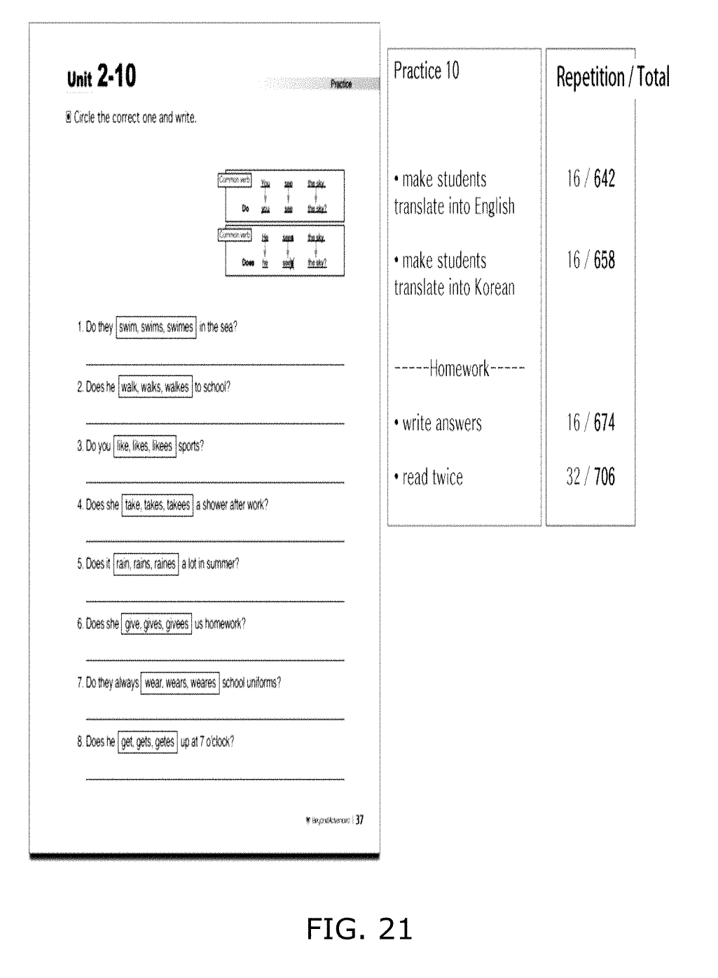

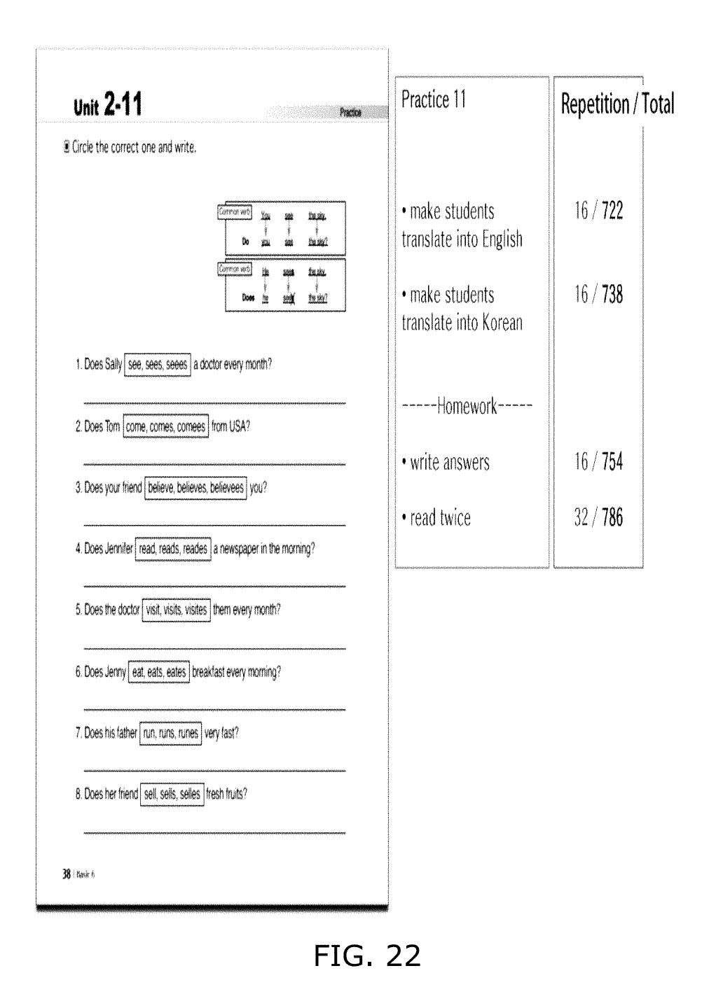

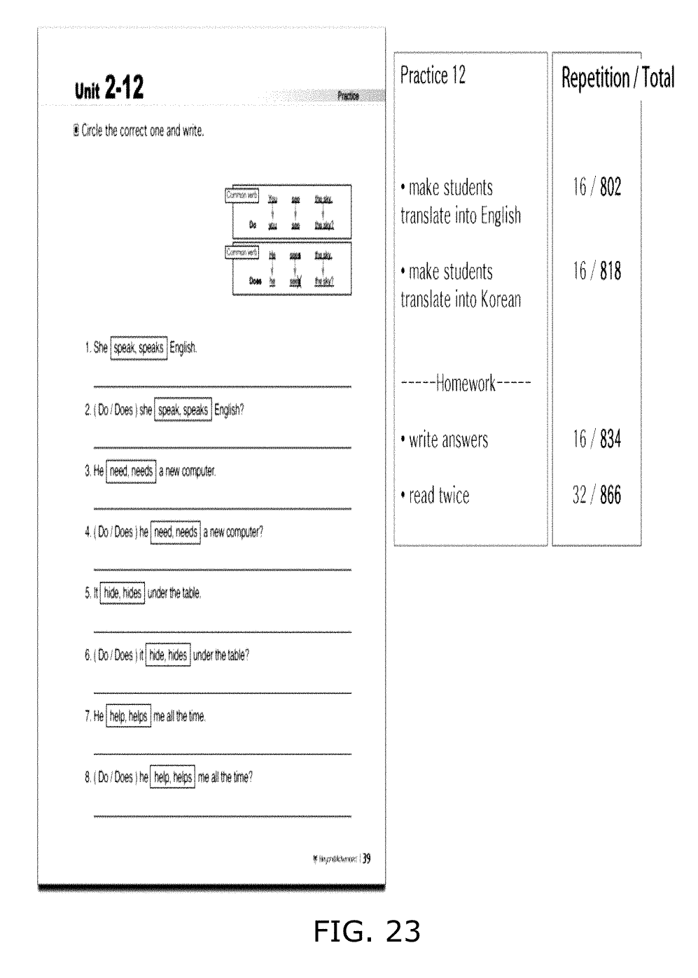

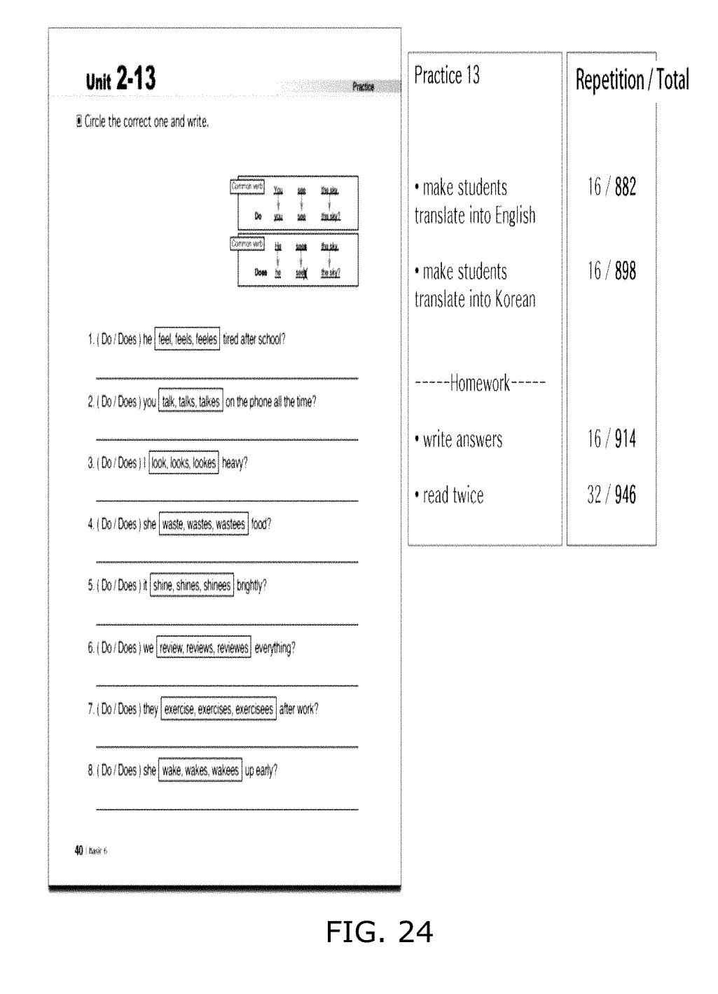

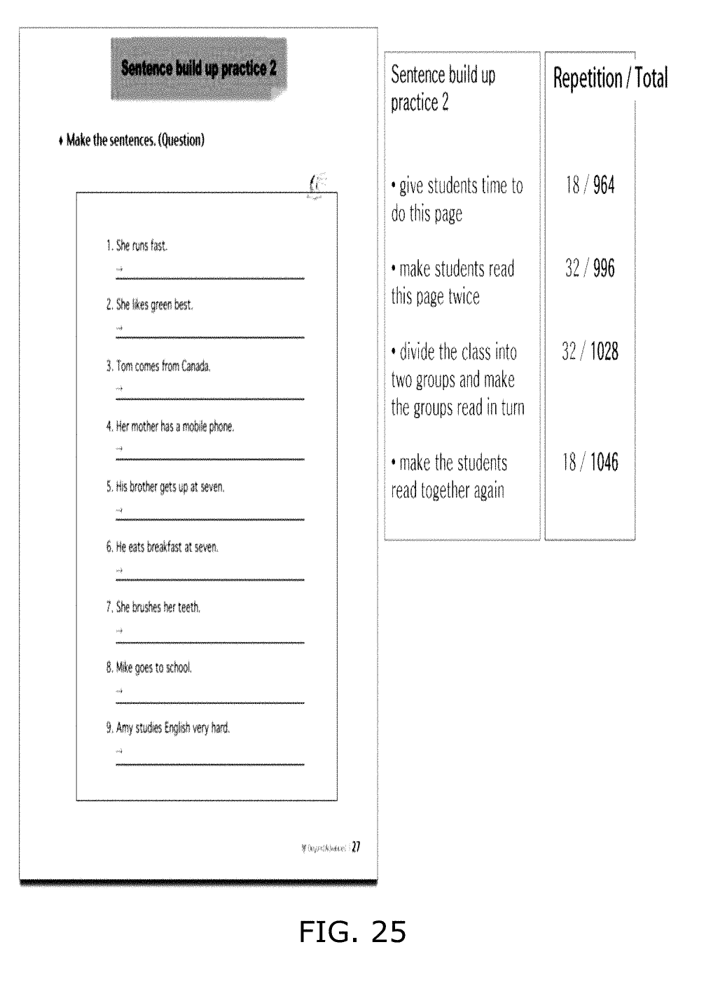

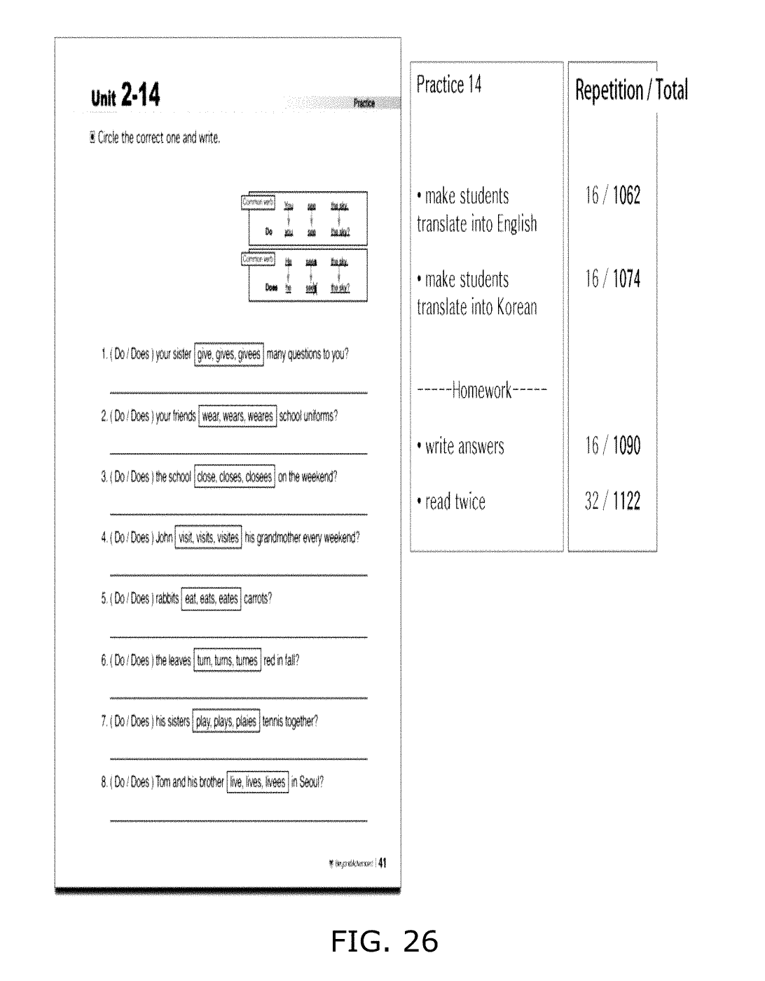

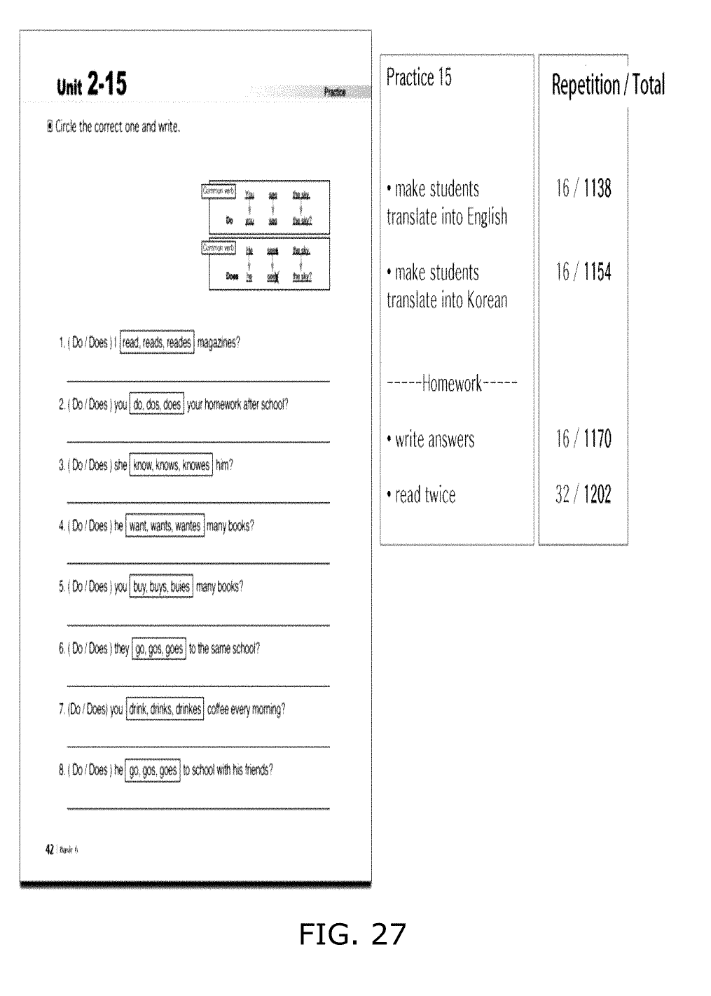

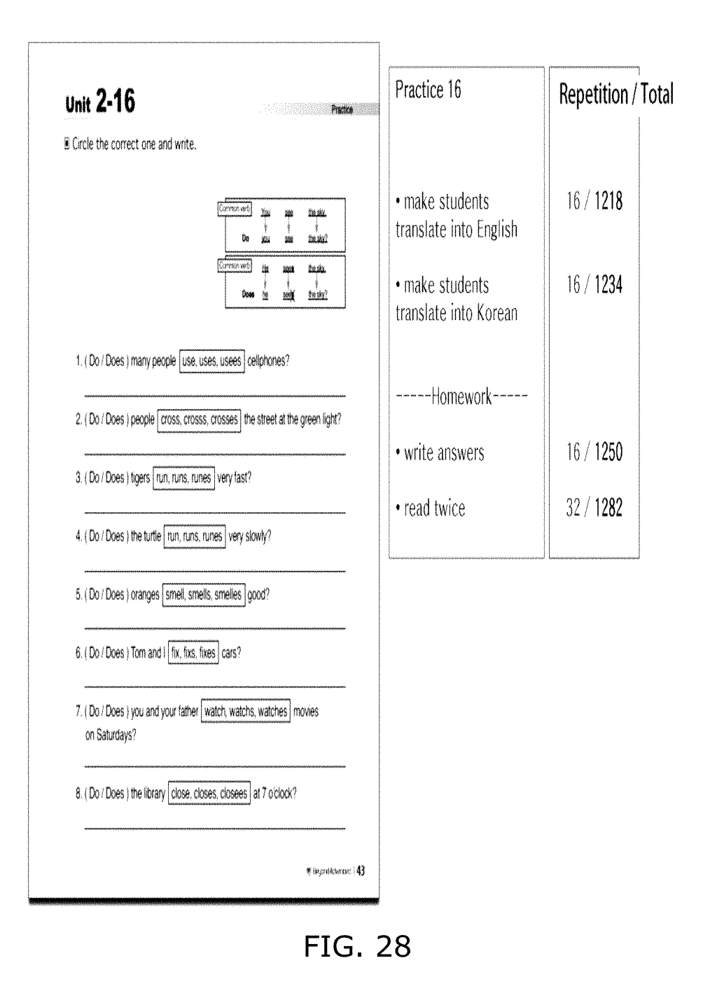

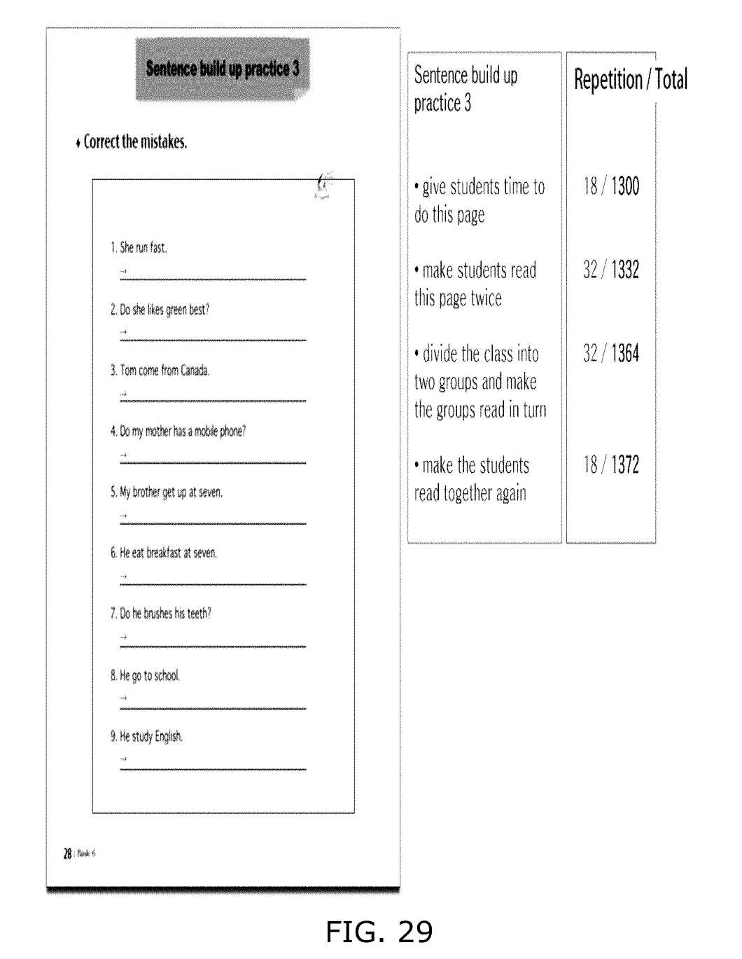

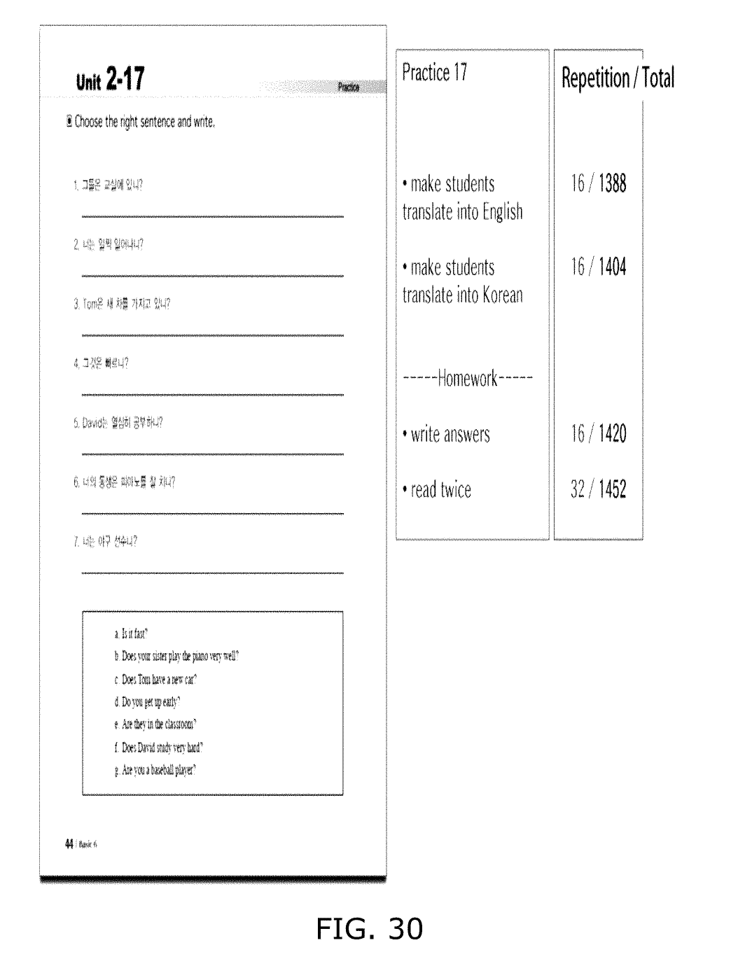

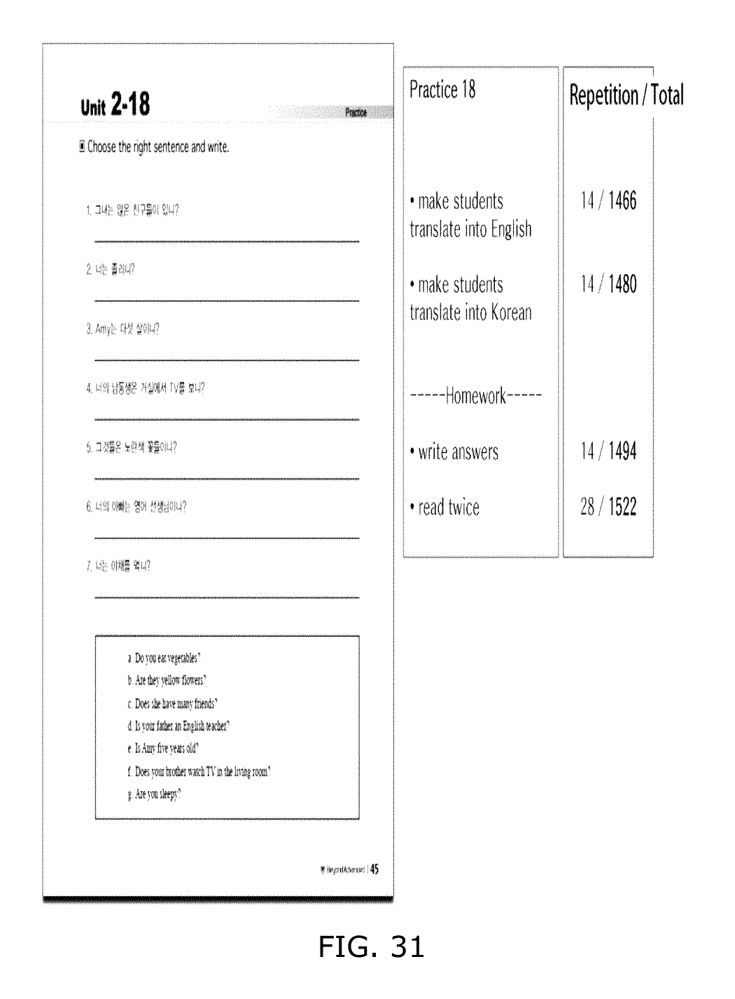

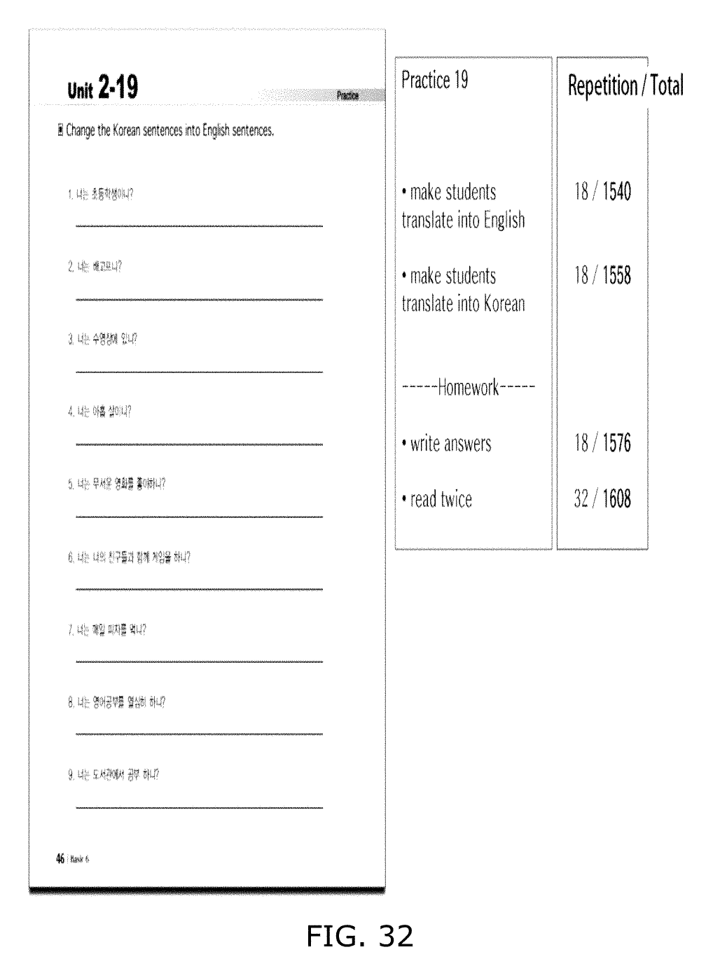

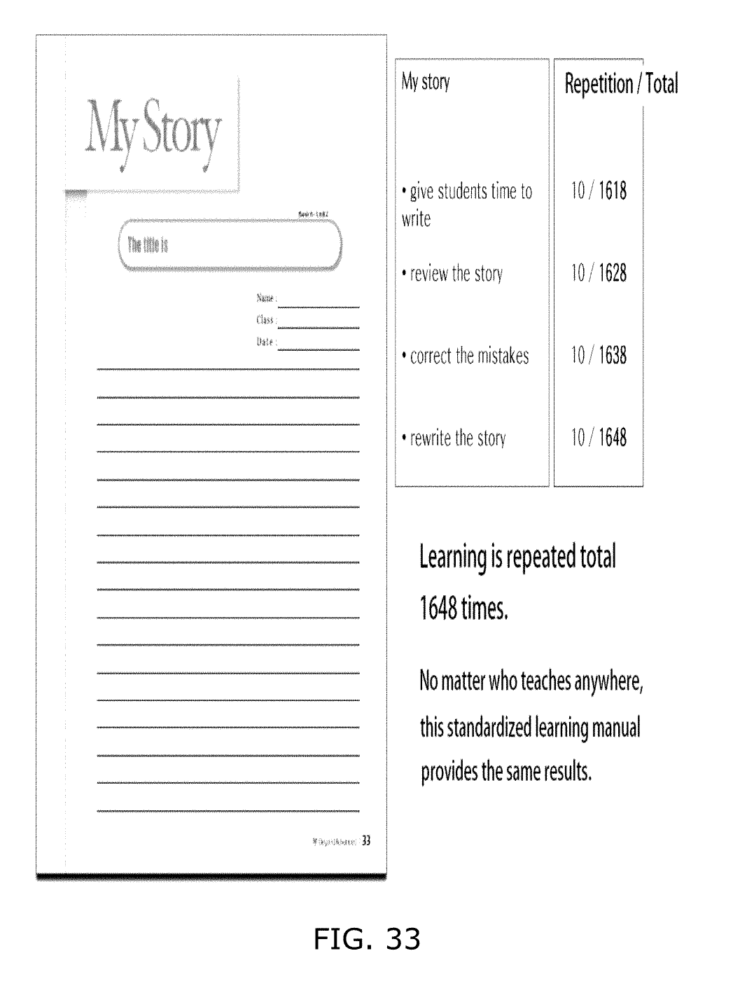

As shown in FIGS. 6 to 33 in order, the standardized learning manual displays the corresponding unit, for instance, Unit 2, and the learning contents, for instance, “Do you see the sky?”, of the current layer at the left side of the screen, and displays activities for learning the corresponding unit in the middle of the screen from the top in learning order. Furthermore, the standardized learning manual displays repetition number by activities to be repeatedly learned and cumulative number of learning at the right side of the screen.

For instance, if it is instructed to listen to the CD in an activity, the learner listens to the CD of the corresponding contents according to the instruction. In this instance, when the learning number is six, the learner listens to the CD six times. After that, the learner can check that he or she did learning of the corresponding manual window total twelve times including six learnings of ‘Make students read the story by themselves’ that the learner learned previously. In this way, the learning number of times is repeatedly accumulated, so the learner can do total 1,648 learnings when finishing his or her learning of all layers up to the 33^{rd} layer.

Therefore, the present invention enables the learner to express all expressions that he or she can express in his or her native language into English expressions through 1,600 iterative learnings of various expressions based on the systematic order and accuracy. Additionally, the present invention enables the learner to adjust and learn the learning contents by stages through the systematic building structure with the 33^{rd} layer or the equivalent, thereby providing standardization in teaching and learning to provide the same learning outcomes regardless of teachers and guaranteeing correct results by enhancing perfection in English skills.

### INDUSTRIAL APPLICABILITY

While exemplary embodiments of the present invention have been illustrated and described, it is obvious to those skilled in the art that the technical spirit of the present invention is not limited to the accompanying drawings and the above description. Therefore, it will be understood by those of ordinary skill in the art that various changes, modifications and equivalents may be made therein without departing from the technical idea of the present invention and such changes, modifications and equivalents belong to the scope of the present invention.

What is claimed is:

1. A sentence build-up English learning system comprising:
a learning operating server which stores learning programs and a user database;
a user terminal connected with the learning operating server through a communication network to store a learning program or an application downloaded from the learning operating server or install executive program, the user terminal having a display part and an input part;
a control part, which logs on to the user database of the learning operating server according to the request of the program or application executed in the user terminal, requests English learning services, and operates and controls learning program;
a learning contents database located inside the learning operating server, the learning contents database storing learning stages and a table of contents and learning contents by stages according to a predetermined learning order;
a learning stage selection module located inside the learning operating server, the learning stage selection module allowing the control part to automatically select the learning stage of the lowest level, which a learner did not complete, out of the learning stages stored in the learning contents database or enabling the learner to directly select one of the learning stages of the learning contents database by the input part, so as to display the table of learning contents and summarized contents of the selected learning stage on a first screen of the display part;
a learning contents display module located inside the learning operating server, the learning contents display module displaying detailed learning contents of the selected learning stage on a second screen of the display part after the learning stage selection module; and
a utilization history providing module located in the user terminal to provide the learning operating server with the learning contents by each stage and the learning progress learned by the learner and to update and store provided information in the user database,
wherein a building structure of the table of learning contents stored in the learning contents database is classified into a basic level, an intermediate level, and an advanced level,
wherein the basic building structure includes: a 1^{st} layer providing 1,600 iterative learnings of easily understandable expressions of verb ‘be’, subject and personal pronouns, and providing verb ‘be’ in the present tense and personal pronouns in the singular form, which are foundational to learning of contents from the 2^{nd} layer to the 33^{rd} layer that the learner will learn later; a 2^{nd} layer providing 1,600 iterative learnings of easily understandable expressions of verb ‘be’, subject, personal pronouns, questions, negative sentences, positive answers, and negative answers, and providing verb ‘be’ in the present tense, personal pronouns in the plural form, negative sentences, and questions and answers, which are foundational to learning of contents from the 3^{rd} layer to the 33^{rd} layer that the learner will learn later; a 3^{rd} layer providing 1,600 iterative learnings of various expressions of subject pronouns, object pronouns, possessive adjectives, and possessive pronouns based on various sentences with verb ‘be’ learned in the first and second layers, and providing personal pronouns and declension, which are foundational to learning of contents from the 4^{th} layer to the 33^{rd} layer that the learner will learn later; a 4^{th} layer providing 1,600 iterative learnings of various expressions of subject pronouns, object pronouns, possessive adjectives, and possessive pronouns based on various sentences with verb ‘be’ learned in the first and second layers, and providing declension of personal pronouns, which are foundational to learning of contents from the 5^{th} layer to the 33^{rd} layer that the learner will learn later; a 5^{th} layer providing 1,600 iterative learnings of various expressions of present tense regular verbs based on various sentences with verb ‘be’ and personal pronouns learned in the 1^{st} to 4^{th} layers, and providing present tense verbs, which are foundational to learning of contents from the sixth layer to the 33^{rd} layer that the learner will learn later; a 6^{th} layer providing 1,600 iterative learnings of various expressions of declarative sentences, questions, negative sentences, positive answers and negative answers based on various sentences with verb ‘be’ and other verbs learned in the 1^{st} to 5^{th} layers, and providing present tense verbs, which are foundational to learning of contents from the seventh layer to the 33^{rd} layer that the learner will learn later; a 7^{th} layer providing 1,600 iterative learnings of various expressions of declarative sentences, questions, negative sentences, positive answers and negative answers in the past tense based on various sentences with verb ‘be’ and other verbs learned in the first to sixth layers, and providing past tense verbs, which are foundational to learning of contents from the 8^{th} layer to the 33^{rd} layer that the learner will learn later; ₐ 8^{th} layer providing 1,600 iterative learnings of various expressions of declarative sentences, questions, negative sentences, positive answers and negative answers in the past tense based on various sentences with verb ‘be’ and other verbs learned in the first to seventh layers, and providing past tense verbs, which are foundational to learning of contents from the 9^{th} layer to the 33^{rd} layer that the learner will learn later; a 9^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 10^{th} layer to the 33^{rd} layer that the learner will learn later; a 10^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 11^{th} layer to the 33^{rd} layer that the learner will learn later; a 11^{th} layer providing 1,600 iterative learnings of various expressions of exclamatory, suggesting, and imperative sentences based on various present simple, past simple, present continuous, past continuous, and future tense sentences with verb ‘be’ and other verbs learned in the first to tenth layers, and providing exclamatory, suggesting, and imperative sentences, which are foundational to learning of contents from the 12^{th} layer to the 33^{rd} layer that the learner will learn later; and a 12^{th} layer providing 1,600 iterative learnings of various expressions of tag questions based on various present simple, past simple, present continuous, past continuous, and future tense, exclamatory, suggesting, and imperative sentences with verb ‘be’ and other verbs learned in the first to 11^{th} layers, and providing tag questions, which are foundational to learning of contents from the 13^{th} layer to the 33^{rd} layer that the learner will learn later,
wherein the intermediate building structure includes: a 13^{th} layer providing 1,600 iterative learnings of various expressions of reflexive pronouns and impersonal subject ‘it’ based on the sentence building structure of various tenses (present simple, past simple, present continuous, past continuous, and future) in questions, declarative, negative, exclamatory, suggesting, and imperative sentences learned in the first to 12^{th} layers, and providing reflexive pronouns and impersonal subject ‘it’, which are foundational to learning of contents from the 14^{th} layer to the 33^{rd} layer that the learner will learn later; a 14^{th} layer providing 1,600 iterative learnings of various expressions of indefinite pronouns and uncountable nouns based on the sentence building structure of various tenses (present simple, past simple, present continuous, past continuous, and future) in questions, declarative, negative, exclamatory, suggesting, and imperative sentences learned in the first to 13^{th} layers, and providing indefinite pronouns and uncountable nouns, which are foundational to learning of contents from the 15^{th} layer to the 33^{rd} layer that the learner will learn later; a 15^{th} layer providing 1,600 iterative learnings of various expressions of question words ‘Wh-’ based on the sentence building structure of various tenses (present simple, past simple, present continuous, past continuous, and future) in questions, declarative, negative, exclamatory, suggesting, and imperative sentences learned in the first to 14^{th} layers, and providing question words ‘Wh-’, which are foundational to learning of contents from the 16^{th} layer to the 33^{rd} layer that the learner will learn later; a 16^{th} layer providing 1,600 iterative learnings of various expressions of the question word ‘How’ based on the sentence building structure of various tenses (present simple, past simple, present continuous, past continuous, and future) in questions, declarative, negative, exclamatory, suggesting, and imperative sentences learned in the first to 15^{th} layers, and providing the question word ‘How’, which are foundational to learning of contents from the 17^{th} layer to the 33^{rd} layer that the learner will learn later; a 17^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 16^{th} layers, and providing modal verbs, which are foundational to learning of contents from the 18^{th} layer to the 33^{rd} layer that the learner will learn later; a 18^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 17^{th} layers, and providing modal verbs, which are foundational to learning of contents from the 19^{th} layer to the 33^{rd} layer that the learner will learn later; a 19^{th} layer providing 1,600 iterative learnings of various expressions of the comparatives and the superlatives based on the sentence building structure of various tenses (present simple, past simple, present continuous, past continuous, and future) in questions, declarative, negative, exclamatory, suggesting, and imperative sentences learned in the first to 18^{th} layers, and providing the comparatives and the superlatives, which are foundational to learning of contents from the 20^{th} layer to the 33^{rd} layer that the learner will learn later; a 20^{th} layer providing 1,600 iterative learnings of various expressions of number expressions and adverbs of frequency based on the sentence building structure of various tenses (present simple, past simple, present continuous, past continuous, and future) in questions, declarative, negative, exclamatory, suggesting, and imperative sentences learned in the first to 19^{th} layers, and providing number expressions and adverbs of frequency, which are foundational to learning of contents from the 21^{th} layer to the 33^{rd} layer that the learner will learn later; a 21^{th} layer providing 1,600 iterative learnings of various expressions of adjectives, adverbs, the indefinite article, and the definite article based on the sentence building structure of various tenses (present simple, past simple, present continuous, past continuous, and future) in questions, declarative, negative, exclamatory, suggesting, and imperative sentences learned in the first to 20^{th} layers, and providing adjectives, adverbs, the indefinite article, and the definite article, which are foundational to learning of contents from the 22^{nd} layer to the 33^{rd} layer that the learner will learn later; a 22^{nd} layer providing 1,600 iterative learnings of various expressions of prepositions and prepositional phrases based on the sentence building structure of various tenses (present simple, past simple, present continuous, past continuous, and future) in questions, declarative, negative, exclamatory, suggesting, and imperative sentences learned in the first to 21^{st} layers, and providing prepositions and prepositional phrases, which are foundational to learning of contents from the 23′¹ layer to the 33^{rd} layer that the learner will learn later; a23^{rd} layer providing 1,600 iterative learnings of various expressions of conjunctions based on the sentence building structure of various tenses (present simple, past simple, present continuous, past continuous, and future) in questions, declarative, negative, exclamatory, suggesting, and imperative sentences learned in the first to 22^{nd} layers, and providing conjunctions, which are foundational to learning of contents from the 24^{th} layer to the 33^{rd} layer that the learner will learn later; and a 24^{th} layer providing 1,600 iterative learnings of various expressions of possessive pronouns, selection of verbs, agreement on number, inversion, and emphasis based on the sentence building structure of various tenses (present simple, past simple, present continuous, past continuous, and future) in questions, declarative, negative, exclamatory, suggesting, and imperative sentences learned in the first to 23^{rd} layers, and providing possessive pronouns, selection of verbs, agreement on number, inversion, and emphasis, which are foundational to learning of contents from the 25^{th} layer to the 33^{rd} layer that the learner will learn later, and
wherein the advanced building structure includes: a 25^{th} layer providing iterative learnings so that the learner can perfectly understand usages of to-infinitive through various expressions including various tenses based on the sentence building structure completed from the first to 24^{th} layers, and providing infinitives, which are associated with various English expressions from the 26^{th} layer to the 33^{rd} layer that the learner will learn later; a 26^{th} layer providing iterative learnings so that the learner can understand usages of gerunds and present participles in connection with to-infinitive through various expressions including various tenses based on the sentence building structure completed from the first to 25^{th} layers, and providing gerunds, which are associated with various English expressions from the 27^{th} layer to the 33^{rd} layer that the learner will learn later; a 27^{th} layer providing iterative learnings so that the learner can understand constituent parts of sentences, kinds of sentences, sentence structures, and discrimination of parts of speech through various expressions including various tenses based on the sentence building structure completed from the first to 26^{th} layers, and providing kinds of verbs and sentence structures, which are associated with various English expressions from the 28^{th} layer to the 33^{rd} layer that the learner will learn later; a 28^{th} layer providing iterative learnings so that the learner can understand kinds and roles of participles, participle forms of emotions, understanding of present participle and gerund, and forms of participle constructions through various expressions including various tenses based on the sentence building structure completed from the first to 27^{th} layers, and providing participles, which are associated with various English expressions from the 29^{th} layer to the 33^{rd} layer that the learner will learn later; a 29^{th} layer providing iterative learnings and advanced learning processes of present, past, future, present perfect, past perfect, future perfect, present continuous, past continuous, future continuous, and present perfect continuous tenses through various expressions including various tenses based on the sentence building structure completed from the first to 28^{th} layers and provide iterative learnings so that the learner can complete the sentence building structure of all tenses including the perfect tense, and providing tenses of verbs, which are associated with various English expressions from the 30^{th} layer to the 33^{rd} layer that the learner will learn later; a 30^{th} layer providing iterative learnings so that the learner can understand kinds of the subjunctives, various forms of the subjunctives, and changes of speech through various expressions including various tenses based on the sentence building structure completed from the first to 29^{th} layers, and providing the subjunctive and speech, which are associated with various English expressions from the 31^{st} layer to the 33^{rd} layer that the learner will learn later; a 3 Pt layer providing iterative learnings so that the learner can understand modal verbs, do, have, can, may, must, should/ought to, will, would, and used to through various expressions including various tenses based on the sentence building structure completed from the first to 30^{th} layers, and providing the modal verbs, which are associated with various English expressions from the 32^{st} layer to the 33^{rd} layer that the learner will learn later; a 32^{st} layer providing iterative learnings so that the learner can understand the meaning, forms and tenses of the passive voice, modal verbs in the passive voice, the passive voice from which ‘by’ is omitted, prepositions in the passive voice, sentence kinds in the passive voice, sentence structures in the passive voice through various expressions including various tenses based on the sentence building structure completed from the first to 31^{st} layers, and providing the passive voice, which is associated with various English expressions of the 33^{rd} layer that the learner will learn later; and a 33^{rd} layer providing iterative learnings so that the learner can perfectly understand relative pronouns who, which, that, and what, usage and ellipsis of the relative pronouns, relative adverbs where, when, why, and how, and usage and ellipsis of the relative adverbs through various expressions including various tenses based on the sentence building structure completed from the first to 32^{nd} layers.

2. The sentence build-up English learning system according to claim 1, further comprising:
a learning stage progress display module having a learning stage progress display part of a multi-layer structure displayed on the first or second screen of the display part in order to show a progress status of the learning stage.

3. The sentence build-up English learning system according to claim 2, wherein the learning stage progress display module classifies the learning stages into finished stages, learning stages in progress, and stages before learning and displays them in their own colors.

4. The sentence build-up English learning system according to claim 1, wherein the learning contents display module comprises: a learning goal display part for displaying a table of contents of the selected stage and a learning goal on the second screen of the display part; a sub-table of contents display part, which divides the learning contents into a plurality of sub-tables of contents; and an example sentence display part providing a plurality of the example sentences having the contents related with the sub-table of contents provided by the sub-table of contents display part.

5. The sentence build-up English learning system according to claim 4, wherein the contents displayed by the example sentence display part are classified into corresponding parts according to parts of speech or various learning purposes of the corresponding learning contents, and are displayed in their own colors.

6. The sentence build-up English learning system according to claim 1, wherein the table of learning contents stored in the learning contents database is configured to have contents associated from the first stage to the final stage.

7. A sentence build-up English learning method comprising the steps of:
storing a table of contents and learning contents by stages in a learning contents database of a learning operating server in determined order;
logging on to a user database of the learning operating server through a communication network by a learner;
allowing a control part to automatically select the learning stage of the lowest level, which the learner did not complete, out of the learning stages stored in the learning contents database of the learning operating server or enabling the learner to directly select one of the learning stages in the table of contents using an input part, and displaying the table of contents and summarized learning contents of the selected learning stage on a first screen;
after the step of selecting the learning stage, displaying detailed learning contents associated with the selected learning stage on a second screen of the display part, so that the learner can learn the learning contents while getting them with eyes; and
updating and storing the utilization history of the learning stage in the user database of the learning operating server,
wherein the learning contents database has a building structure of learning contents, which is classified into a basic level, an intermediate level, and an advanced level,
wherein the building structure of the basic level includes: a 1^{st} layer providing 1,600 iterative learnings of easily understandable expressions of verb ‘be’, subject and personal pronouns, and providing verb ‘be’ in the present tense and personal pronouns in the singular form, which are foundational to learning of contents from the 2^{nd} layer to the 33^{rd} layer that the learner will learn later; a 2^{nd} layer providing 1,600 iterative learnings of easily understandable expressions of verb ‘be’, subject, personal pronouns, questions, negative sentences, positive answers, and negative answers, and providing verb ‘be’ in the present tense, personal pronouns in the plural form, negative sentences, and questions and answers, which are foundational to learning of contents from the 3^{rd} layer to the 33^{rd} layer that the learner will learn later; a 3^{rd} layer providing 1,600 iterative learnings of various expressions of subject pronouns, object pronouns, possessive adjectives, and possessive pronouns based on various sentences with verb ‘be’ learned in the first and second layers, and providing personal pronouns and declension, which are foundational to learning of contents from the 4^{th} layer to the 33^{rd} layer that the learner will learn later; a 4^{th} layer providing 1,600 iterative learnings of various expressions of subject pronouns, object pronouns, possessive adjectives, and possessive pronouns based on various sentences with verb ‘be’ learned in the first and second layers, and providing declension of personal pronouns, which are foundational to learning of contents from the 5^{th} layer to the 33^{rd} layer that the learner will learn later; a 5^{th} layer providing 1,600 iterative learnings of various expressions of present tense regular verbs based on various sentences with verb ‘be’ and personal pronouns learned in the P^{t} to 4^{th} layers, and providing present tense verbs, which are foundational to learning of contents from the sixth layer to the 33^{rd} layer that the learner will learn later; a 6^{th} layer providing 1,600 iterative learnings of various expressions of declarative sentences, questions, negative sentences, positive answers and negative answers based on various sentences with verb ‘be’ and other verbs learned in the P^{t} to 5^{th} layers, and providing present tense verbs, which are foundational to learning of contents from the seventh layer to the 33^{rd} layer that the learner will learn later; a 7^{th} layer providing 1,600 iterative learnings of various expressions of declarative sentences, questions, negative sentences, positive answers and negative answers in the past tense based on various sentences with verb ‘be’ and other verbs learned in the first to sixth layers, and providing past tense verbs, which are foundational to learning of contents from the 8^{th} layer to the 33^{rd} layer that the learner will learn later; a 8^{th} layer providing 1,600 iterative learnings of various expressions of declarative sentences, questions, negative sentences, positive answers and negative answers in the past tense based on various sentences with verb ‘be’ and other verbs learned in the first to seventh layers, and providing past tense verbs, which are foundational to learning of contents from the 9^{th} layer to the 33^{rd} layer that the learner will learn later; a 9^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 10^{th} layer to the 33^{rd} layer that the learner will learn later; a 10^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 11^{th} layer to the 33^{rd} layer that the learner will learn later; a 11^{th} layer providing 1,600 iterative learnings of various expressions of exclamatory, suggesting, and imperative sentences based on various present simple, past simple, present continuous, past continuous, and future tense sentences with verb ‘be’ and other verbs learned in the first to tenth layers, and providing exclamatory, suggesting, and imperative sentences, which are foundational to learning of contents from the 12^{th} layer to the 33^{rd} layer that the learner will learn later; and a 12^{th} layer providing 1,600 iterative learnings of various expressions of tag questions based on various present simple, past simple, present continuous, past continuous, and future tense, exclamatory, suggesting, and imperative sentences with verb ‘be’ and other verbs learned in the first to 11^{th} layers, and providing tag questions, which are foundational to learning of contents from the 13^{th} layer to the 33^{rd} layer that the learner will learn later,
wherein the building structure of the intermediate level includes: a 13^{th} layer providing 1,600 iterative learnings of various expressions of reflexive pronouns and impersonal subject ‘it’ based on the sentence building structure of various tenses (present simple, past simple, present continuous, past continuous, and future) in questions, declarative, negative, exclamatory, suggesting, and imperative sentences learned in the first to 12^{th} layers, and providing reflexive pronouns and impersonal subject ‘it’, which are foundational to learning of contents from the 14^{th} layer to the 33^{rd} layer that the learner will learn later; a 14^{th} layer providing 1,600 iterative learnings of various expressions of indefinite pronouns and uncountable nouns based on the sentence building structure of various tenses (present simple, past simple, present continuous, past continuous, and future) in questions, declarative, negative, exclamatory, suggesting, and imperative sentences learned in the first to 13^{th} layers, and providing indefinite pronouns and uncountable nouns, which are foundational to learning of contents from the 15^{th} layer to the 33^{rd} layer that the learner will learn later; a 15^{th} layer providing 1,600 iterative learnings of various expressions of question words ‘Wh-’ based on the sentence building structure of various tenses (present simple, past simple, present continuous, past continuous, and future) in questions, declarative, negative, exclamatory, suggesting, and imperative sentences learned in the first to 14^{th} layers, and providing question words ‘Wh-’, which are foundational to learning of contents from the 16^{th} layer to the 33^{rd} layer that the learner will learn later; a 16^{th} layer providing 1,600 iterative learnings of various expressions of the question word ‘How’ based on the sentence building structure of various tenses (present simple, past simple, present continuous, past continuous, and future) in questions, declarative, negative, exclamatory, suggesting, and imperative sentences learned in the first to 15^{th} layers, and providing the question word ‘How’, which are foundational to learning of contents from the 17^{th} layer to the 33^{rd} layer that the learner will learn later; a 17^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 16^{th} layers, and providing modal verbs, which are foundational to learning of contents from the 18^{th} layer to the 33^{rd} layer that the learner will learn later; a 18^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 17^{th} layers, and providing modal verbs, which are foundational to learning of contents from the 19^{th} layer to the 33^{rd} layer that the learner will learn later; a 19^{th} layer providing 1,600 iterative learnings of various expressions of the comparatives and the superlatives based on the sentence building structure of various tenses (present simple, past simple, present continuous, past continuous, and future) in questions, declarative, negative, exclamatory, suggesting, and imperative sentences learned in the first to 18^{th} layers, and providing the comparatives and the superlatives, which are foundational to learning of contents from the 20^{th} layer to the 33^{rd} layer that the learner will learn later; a 20^{th} layer providing 1,600 iterative learnings of various expressions of number expressions and adverbs of frequency based on the sentence building structure of various tenses (present simple, past simple, present continuous, past continuous, and future) in questions, declarative, negative, exclamatory, suggesting, and imperative sentences learned in the first to 19^{th} layers, and providing number expressions and adverbs of frequency, which are foundational to learning of contents from the 21^{th} layer to the 33^{rd} layer that the learner will learn later; a 21^{th} layer providing 1,600 iterative learnings of various expressions of adjectives, adverbs, the indefinite article, and the definite article based on the sentence building structure of various tenses (present simple, past simple, present continuous, past continuous, and future) in questions, declarative, negative, exclamatory, suggesting, and imperative sentences learned in the first to 20^{th} layers, and providing adjectives, adverbs, the indefinite article, and the definite article, which are foundational to learning of contents from the 22^{nd} layer to the 33^{rd} layer that the learner will learn later; a 22^{nd} layer providing 1,600 iterative learnings of various expressions of prepositions and prepositional phrases based on the sentence building structure of various tenses (present simple, past simple, present continuous, past continuous, and future) in questions, declarative, negative, exclamatory, suggesting, and imperative sentences learned in the first to 21^{st} layers, and providing prepositions and prepositional phrases, which are foundational to learning of contents from the 23′¹ layer to the 33^{rd} layer that the learner will learn later; a23^{rd} layer providing 1,600 iterative learnings of various expressions of conjunctions based on the sentence building structure of various tenses (present simple, past simple, present continuous, past continuous, and future) in questions, declarative, negative, exclamatory, suggesting, and imperative sentences learned in the first to 22^{nd} layers, and providing conjunctions, which are foundational to learning of contents from the 24^{th} layer to the 33^{rd} layer that the learner will learn later; and a 24^{th} layer providing 1,600 iterative learnings of various expressions of possessive pronouns, selection of verbs, agreement on number, inversion, and emphasis based on the sentence building structure of various tenses (present simple, past simple, present continuous, past continuous, and future) in questions, declarative, negative, exclamatory, suggesting, and imperative sentences learned in the first to 23^{rd} layers, and providing possessive pronouns, selection of verbs, agreement on number, inversion, and emphasis, which are foundational to learning of contents from the 25^{th} layer to the 33^{rd} layer that the learner will learn later, and
wherein the building structure of the advanced level includes: a 25^{th} layer providing iterative learnings so that the learner can perfectly understand usages of to-infinitive through various expressions including various tenses based on the sentence building structure completed from the first to 24^{th} layers, and providing infinitives, which are associated with various English expressions from the 26^{th} layer to the 33^{rd} layer that the learner will learn later; a 26^{th} layer providing iterative learnings so that the learner can understand usages of gerunds and present participles in connection with to-infinitive through various expressions including various tenses based on the sentence building structure completed from the first to 25^{th} layers, and providing gerunds, which are associated with various English expressions from the 27^{th} layer to the 33^{rd} layer that the learner will learn later; a 27^{th} layer providing iterative learnings so that the learner can understand constituent parts of sentences, kinds of sentences, sentence structures, and discrimination of parts of speech through various expressions including various tenses based on the sentence building structure completed from the first to 26^{th} layers, and providing kinds of verbs and sentence structures, which are associated with various English expressions from the 28^{th} layer to the 33^{rd} layer that the learner will learn later; a 28^{th} layer providing iterative learnings so that the learner can understand kinds and roles of participles, participle forms of emotions, understanding of present participle and gerund, and forms of participle constructions through various expressions including various tenses based on the sentence building structure completed from the first to 27^{th} layers, and providing participles, which are associated with various English expressions from the 29^{th} layer to the 33^{rd} layer that the learner will learn later; a 29^{th} layer providing iterative learnings and advanced learning processes of present, past, future, present perfect, past perfect, future perfect, present continuous, past continuous, future continuous, and present perfect continuous tenses through various expressions including various tenses based on the sentence building structure completed from the first to 28^{th} layers and provide iterative learnings so that the learner can complete the sentence building structure of all tenses including the perfect tense, and providing tenses of verbs, which are associated with various English expressions from the 30^{th} layer to the 33^{rd} layer that the learner will learn later; a 30^{th} layer providing iterative learnings so that the learner can understand kinds of the subjunctives, various forms of the subjunctives, and changes of speech through various expressions including various tenses based on the sentence building structure completed from the first to 29^{th} layers, and providing the subjunctive and speech, which are associated with various English expressions from the 31^{st} layer to the 33^{rd} layer that the learner will learn later; a 31^{st} layer providing iterative learnings so that the learner can understand modal verbs, do, have, can, may, must, should/ought to, will, would, and used to through various expressions including various tenses based on the sentence building structure completed from the first to 30^{th} layers, and providing the modal verbs, which are associated with various English expressions from the 32^{st} layer to the 33^{rd} layer that the learner will learn later; a 32^{st} layer providing iterative learnings so that the learner can understand the meaning, forms and tenses of the passive voice, modal verbs in the passive voice, the passive voice from which ‘by’ is omitted, prepositions in the passive voice, sentence kinds in the passive voice, sentence structures in the passive voice through various expressions including various tenses based on the sentence building structure completed from the first to 31^{st} layers, and providing the passive voice, which is associated with various English expressions of the 33^{rd} layer that the learner will learn later; and a 33^{rd} layer providing iterative learnings so that the learner can perfectly understand relative pronouns who, which, that, and what, usage and ellipsis of the relative pronouns, relative adverbs where, when, why, and how, and usage and ellipsis of the relative adverbs through various expressions including various tenses based on the sentence building structure completed from the first to 32^{nd} layers.

8. The sentence build-up English learning method according to claim 7, wherein in the step of logging in, a layer structure the learning stages are classified into finished stages, learning stages in progress, and stages before learning and are displayed in their own colors on the display part of the user terminal.

9. The sentence build-up English learning method according to claim 7, wherein in the step of displaying detailed learning contents, the contents to be learned are divided into a plurality of sub-table of contents and are displayed on the second screen of the display part, and a plurality of example sentences containing contents related with the sub-table of contents are further displayed on the second screen of the display part.

10. The sentence build-up English learning method according to claim 7, wherein the table of contents stored in the learning contents database is configured to have contents associated from the first stage to the final stage, so that the learner progresses learning in order from a lower stage to higher stages.

11. A sentence build-up English teaching method comprising the steps of:
storing a table of contents and learning contents by stages in a learning contents database of a learning operating server in determined order;
logging on to a user database of the learning operating server through a communication network by a learner;
allowing a control part to automatically select the learning stage of the lowest level, which the learner did not complete, out of the learning stages stored in the learning contents database of the learning operating server or enabling the learner to directly select one of the learning stages in the table of contents using an input part, and displaying the table of contents and summarized learning contents of the selected learning stage on a first screen;
after the step of selecting the learning stage, displaying detailed learning contents associated with the selected learning stage on a second screen of the display part, so that the learner can learn the learning contents while getting them with eyes;
reading the contents corresponding to the corresponding layer from an electronically standardized learning manual stored in the learning operating server and displaying the read contents on a part of the screen of the display part or a separate window; and
updating and storing the utilization history of the learning stage in the user database of the learning operating server,
wherein the learning contents database has a building structure of learning contents, which is classified into a basic level, an intermediate level, and an advanced level,
wherein the building structure of the basic level includes: a 1^{st} layer providing 1,600 iterative learnings of easily understandable expressions of verb ‘be’, subject and personal pronouns, and providing verb ‘be’ in the present tense and personal pronouns in the singular form, which are foundational to learning of contents from the 2^{nd} layer to the 33^{rd} layer that the learner will learn later; a 2^{nd} layer providing 1,600 iterative learnings of easily understandable expressions of verb ‘be’, subject, personal pronouns, questions, negative sentences, positive answers, and negative answers, and providing verb ‘be’ in the present tense, personal pronouns in the plural form, negative sentences, and questions and answers, which are foundational to learning of contents from the 3^{rd} layer to the 33^{rd} layer that the learner will learn later; a 3^{rd} layer providing 1,600 iterative learnings of various expressions of subject pronouns, object pronouns, possessive adjectives, and possessive pronouns based on various sentences with verb ‘be’ learned in the first and second layers, and providing personal pronouns and declension, which are foundational to learning of contents from the 4^{th} layer to the 33^{rd} layer that the learner will learn later; a 4^{th} layer providing 1,600 iterative learnings of various expressions of subject pronouns, object pronouns, possessive adjectives, and possessive pronouns based on various sentences with verb ‘be’ learned in the first and second layers, and providing declension of personal pronouns, which are foundational to learning of contents from the 5^{th} layer to the 33^{rd} layer that the learner will learn later; a 5^{th} layer providing 1,600 iterative learnings of various expressions of present tense regular verbs based on various sentences with verb ‘be’ and personal pronouns learned in the Pt to 4^{th} layers, and providing present tense verbs, which are foundational to learning of contents from the sixth layer to the 33^{rd} layer that the learner will learn later; a 6^{th} layer providing 1,600 iterative learnings of various expressions of declarative sentences, questions, negative sentences, positive answers and negative answers based on various sentences with verb ‘be’ and other verbs learned in the Pt to 5^{th} layers, and providing present tense verbs, which are foundational to learning of contents from the seventh layer to the 33^{rd} layer that the learner will learn later; a 7^{th} layer providing 1,600 iterative learnings of various expressions of declarative sentences, questions, negative sentences, positive answers and negative answers in the past tense based on various sentences with verb ‘be’ and other verbs learned in the first to sixth layers, and providing past tense verbs, which are foundational to learning of contents from the 8^{th} layer to the 33^{rd} layer that the learner will learn later; ^{a} 8^{th} layer providing 1,600 iterative learnings of various expressions of declarative sentences, questions, negative sentences, positive answers and negative answers in the past tense based on various sentences with verb ‘be’ and other verbs learned in the first to seventh layers, and providing past tense verbs, which are foundational to learning of contents from the 9^{th} layer to the 33^{rd} layer that the learner will learn later; a 9^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 10^{th} layer to the 33^{rd} layer that the learner will learn later; a 10^{th} layer providing 1,600 iterative learnings of various expressions of declarative sentences, questions, negative sentences, positive answers and negative answers in the present continuous tense based on various sentences with verb ‘be’ and other verbs learned in the first to eighth layers, and providing the present continuous tense, which are foundational to learning of contents from the 11^{th} layer to the 33^{rd} layer that the learner will learn later; a 11^{th} layer providing 1,600 iterative learnings of various expressions of exclamatory, suggesting, and imperative sentences based on various present simple, past simple, present continuous, past continuous, and future tense sentences with verb ‘be’ and other verbs learned in the first to tenth layers, and providing exclamatory, suggesting, and imperative sentences, which are foundational to learning of contents from the 12^{th} layer to the 33^{rd} layer that the learner will learn later; and a 12^{th} layer providing 1,600 iterative learnings of various expressions of tag questions based on various present simple, past simple, present continuous, past continuous, and future tense, exclamatory, suggesting, and imperative sentences with verb ‘be’ and other verbs learned in the first to 11′^{h} layers, and providing tag questions, which are foundational to learning of contents from the 13^{th} layer to the 33^{rd} layer that the learner will learn later,
wherein the building structure of the intermediate level includes: a 13^{th} layer providing 1,600 iterative learnings of various expressions of reflexive pronouns and impersonal subject ‘it’ based on the sentence building structure of various tenses (present simple, past simple, present continuous, past continuous, and future) in questions, declarative, negative, exclamatory, suggesting, and imperative sentences learned in the first to 12^{th} layers, and providing reflexive pronouns and impersonal subject ‘it’, which are foundational to learning of contents from the 14^{th} layer to the 33^{rd} layer that the learner will learn later; a 14^{th} layer providing 1,600 iterative learnings of various expressions of indefinite pronouns and uncountable nouns based on the sentence building structure of various tenses (present simple, past simple, present continuous, past continuous, and future) in questions, declarative, negative, exclamatory, suggesting, and imperative sentences learned in the first to 13^{th} layers, and providing indefinite pronouns and uncountable nouns, which are foundational to learning of contents from the 15^{th} layer to the 33^{rd} layer that the learner will learn later; a 15^{th} layer providing 1,600 iterative learnings of various expressions of question words ‘Wh-’ based on the sentence building structure of various tenses (present simple, past simple, present continuous, past continuous, and future) in questions, declarative, negative, exclamatory, suggesting, and imperative sentences learned in the first to 14^{th} layers, and providing question words ‘Wh-’, which are foundational to learning of contents from the 16^{th} layer to the 33^{rd} layer that the learner will learn later; a 16^{th} layer providing 1,600 iterative learnings of various expressions of the question word ‘How’ based on the sentence building structure of various tenses (present simple, past simple, present continuous, past continuous, and future) in questions, declarative, negative, exclamatory, suggesting, and imperative sentences learned in the first to 15^{th} layers, and providing the question word ‘How’, which are foundational to learning of contents from the 17^{th} layer to the 33^{rd} layer that the learner will learn later; a 17^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 16^{th} layers, and providing modal verbs, which are foundational to learning of contents from the 18^{th} layer to the 33^{rd} layer that the learner will learn later; a 18^{th} layer providing 1,600 iterative learnings of various expressions of modal verbs based on the sentence building structure of various tenses (present simple, past simple, present continuous, past continuous, and future) in questions, declarative, negative, exclamatory, suggesting, and imperative sentences learned in the first to 17^{th} layers, and providing modal verbs, which are foundational to learning of contents from the 19^{th} layer to the 33^{rd} layer that the learner will learn later; a 19^{th} layer providing 1,600 iterative learnings of various expressions of the comparatives and the superlatives based on the sentence building structure of various tenses (present simple, past simple, present continuous, past continuous, and future) in questions, declarative, negative, exclamatory, suggesting, and imperative sentences learned in the first to 18^{th} layers, and providing the comparatives and the superlatives, which are foundational to learning of contents from the 20^{th} layer to the 33^{rd} layer that the learner will learn later; a 20^{th} layer providing 1,600 iterative learnings of various expressions of number expressions and adverbs of frequency based on the sentence building structure of various tenses (present simple, past simple, present continuous, past continuous, and future) in questions, declarative, negative, exclamatory, suggesting, and imperative sentences learned in the first to 19^{th} layers, and providing number expressions and adverbs of frequency, which are foundational to learning of contents from the 21^{th} layer to the 33^{rd} layer that the learner will learn later; a 21^{th} layer providing 1,600 iterative learnings of various expressions of adjectives, adverbs, the indefinite article, and the definite article based on the sentence building structure of various tenses (present simple, past simple, present continuous, past continuous, and future) in questions, declarative, negative, exclamatory, suggesting, and imperative sentences learned in the first to 20^{th} layers, and providing adjectives, adverbs, the indefinite article, and the definite article, which are foundational to learning of contents from the 22^{nd} layer to the 33^{rd} layer that the learner will learn later; a 22^{nd} layer providing 1,600 iterative learnings of various expressions of prepositions and prepositional phrases based on the sentence building structure of various tenses (present simple, past simple, present continuous, past continuous, and future) in questions, declarative, negative, exclamatory, suggesting, and imperative sentences learned in the first to 21^{st} layers, and providing prepositions and prepositional phrases, which are foundational to learning of contents from the 23^{rd} layer to the 33^{rd} layer that the learner will learn later; a23^{rd} layer providing 1,600 iterative learnings of various expressions of conjunctions based on the sentence building structure of various tenses (present simple, past simple, present continuous, past continuous, and future) in questions, declarative, negative, exclamatory, suggesting, and imperative sentences learned in the first to 22^{nd} layers, and providing conjunctions, which are foundational to learning of contents from the 24^{th} layer to the 33^{rd} layer that the learner will learn later; and a 24^{th} layer providing 1,600 iterative learnings of various expressions of possessive pronouns, selection of verbs, agreement on number, inversion, and emphasis based on the sentence building structure of various tenses (present simple, past simple, present continuous, past continuous, and future) in questions, declarative, negative, exclamatory, suggesting, and imperative sentences learned in the first to 23^{rd} layers, and providing possessive pronouns, selection of verbs, agreement on number, inversion, and emphasis, which are foundational to learning of contents from the 25^{th} layer to the 33^{rd} layer that the learner will learn later, and
wherein the building structure of the advanced level includes: a 25^{th} layer providing iterative learnings so that the learner can perfectly understand usages of to-infinitive through various expressions including various tenses based on the sentence building structure completed from the first to 24^{th} layers, and providing infinitives, which are associated with various English expressions from the 26^{th} layer to the 33^{rd} layer that the learner will learn later; a 26^{th} layer providing iterative learnings so that the learner can understand usages of gerunds and present participles in connection with to-infinitive through various expressions including various tenses based on the sentence building structure completed from the first to 25^{th} layers, and providing gerunds, which are associated with various English expressions from the 27^{th} layer to the 33^{rd} layer that the learner will learn later; a 27^{th} layer providing iterative learnings so that the learner can understand constituent parts of sentences, kinds of sentences, sentence structures, and discrimination of parts of speech through various expressions including various tenses based on the sentence building structure completed from the first to 26^{th} layers, and providing kinds of verbs and sentence structures, which are associated with various English expressions from the 28^{th} layer to the 33^{rd} layer that the learner will learn later; a 28^{th} layer providing iterative learnings so that the learner can understand kinds and roles of participles, participle forms of emotions, understanding of present participle and gerund, and forms of participle constructions through various expressions including various tenses based on the sentence building structure completed from the first to 27^{th} layers, and providing participles, which are associated with various English expressions from the 29^{th} layer to the 33^{rd} layer that the learner will learn later; a 29^{th} layer providing iterative learnings and advanced learning processes of present, past, future, present perfect, past perfect, future perfect, present continuous, past continuous, future continuous, and present perfect continuous tenses through various expressions including various tenses based on the sentence building structure completed from the first to 28^{th} layers and provide iterative learnings so that the learner can complete the sentence building structure of all tenses including the perfect tense, and providing tenses of verbs, which are associated with various English expressions from the 30^{th} layer to the 33^{rd} layer that the learner will learn later; a 30^{th} layer providing iterative learnings so that the learner can understand kinds of the subjunctives, various forms of the subjunctives, and changes of speech through various expressions including various tenses based on the sentence building structure completed from the first to 29^{th} layers, and providing the subjunctive and speech, which are associated with various English expressions from the 31^{st} layer to the 33^{rd} layer that the learner will learn later; a 31^{st} layer providing iterative learnings so that the learner can understand modal verbs, do, have, can, may, must, should/ought to, will, would, and used to through various expressions including various tenses based on the sentence building structure completed from the first to 30^{th} layers, and providing the modal verbs, which are associated with various English expressions from the 32^{st} layer to the 33^{rd} layer that the learner will learn later; a 32^{st} layer providing iterative learnings so that the learner can understand the meaning, forms and tenses of the passive voice, modal verbs in the passive voice, the passive voice from which ‘by’ is omitted, prepositions in the passive voice, sentence kinds in the passive voice, sentence structures in the passive voice through various expressions including various tenses based on the sentence building structure completed from the first to 31^{st} layers, and providing the passive voice, which is associated with various English expressions of the 33^{rd} layer that the learner will learn later; and a 33^{rd} layer providing iterative learnings so that the learner can perfectly understand relative pronouns who, which, that, and what, usage and ellipsis of the relative pronouns, relative adverbs where, when, why, and how, and usage and ellipsis of the relative adverbs through various expressions including various tenses based on the sentence building structure completed from the first to 32^{nd} layers.

12. The sentence build-up English teaching method according to claim 11, wherein the standardized learning manual displays the unit and learning contents of the layer, which the learner is currently learning, at the left side of the screen, displays activities for learning the corresponding unit from the top in learning order in the middle of the screen, and displays repetition number by activities to be repeatedly learned and cumulative number of learning at the right side of the screen.
